(19) United States
(12) Patent Application Publication
(10) Pub. No.: US 2009/0003172 A1
(43) Pub. Date: Jan. 1, 2009

(54) PLAYBACK DEVICE, RECORDING DEVICE, DISC MEDIUM, AND METHOD

(76) Inventors: Hiroshi Yahata, Osaka (JP); Tomoki Ogawa, Osaka (JP); Wataru Ikeda, Osaka (JP); Taiji Sawada, Osaka (JP); Kazuhiro Mochinaga, Hyogo (JP); Tomoyuki Okada, Nara (JP)

Correspondence Address: WENDEROTH, LIND & PONACK L.L.P., 2033 K. STREET, NW, SUITE 800, WASHINGTON, DC, 20006, US

(21) Appl. No.: 11/960,441

(22) Filed: Dec. 19, 2007

Related U.S. Application Data
(60) Provisional application No. 60/877,612, filed on Dec. 29, 2006.

(51) Int. Cl. G11B 5/58

(52) U.S. Cl. 369/53.41

(57) ABSTRACT

The present invention aims to simply showing to the user what operations are available with the combination of the disc medium type, the application format of the data recorded/to be recorded on the disc medium, and the information processing apparatus being used by the user.

The present invention displays the medium type/the application format type, etc. on the display or the like when the disc medium is loaded/the disc medium is played back/data is recorded on the disc medium/the disc medium is ejected. This improves the user's recognition of the operations, and the comfort thereof.

### BACKGROUND OF THE INVENTION

(1) Field of the Invention

The present invention belongs to a technical field of recording/playback control for disc media.

(2) Description of the Related Art

Various types of disc media are subjected to the recording/playback control mentioned above. Examples of such media are DVD-Audio discs for recording music, DVD-ROM discs for distributing packages of movies in the form of DVD-Videos, DVD-R/RW/RAM discs for recording broadcast data and videos shot by end users by the DVD Video Recording system, and so on.

In addition, next-generation DVD standards, such as the Blu-ray Disc standard and the HD-DVD standard have been established recently. Therefore, the number of types of discs and the number of formats used for recording data onto such discs have been increasing, and becoming complicated.

### SUMMARY OF THE INVENTION

Technical Problem of Conventional Playback Apparatuses

However, every disc medium has a file system layer on assumption that it will be used as a medium for PCs, regardless of whether it is a Blu-ray disc or a DVD or anything else. When a disc medium is used as a medium for PCs, users may write data files onto the disc by a Drag-Drop operation. Moreover, user may write data that is dependent on the application format of the Blu-ray discs onto the DVD recording layer by the simple Drag-Drop operation. Such data, that is, data dependent on the application format of the Blu-ray discs, is designed to be read from the physical layer of a Blu-ray disc for playback. Accordingly, if a recording medium having recorded thereon a combination of a DVD physical type and a Blu-ray format type is loaded into a playback apparatus and played back, playback failures, such as a reading failure due to a slow reading speed.

To avoid such failures, a certain level of restrictions on use with PC may achieve an effect. However, such restrictions ruin the ability of the discs as a recording media for PCs, and cause a great loss to manufactures who aim to popularize the Blu-ray discs and the DVDs.

Alternatively, it is possible to apply a safety mechanism to the playback apparatus so that the playback apparatus does not start playback if data in the Blu-ray format is recorded on the DVD physical layer. However, many playback apparatuses on the market have a drive device with a large design margin to support high-speed driving. Such playback apparatuses have a potential ability to play back a DVD disc on which a high bit rate Blu-ray format data is recorded, even though they are labeled in the product specification thereof as apparatuses exclusively for use with DVD discs. Also, there certainly are many users who want to play back Blu-ray format data recorded on DVD discs using a DVD playback apparatus, without regard to a little shake and noise. In view of these facts, complete appliance of the safety mechanism mentioned above frustrates the users' wishes, and does not meet the needs of the users.

In view of these problems, the first object of the present invention is to provide a playback apparatus that is capable of appropriately playing back data recorded on a disc, with supporting various combinations between the physical types of the disc and the format types of the data.

The first object is fulfilled by a playback apparatus comprising: a first detection unit operable to detect a physical type of a disc medium when the disc medium is loaded; a second detection unit operable to detect a format type of data recorded on the disc medium; a playback unit operable to play back the data recorded on the disc medium; and a determination unit operable to determine whether to play back the data, based on a combination of the physical type and the format type.

With the stated structure, if a recording medium with an unsupported combination of the physical layer type and the data format type is loaded, the playback apparatus can make a decision not to play back the data recorded on the recording medium. If a recording medium with a supported combination of the physical layer type and the data format type is loaded, the playback apparatus can make a decision to play back the data recorded on the recording medium.

Manufactures of the playback apparatus can define acceptable combinations among the various combinations of the physical layer type and the data format type, based on the durability of the drive device of the playback apparatus. Therefore, it is possible to meet the demand of users targeted as buyers of the product.

### Technical Problem of Conventional Recording Apparatuses

Conventional recording apparatuses firstly record a content received as a broadcast program on a built-in recording medium such as an HDD (or, for example, an external HDD that is connected to the recording apparatuses via USB), and then record the content on a disc medium. The mainstream method for recording a content on the built-in recording medium is to record the content in a single application format. With this method, if the format of the data recorded on the built-in recording medium is different from the format writable on an optical disc medium, it is necessary to once convert the data of the TV programs recorded on the built-in medium to be in the format writable on the optical disc medium, and this processing takes a long time. To solve this problem, the content received as a broadcast wave may be recorded after being converted to be in some application formats that are applicable to a plurality of envisioned optical disc medium types. This realizes high-speed copy and move of the content from the built-in medium to the disc.

However, this option can be a problem even though it realizes such high-speed dubbing. Because if the content is converted to contents in two or more formats and recorded, the built-in medium will be filled to capacity more quickly than expected by the users.

In view of this problem, the second object of the present invention is to provide a recording apparatus that is capable of, even if converting a content to contents in two or more formats and recording the converted contents on the built-in medium, hiding the fact of such duplicate recording from the users.

The second object is fulfilled by a recording apparatus comprising: a built-in medium; a conversion unit operable to convert a content to be recorded, to obtain two or more format-dependent data sets, and write the data sets on the built-in medium, each of the data sets being dependent on a different application format; a presentation unit operable to present to a user a capacity of the built-in medium obtained by adding a prescribed offset to an actual free space size of the built-in medium; and a dubbing unit operable, when a portable medium is loaded, to read one of the data sets that has been written in an application format that is acceptable to the portable medium, and write the read data set on the portable medium, wherein the prescribed offset is a size of a data set that is to be deleted to increase a free space of the built-in medium.

With the stated structure, the recording apparatus presents the total of a free disk space and a prescribed offset to the user. The prescribed offset represents the size of a disc space occupied by any of two or more pieces of application data to be deleted by priority, among pieces of application data recorded in different application formats. As a result, it is possible to eliminate the gap between the size of the free space of the built-in HDD recognized by the user and the actual size of data that can be written on the disc. Since the recording apparatus does not make the user aware of the fact that content is recorded on the built-in HDD in duplicate in different formats, the recording apparatus can promptly respond to a user's request for dubbing, such as copy and move, of the content.

### 1^{st} Technical Problem of Conventional Recording Media

In recent years, hybrid optical media (Blu-ray/DVD hybrid disc) having a physical structure of a Blu-ray disc on the first layer and a physical structure of a DVD disc on the second layer have been researched and developed.

With a Blu-ray/DVD hybrid disc, it is possible to record/play back data on the first layer (Blu-ray recording layer) using a blue-violet laser (wavelength: 405 nm), and on the second layer (DVD recording layer) using a red laser (wavelength: 650 nm). For example, a conventional DVD player equipped with only a red laser device is capable of playing back only data recorded on the DVD recording layer, and a conventional Blu-ray player equipped with only a blue-violet laser device is capable of playing back only data recorded on the Blu-ray recording layer.

Here, if the total capacity of the Blu-ray recording layer is 25 GB and the total capacity of the DVD recording layer is 4.7 GB, it is necessary to manage the disc space such that 12.5 GB data recorded on the Blu-ray recording layer and 2.35 GB data recorded on the DVD recording layer are equivalent in terms of the length of the recording time.

This is for the following reason: Since a recording apparatus is required to handle the two recording layers as equals, when usage rates of the two recording layers are different, the free disc space to be presented to the user should be calculated based on the higher one of the usage rates. For example, if the usage rate of one Layer is ¾ and the usage rate of the other layer is ½, the recording apparatus should present to the user the former rate as the usage rate of the whole medium. However, if the usage rate is presented to the user in this way, the disc space corresponding to the difference ¼ will be left unused. This degrades the usability of the disc medium.

In view of this problem, the third object of the present invention is to provide a hybrid type disc medium that is capable of preventing degradation of the usability of the medium caused by that one of the recording layers is left unused.

The third object is fulfilled by a recording apparatus that records a content on a disc medium that has two ore more recording layers, the recording apparatus comprising: a designation unit operable to designate a recording layer as a recording destination according to an attribute of the content; a first writing unit operable to write the content on the designated recording layer; a re-encode unit operable to re-encode the content; and a second writing unit operable to write the re-encoded content on an undesignated recording layer, wherein a size of the re-encoded content is determined based on a size of the content recorded on the designated layer, a free space size of the designated layer, and a free space size of the undesignated layer.

### 2^{nd} Technical Problem of Conventional Recording Media

With read-only type disc media such as BD-ROMs, it is impossible to rewrite data that has been written. Accordingly, a function called “virtual package” is provided in playback apparatuses. The virtual package is a technique for extending the contents of a read-only type disc medium by dynamically combining a digital stream recorded on a read-only type recording medium such as a BD-ROM and data downloaded via a network, to structure a virtual package (that can be managed as equivalent to one BD-ROM disc). For example, if the digital stream recorded on the BD-ROM is a main movie content and the download data is additional audio data, additional subtitles, or the like, it is possible to extend the main movie content by structuring the virtual package as described above.

However, there is a problem here. With the conventional virtual package, downloaded data is firstly stored in a rewritable type recording medium other than the BD-ROM, such as a hard disk and a semiconductor memory card, and then used. As the downloaded data is stored in a rewritable type medium separately from the main movie content, if the number of BD-ROMs owned by the user increases, it becomes difficult for the user to manage the main content stored in the BD-ROM and the downloaded data stored in the hard disk with associating them with each other.

BD-ROM players use the Out-of-MUX framework for realizing synchronous playback between a video stream read from a read-only type medium and audio and graphics data read from a rewritable type recording medium (which may be built-in/external/removable information recording medium readable by the player). To apply such an Out-of-MUX framework, it is necessary that the video stream as the main movie content and the audio and graphics data are read from different recording media.

However, the download data includes many data files that are to be used by a Java™ application to operate, and such data files do not necessarily require the Out-of-MUX framework which is for playing back two digital AV streams at the same time. With the conventional virtual package, such data files, as downloaded data to be used by Java™ application to operate, are stored in a rewritable medium separately from the BD-ROM. Accordingly, it is difficult for the user to prevent the data management of the user's belongings from getting complex.

In view of this problem, the fourth object of the present invention is to provide a disc medium that is capable of resolving the complexity of the management of the user's belongings.

The fourth object is fulfilled by a disc medium having two or more recording layers thereon.

The fourth object is fulfilled by a disc medium that has two or more recording layers each applying a different recording method, wherein the recording layers include: a first recording layer that is a read-only area; and a second recording layer that is a writable area or a rewritable area, and when loaded on a playback apparatus, the disc medium has the playback apparatus generate a virtual package by combining contents recorded on the first recording layer and the second recording layer according to playback control information recorded on the second recording layer, and play back the virtual package.

With the stated structure, as the playback apparatus stores the downloaded data into the writable layer of the disc medium, the playback apparatus can generate a virtual package when the disc medium is loaded, and play back the virtual package. Accordingly, the user can enjoy the playback in combination with the downloaded data without storing the downloaded data in a separate recording medium.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows a structure of a recorder according to the first embodiment of the present invention;

FIG. 2 shows a structure in conformity with a BDAV application standard according to the first embodiment of the present invention;

FIG. 3 shows a structure of HDVD-VR according to the first embodiment of the present invention;

FIG. 4 shows combinations of physical media and application standards according to the first embodiment;

FIG. 5 shows an example of a warning message displayed at reproduction by the recorder according to the first embodiment;

FIG. 6 is a first flowchart of the first embodiment;

FIG. 7 shows an example of a warning message displayed at recording by the recorder according to the first embodiment;

FIG. 8 is a second flowchart of the first embodiment;

FIG. 9 shows an example of a selection message for a hybrid disc according to the first embodiment;

FIG. 10 is a third flowchart of the first embodiment;

FIG. 11 is a first flowchart showing priority selection in the first embodiment;

FIG. 12 is a second flowchart showing the priority selection in the first embodiment;

FIG. 13 shows a method for identifying a disc;

FIG. 14 shows a method for identifying a medium;

FIG. 15 shows correlation between a hybrid recorder/a PC and media;

FIG. 16 explains contents management on a built-in HDD of a hybrid recorder;

FIG. 17 shows a data structure of a play list;

FIG. 18 explains reference sections in a format-mixed play list;

FIG. 19 explains a dubbing-configuration selection screen of a recorder;

FIG. 20 explains the dubbing-configuration selection screen of a recorder;

FIG. 21 is a flowchart showing a flow of processing by the dubbing-configuration selection screen;

FIG. 22 explains time required for dubbing;

FIG. 23 explains time required for dubbing a format-mixed play list;

FIG. 24 shows an example of an initial configuration screen of a hybrid recorder;

FIG. 25 schematically shows content management based on format duplication;

FIG. 26 shows contents recorded on a first format recording area and a second format recording area;

FIG. 27 shows how to present a free disc space to a user at recording;

FIG. 28 shows how to present the free disc space to the user if a recording area of the built-in medium is divided in a recording area for a low-priority format and a recording area for a high-priority format;

FIG. 29 shows an example GUI for accepting a user's policy for saving data;

FIG. 30 shows management information used for managing format-dependent data that is “to be deleted by priority”;

FIG. 31 shows an internal structure of a recording apparatus according to the fourth embodiment;

FIG. 32 is a flowchart showing processing procedures for scheduling a recording;

FIG. 33 shows an example GUI for determining priorities of application formats based on prices of media;

FIG. 34 is an example GUI for accepting a priority configuration for each of channels;

FIG. 35 shows a recording configuration GUI 801 for scheduling recording of TV programs;

FIG. 36 shows a recording information table 901;

FIG. 37 shows a dubbing configuration GUI 1001 used for copying TV programs recorded on a HD drive 202 to an optical disc medium such as a BD and an HDVD;

FIG. 38 is a flowchart showing processing procedures performed by the user to schedule recording of TV programs;

FIG. 39 is a flowchart showing processing procedures for recording a TV program in accordance with recording schedule information;

FIG. 40 is a flowchart showing processing procedures for copying a TV program to an optical disc medium according to dubbing configuration information configured by the user;

FIG. 41 shows a GUI used for notifying the user of a time required for dubbing, with respect to each disc medium;

FIG. 42 shows a disc having recorded thereon subdirectories, namely an HDVD directory and a BD directory, under a root directory;

FIG. 43 shows an internal structure of a hybrid medium;

FIG. 44 shows a dubbing configuration GUI 1001 used for copying a TV program recorded on an HDD 202 to a BD/DVD hybrid disc;

FIG. 45A to FIG. 45C are pie charts showing transitions of usage rates of a designated layer and an undesignated layer;

FIG. 46 shows an example of a hybrid recording information table 2001;

FIG. 47 shows a program navigator 210 for TV programs recorded on a BD/DVD hybrid disc;

FIG. 48 is a flowchart showing processing procedures for copying TV program to a BD/DVD hybrid disc in accordance with dubbing configuration information configured by the user;

FIG. 49 is a flowchart showing processing procedures for writing data onto the both layers of a BD/DVD hybrid disc;

FIG. 50 is a flowchart showing processing procedures for deleting a TV program from a BD/DVD hybrid disc in accordance with deletion configuration information configured by the user;

FIG. 51 shows a GUI that shows copy destinations by a pull-down menu and enables the user to select a preferable medium format;

FIG. 52 shows a GUI that enables the user to select either of the layers of a hybrid medium on which a TV program is to be record;

FIG. 53 shows an internal structure of a hybrid medium that has a BD-RE recording layer and a BD-ROM recording layer;

FIG. 54 shows an internal structure of INDEX.TBL;

FIG. 55 shows a directory structure of the BD-RE recording layer;

FIG. 56A shows an internal structure of a merge management information;

FIG. 56B shows a process of generation of a virtual package performed by a recording/playback apparatus;

FIG. 57 explains how to record a plurality of contents such as a series of TV programs;

FIG. 58 shows an example of format-dependent data stored in the HD drive 202;

FIG. 59 shows a method for calculating a recording rate for recording contents;

FIG. 60 shows a method for calculating a recording rate for recording contents respectively having different time lengths; and

FIG. 61 shows a flowchart for determining a recording mode for recording contents.

### DESCRIPTION OF THE PREFERRED EMBODIMENT

### The First Embodiment

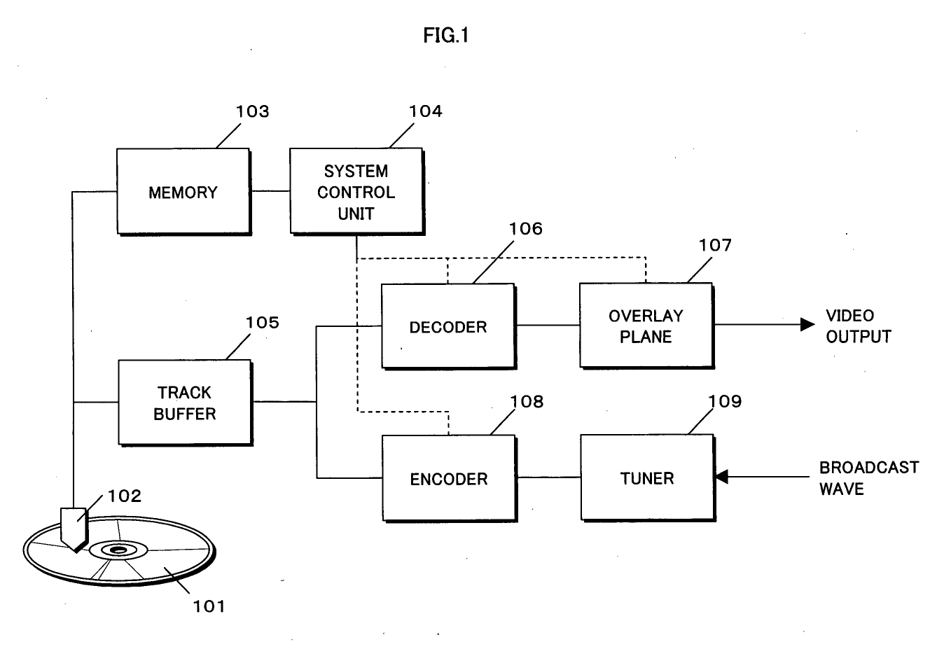

FIG. 1 shows a structure of a recorder according to the first embodiment of the present invention.

In FIG. 1, 101 is an optical disc medium. In this embodiment, a Blu-ray disc (BD-RE) or an HD-DVD disc (HDVD-RW) is used. The Blu-ray disc is an optical disc medium with use of a blue-violet laser, which has been standardized by the Blu-ray Disc Association. The HD-DVD is an optical disc medium which has been standardized by the DVD forum.

The Blu-ray disc is characterized by a protective layer of 0.1 mm and that recording and reading is performed with use of the blue-violet laser, so that the recording capacity of an optical disc medium having a diameter of 12 cm, which is the same as that of a CD and a DVD, is 25 GB with one layer, and 50 GB with two layers.

On the other hand, since the HD-DVD uses 0.6 mm protective layer which is the same as the DVD, the recording size is 15 GB with one layer and 30 GB with two layers. This is smaller than the capacity of the Blu-ray disc.

In FIG. 1, 102 is an optical pickup that reads or writes data on the optical disc medium. 103 is a memory for storing data other than AV data from the optical disc medium or storing data to be recorded on the optical disc medium. 104 is a system control unit for controlling the recorder at recording and reproduction.

105 to 109 are modules of the recorder, used for controlling the AV data. 105 is a track buffer for maintaining a constant transmission rate (72 Mbps, etc. for the Blu-ray) for recording on/reading from the optical disc medium. 106 is a decoder. 107 is an overlay plane for overlaying images, such as a graphics user interface, on the video data as a decoding result. 108 is an encoder. 109 is a digital tuner that inputs video and audio to the encoder (108).

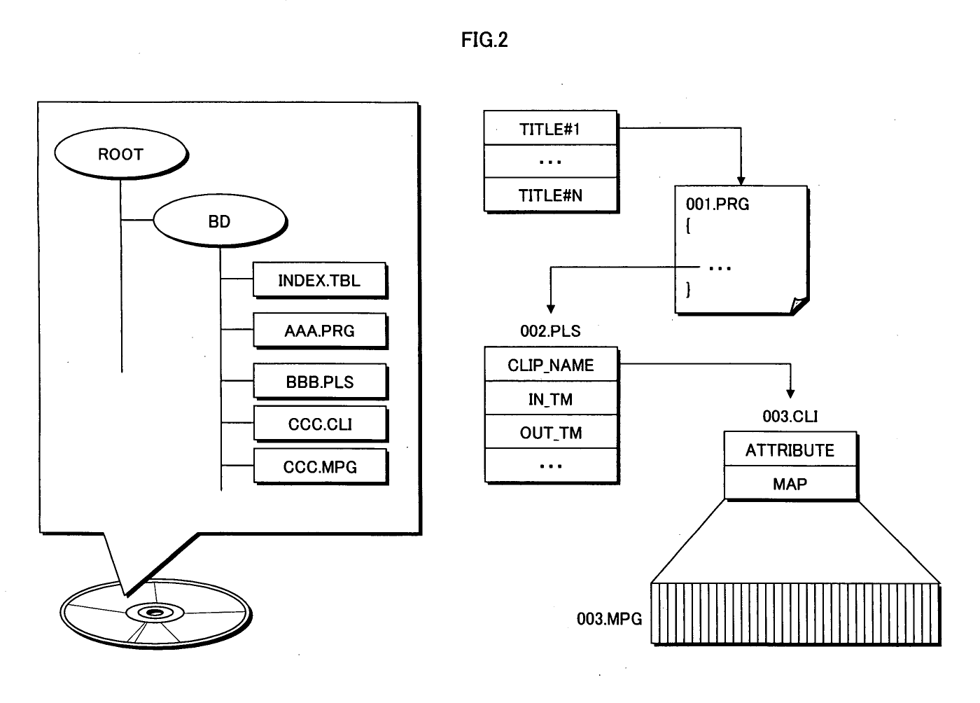

FIG. 2 shows a structure of an application format (BDAV) to be recorded on the Blu-ray Disc (BD-RE).

As FIG. 2 shows, pieces of data in the application format are provided with being recorded as a file by a file system. The file system used for the Blu-ray disc is the UDF (Universal Disk Format) version 2.5.

Each piece of the application data is recorded in a form of a file in a dedicated directory (BD) on the ROOT. The application data is constituted of five types of files (“INDEX.TBL”, “AAA.PRG”, “BBB.PLS”, “CCC.CLI” and “DDD.MPG”) “AAA”, “BBB”, “CCC” and “DDD” respectively represent prescribed decimal numbers. Practically, they are recorded as “000.PRG”, “002.CLI”, or the like.

The “INDEX.TBL” is index information of titles. The title is a unit that the user can recognize. For example, one title corresponds to one TV program that the user has recorded. The user can specify a program to be reproduced by instructing “reproduction of title No. N”, for example. Specifically, the INDEX.TBL includes a plurality of pieces of title information (TITLE#1 to TITLE#N), and each piece of the title information includes a file number of a program (the number “AAA” of the “AAA.PRG”) to be executed.

The “AAA.PRG” includes a program to be designated and executed from a title. There are a plurality of program files and a prefix (AAA) is used for identifying the programs. The programs used in the Blu-ray are proprietary interpreter programs called command navigations. However, the language type is not the essence of the present invention. Therefore, general-purpose programming languages, such as Java and Java Script, may be used. The program designates a play list to be reproduced.

The “BBB.PLS” includes play list information. The play list information is information for statically managing reproduction paths. The reproduction order of a section in actual AV data (CLIP_NAME) is defined by specifying a start point (IN_TM) and an endpoint (OUT_TM). As in the case of the program files, the prefix (BBB) is a prescribed decimal number used for identifying the play lists. The program designates the play list number (BBB) to specify the play list.

The “CCC.CLI” includes management information for the actual AV data. The management information can be roughly classified into two types. One is attribute information (ATTRIBUTE), which includes information used at decoding, such as codec types of video, audio and subtitles, the number, and language attributes. The other one is addressing information (MAP), which is a table for acquiring are production start address when, for example, a random access (skip reproduction) to a position of thirty minutes from the beginning is attempted. This table is used because the video codec used in the Blu-ray performs encoding with use of a variable bit rate (VBR).

As in the case of the program information and the play list information, the prefix (CCC) is a prescribed decimal number used for identifying the management information (CCC.CLI).

Using the number “CCC”, the above-described play list (BBB.PLS) can specify the actual AV data at the link destination.

The “CCC.MPG” is the actual AV data. In the case of the Blu-ray Disc, the AV data is multiplexed in the form of the MPEG Transport Stream (generally called “MPEG-TS”) that is standardized by ISO/IEC13818. In each piece of the AV data, video data is encoded and recorded with use of any of MPEG-2, MPEG-4AVC and SMPTE VC-1, and audio data is compressed and encoded with use of any of Dolby AC-3, Dolby Digital Plus, MLP, DTS, DTS-HD and linear PCM.

Each piece of the actual AV data and the management information of the AV data are associated each other by a common prefix (CCC).

At the playback of the Blu-ray disc, the “INDEX.TBL”, the “AAA.PRG”, the “BBB.PLS” and the “CCC.CLI”, which are shown in FIG. 2, are stored in the system memory (103) explained in FIG. 1, read by the system control unit (104), and analyzed and executed.

The “CCC.MPG” of FIG. 2 is stored in the track buffer (105) explained in FIG. 1, and is read by the decoder (106), and decoding processing is carried out.

At the recording onto the Blu-ray disc on the other hand, the “AAA.PRG”, the “BBB.PLS” and the “CCC.CLI”, which are shown in FIG. 2, are generated in the system control unit (104) explained in FIG. 1, stored in the system memory (103), and recorded on the optical disc medium (101) via the optical pickup (102) at the end of the recording.

An AV stream is generated from the “CCC.MPG” of FIG. 2 by the encoder (108) explained FIG. 1, and temporarily stored in the track buffer (105), and then recorded on the optical disc medium (101) via the optical pickup (102).

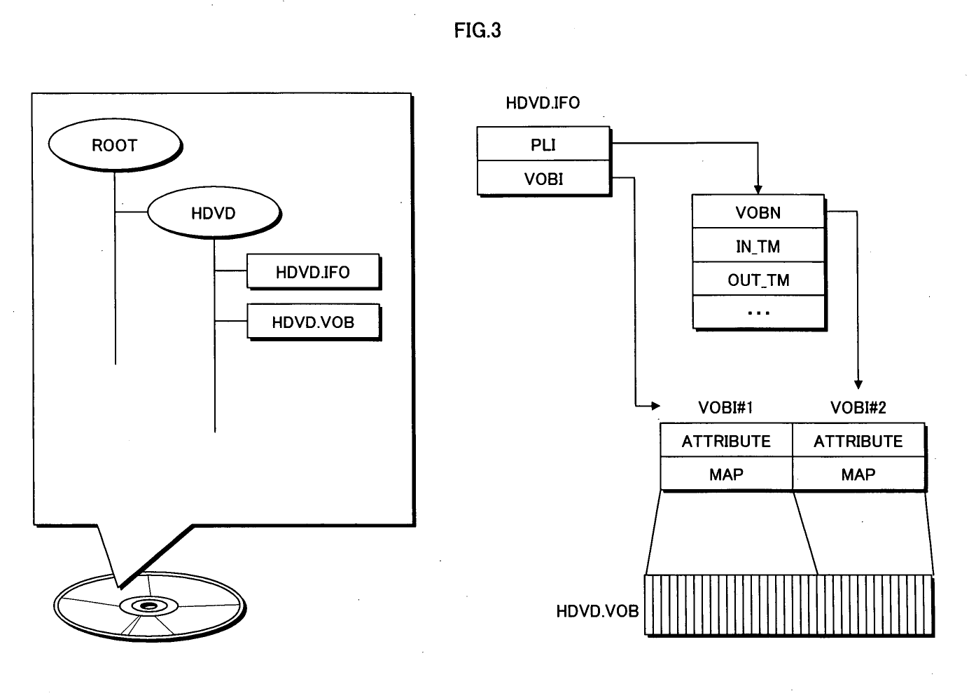

FIG. 3 shows the structure of the application format (HDVD-VR) to be recorded on the HD-DVD (HDVD-RW).

As FIG. 3 shows, as in the case of the Blu-ray disc, pieces of data in the application format are provided with being recorded as a file by a file system. The file system used for the HD-DVD disc is the UDF (Universal Disk Format) version 2.5, which is the same as in the Blu-ray disc.

Each piece of the application data is recorded in a form of a file in a dedicated directory (HDVD) on the ROOT. The application data is constituted of two types of files (“HDVD.IFO” and “HDVD.VOB”). The “HDVD.IFO” includes management information, and the “HDVD.VOB” includes actual AV data.

The “HDVD.IFO” includes all the pieces of management information. Information corresponding to the “INDEX.TBL”, the “BBB.PLS” and the “CCC.CLI” of the Blu-ray explained in FIG. 2 is recorded as one file. The information included in the “HDVD.IFO” is roughly classified into two types of information, namely play list information (PLI) and stream management information (VOBI).

The play list information (PLI) is a table of play lists, and this table is equivalent to the INDEX.TBL of the Blu-ray. Each play list is equivalent to the “BBB.PLS” or the Blu-ray disc.

Each play list is, as in the case of the Blu-ray disc, static reproduction scenario information including reproduction section information defined by a combination of a reproduction start point (IN_TM) and a reproduction end point (OUT_TM) of actual AV data (VOBN) and chain information (a list of VOBN) that defines reproduction sections by the order of the reproduction.

The stream management information (VOBI) is a table of pieces of management information, each corresponding to a stream. Each piece of the management information corresponds to the AV data management information (the CCC.CLI) of the Blu-ray disc.

The management information for each stream is roughly classified into two types. One is attribute information (ATTRIBUTE), which includes information used at decoding, such as codec types of video, audio and subtitles, the number, and language attributes. The other one is addressing information (MAP), which is a table for acquiring a reproduction start address when, for example, a random access (skip reproduction) to a position of thirty minutes from the beginning is attempted. This table is used because, as in the case of the Blu-ray, the video codec used in the HD-DVD performs encoding with use of a variable bit rate (VBR).

At the playback of the HD-DVD, the “HDVD.IFO” of FIG. 3 is stored in the system memory 103 explained in FIG. 1, read by the system control unit (104), and analyzed and executed.

The “HDVD.VOB” of FIG. 3 is stored in the track buffer (105) explained in FIG. 1, and is read by the decoder (106), and decoding processing is carried out.

At the recording onto the HD-DVD disc on the other hand, the “HDVD.IFO” of FIG. 3 is generated in the system control unit (104) explained in FIG. 1, stored in the system memory (103), and recorded on the optical disc medium (101) via the optical pickup (102) at the end of the recording.

An AV stream is generated from the “HDVD.VOB” of FIG. 3 by the encoder (108) explained FIG. 1, and temporarily stored in the track buffer (105), and then recorded on the optical disc medium (101) via the optical pickup (102).

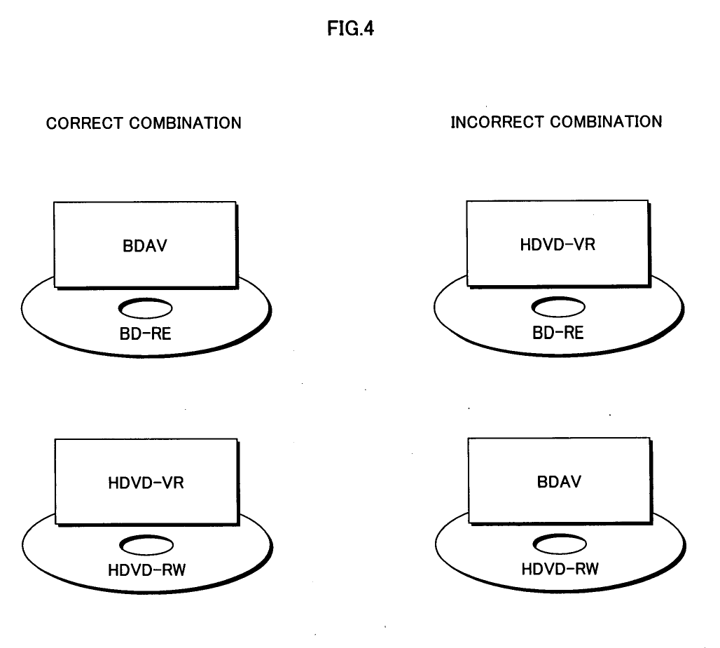

FIG. 4 shows issues of combinations of physical media and application standards raised in the first embodiment.

As shown on the left side of the FIG. 4, physical media and application standards are used in pairs. Although it can be considered that application standards are independent from physical media, since some application standards depend on physical media, they should be used in pairs for securing the compatibility.

In the case of incorrect combinations of physical media and application standards as shown on the right side of FIG. 4, it is impossible to secure functions that depend on the physical medium and are defined in the application standard.

Specifically, in the case of the BD-RE, it is defined that the reading rate of data from the medium is 72 Mbps at the maximum (spinning at so called “2× speed”), and the BDAV format to be recorded on the BD-RE medium is the MPEG-TS of 48 Mbps at the maximum (The MPEG-TS is the MPEG Transport Stream for multiplexing video and audio that is internationally standardized by ISO/IEC13818).

On the other hand, in the case of the HD-DVD, it is defined that the reading rate of data from the medium is 33 Mbps at the maximum (spinning at so called “2× speed”), and the HDVD-VR format to be recorded on the HDVD-RW medium is the MPEG-PS of 48 Mbps at the maximum (The MPEG-PS is a program stream internationally standardized by ISO/IEC13818). Therefore, if a BDAV is recorded on an HDVD-RW medium, since the reading rate 30 Mbps from the HDVD-RW medium is smaller than the maximum recording rate 48 Mbps of the BDAV, the MPEG-TS can not be read on time, and can not be properly played back.

Dependence on physical media is not limited to the bit rate described above. In the case where AV-data can not be sequentially recorded on a medium, part of the AV data is recorded on successive areas and seeking is performed for dispersive recording so that the recording capacity of the medium is efficiently used. In such a case, the seek performance on the medium is dependent on the physical medium. Therefore, with the incorrect combinations of the physical media and applications, it is difficult to secure that the continuous playback and the continuous recording are properly performed.

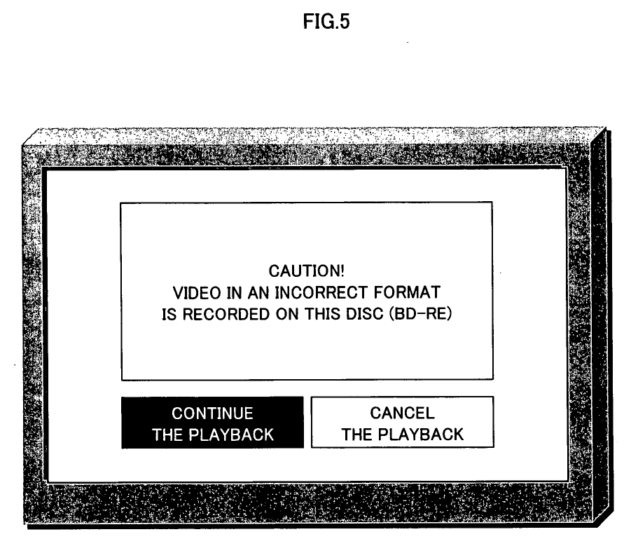

FIG. 5 shows an error message displayed by the recorder according to the first embodiment if an incorrect combination of a physical medium and an application standard shown in FIG. 4 occurs.

As FIG. 5 shows, if an incorrect combination of a physical medium and an application standard is detected, the recorder warns the user that recording has not been performed correctly, and prompts the user to select whether to continue the playback on the understanding that the playback can not be performed correctly or cancel the playback.

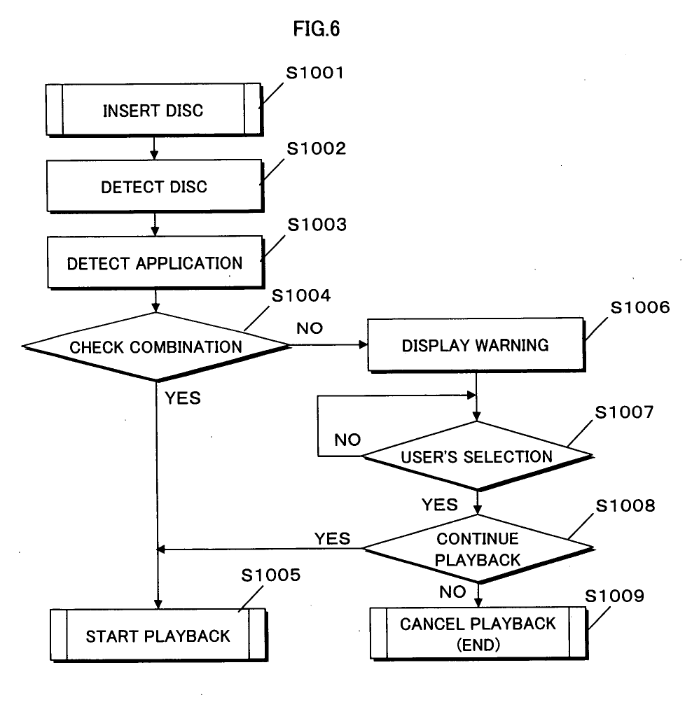

FIG. 6 is a flowchart showing playback performed by the recorder according to the first embodiment.

Upon insertion of the disc (Step S1001), the recorder performs disc detection (Step S1002), and judges whether the inserted disc is a Blu-ray disc (BD-RE) or an HD-DVD disc (HDVD-RW).

Next, in an application detection step (Step S1003), the recorder judges whether the application standard in which the data is recorded on the medium is the Blue-ray disc type (BDAV) or the HD-DVD type (HDVD-VR). This judgment is performed based on the recorded directory names and file names as described above.

Next, the recorder judges whether the combination of the identified physical medium and application standard is appropriate (Step S1004). As FIG. 5 shows, if the HDVD-VR is recorded on the BD-RE or the BDAV is recorded on the HDVD-RW, warning message displaying processing (Step S1006) is performed, because the combination is inappropriate. If an appropriate combination is detected, playback start processing (Step S1005) is performed.

If it is judged in Step S1004 that the combination is inappropriate, the warning message displaying processing (Step S1006) is performed. The warning message is displayed by the system control unit (104) drawing the message explained in FIG. 5 on the overlay plane (107).

After Step S1006 is performed, the recorder waits for the user's selection (Step S1007). Step S1007 is repeated until the user's selection is input.

Upon receiving a selection by the user in Step S1007, the recorder judges whether the user's selection is the continuation of the playback (Step S1008). If the user's selection is the continuation of the playback, the recorder performs the Step S1005 to continue the playback. If the user's selection is the cancellation of the playback, the recorder cancels the playback (Step S1009).

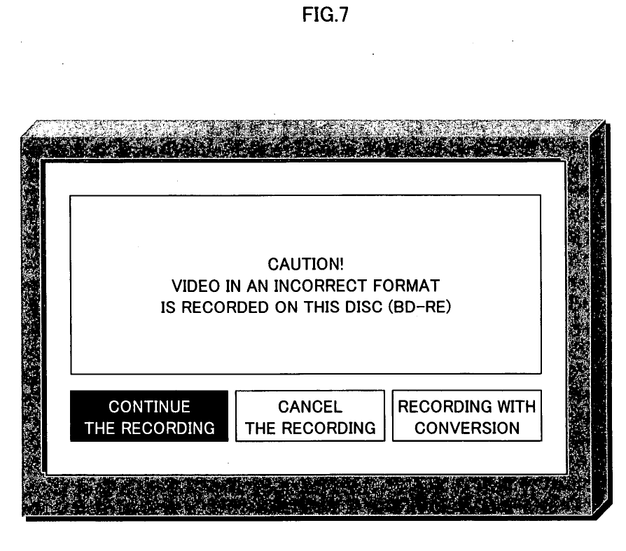

FIG. 7 shows an example according to the first embodiment showing a case where the user records a broadcast program. As described in FIG. 4, if an in appropriate combination of a physical medium and an application standard occurs, the recorder displays an error message as shown in FIG. 7, because the recording processing of the recorder can not be secured.

As FIG. 7 shows, if an incorrect combination of a physical medium and an application standard is detected, the recorder warns the user that recording is not performed correctly, and prompts the user to select whether to continue the recording on the understanding that the recording can not be performed correctly or cancel the recording, or appropriately convert the already recorded data to secure the recording afterwards.

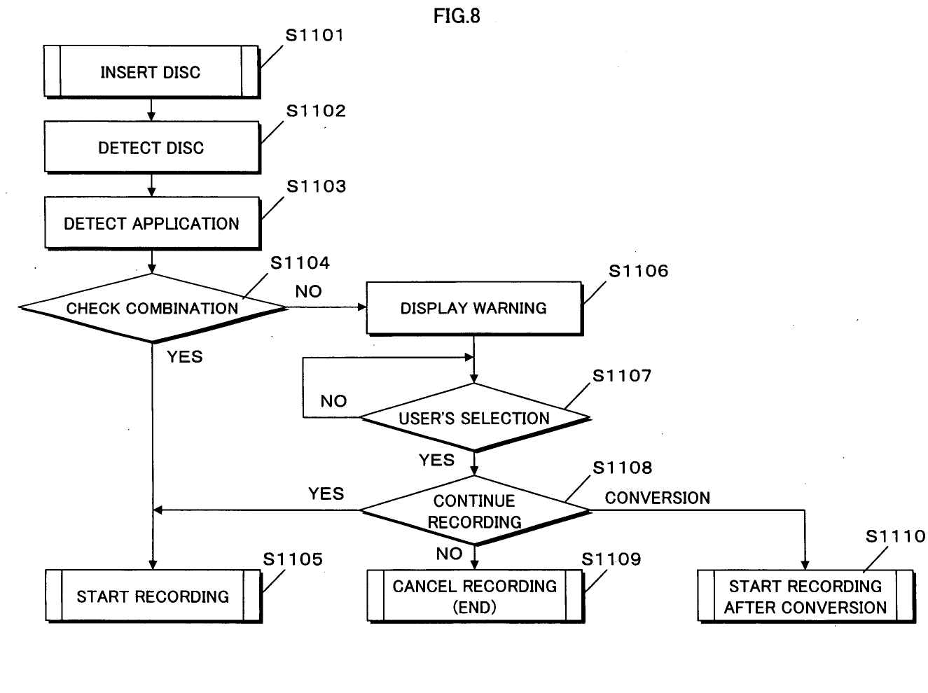

FIG. 8 is a flowchart showing the recording processing performed by the recorder according to the first embodiment.

Upon insertion of the disc (Step S1101), the recorder performs disc detection (Step S1102), and judges whether the inserted disc is a Blu-ray disc (BD-RE) or an HD-DVD disc (HDVD-RW).

Next, in an application detection step (Step S1103), the recorder judges whether the application standard in which the data has been recorded on the medium is the Blue-ray disc type (BDAV) or the HD-DVD type (HDVD-VR). This judgment is performed based on the recorded directory names and file names as described above.

Next, the recorder judges whether the combination of the identified physical medium and application standard is appropriate (Step S1104). As FIG. 5 shows, if the HDVD-VR is recorded on the BD-RE or the BDAV is recorded on the HDVD-RW, warning message displaying processing (Step S1106) is performed, because the combination is inappropriate. If an appropriate combination is detected, recording start processing (Step S1105) is performed.

If it is judged in Step S1104 that the combination is inappropriate, the warning message displaying processing (Step S1106) is performed. The warning message is displayed by the system control unit (104) drawing the message explained in FIG. 5 on the overlay plane (107).

After Step S1106 is performed, the recorder waits for the user's selection (Step S1107). Step S1107 is repeated until the user's selection is input.

Upon receiving a selection by the user in Step S1107, the recorder judges whether the user's selection is the continuation of the recording (Step S1108). If the user's selection is the continuation of the recording, the recorder performs the Step S1105 to continue the recording. If the user's selection is the cancellation of the recording, the recorder cancels the recording (Step S1109). If the user's selection is to appropriately convert the recorded data and continue the recording, of the broadcast program, the recorder performs the data conversion (Step S1110).

In the data conversion, if the data is recorded on the BD-RE medium in the format of the HD-DVD application standard (HDVD-VR), the data format is to be converted from the HDVD-VR format to the BD-RE application standard (BDAV). If the data is recorded on the HDVD-RW medium in the format of the BD-RE application standard (BDAV), the data format is to be converted from the BDAV to the HDVD-VR.

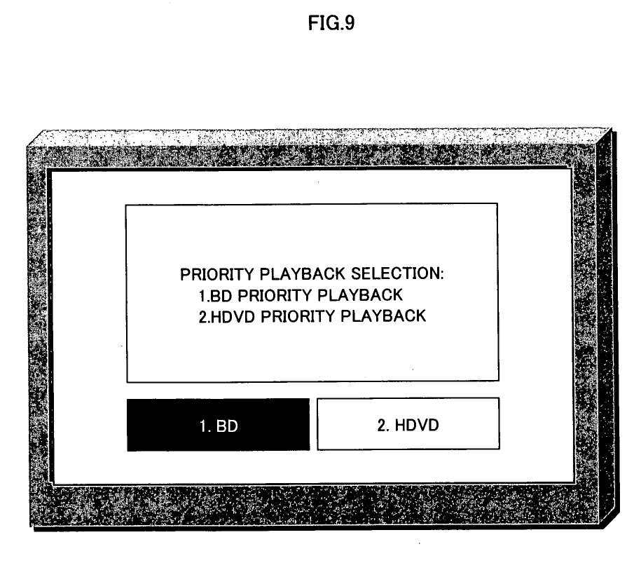

FIG. 9 explains the playback processing according to the first embodiment, performed by the recorder in the case where the two application formats, namely the BDAV and the HDVD-VR, are recorded on one disc.

If two application formats are recorded on one disc, the following can be considered as the reason: (1) the incorrect combination of a physical medium and an application standard is recorded on the disc together with a correct combination; or (2) a BD media layer and an HD-DVD media layer are pasted together to form one optical disc medium (a hybrid disc) having more than two layers.

FIG. 9 is a screen displayed in the case where the two applications are recorded, for prompting the user to select an application format to be used for the playback performed by the recorder. The user selects one application from the BDAV and the HDVD-VR, and the recorder executes the playback.

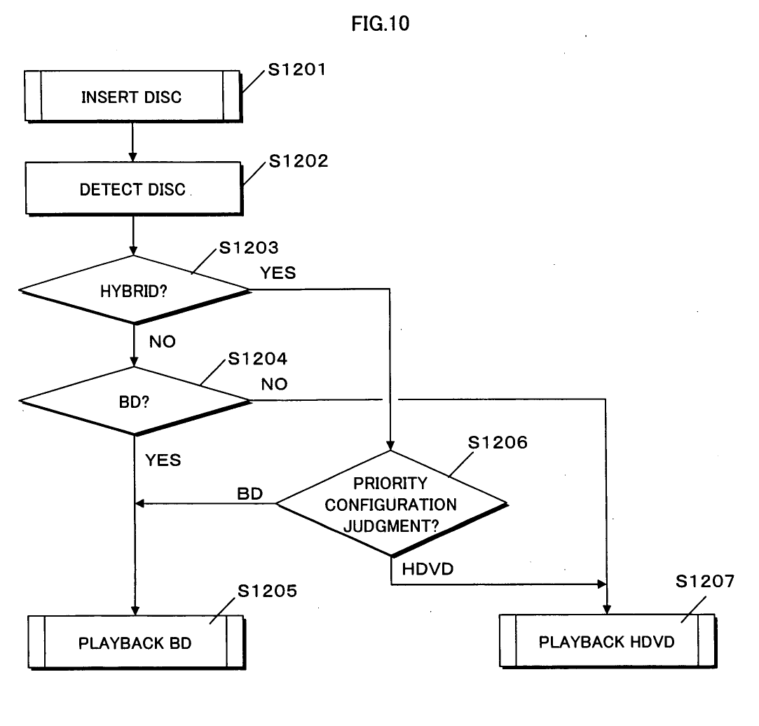

FIG. 10 is a flowchart showing playback of the hybrid disc performed by the recorder according to the first embodiment.

Upon insertion of the disc (Step S1201), the recorder performs disc detection-(Step S1202), and judges whether the inserted disc is a Blu-ray disc (BD-RE) or an HD-DVD disc (HDVD-RW or a hybrid disc (a combination of the BD-RE and the HDVD-RW).

In a hybrid disc judging step (Step S1203), if the detected disc is a hybrid disc, a priority configuration judging step is to be performed (Step S1206), and if the detected disc is no a hybrid disc, a BD judging step (Step S1204) is to be performed.

In Step S1204, if it is judged that the disc is a BD, the recorder performs BD playback, and if it is judged that the disc is an HD-DVD, the recorder performs HD-DVD playback (Step S1207).

In the case where it is judged in Step S1203 that the disc is a hybrid disc, if the priority configuration (Step S1206) is a BD, the recorder performs BD playback (Step S1205), and if the priority configuration is an HD-DVD, the recorder performs HD-DVD playback (Step S1207).

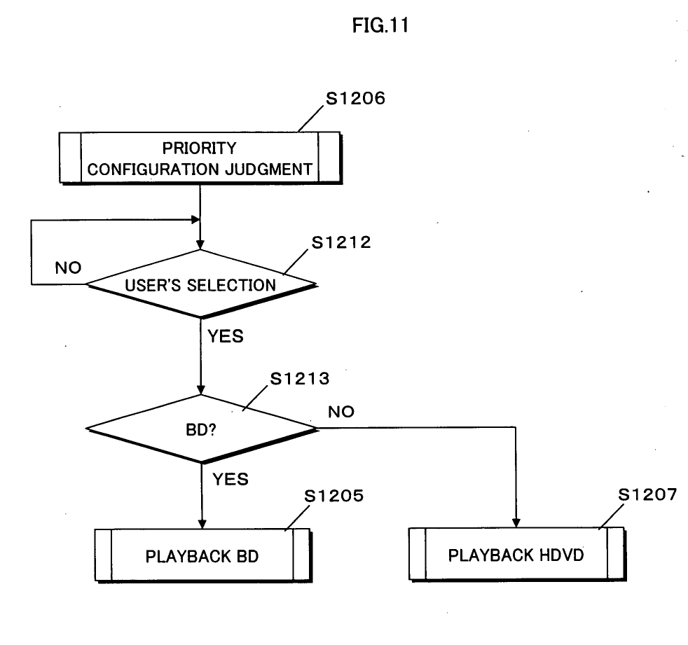

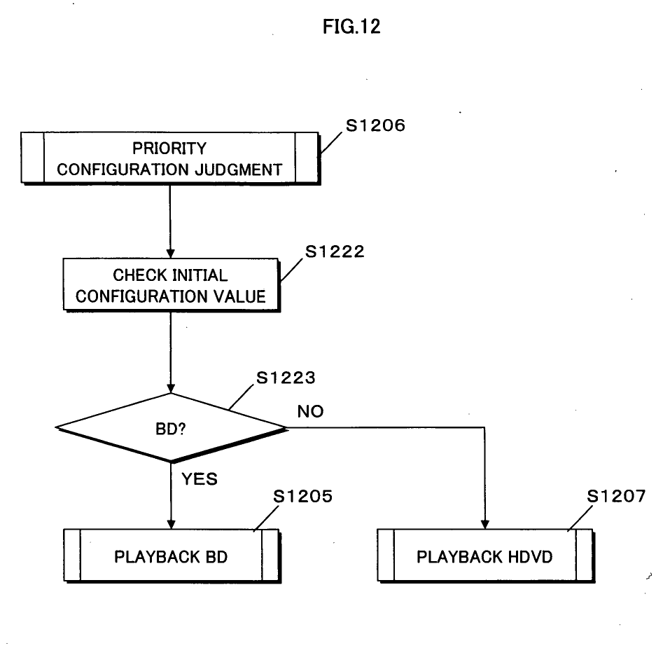

The following explains the priority configuration judging step in detail, with reference to FIG. 11 and FIG. 12.

FIG. 11 shows a case of prompting the user to make a selection. The recorder waits for a user's selection (Step S1212). Upon receiving the user's selection, the recorder judges whether the selection is BD playback (Step S1213). If the user's selection is BD playback, BD playback (Step S1205) is to be performed, and if the user's selection is the HD-DVD playback, HD-DVD playback (Step S1207) is to be performed.

The initial configuration value is stored in the memory (103) explained in FIG. 1, and recording and reading of the value are performed by the system control unit (104).

Although the data structures of the application formats of the Blu-ray disc and the HD-DVD are explained in the first embodiment, the detailed data structure, the file name, the file number, and the location of data are not related to the essence of the present invention, and they are not limited to those described in the first embodiment.

Also, in the first embodiment, although the present invention is described based on the Blu-ray disc and the HD-DVD, the present invention is not limited to these two formats. The present invention is applicable even if other different formats are used.

### The Second Embodiment

The following describes the second embodiment of the present invention.

The second embodiment relates to a method for simply showing the difference of the type of a medium to the user. This embodiment is basically based on the first embodiment. The following mainly describes extended part and the difference from the first embodiment.

With regard to optical disc media having a diameter of 12 cm, only as to read-only discs, there are many types such as CDs, DVD-Videos, BD-ROMs, HDVD-ROMs. They have the same size but different physical characteristics, or data formats of the recorded data and contents reproduction patterns are different. As writable optical discs having the same 12 cm size, there also are DVD-Rs, DVD-RAMs, BD-REs, and so on.

Since they are all 12 cm disc, it is difficult for users to identify of which type a medium is only from the appearance. Therefore, if no label describing the type is attached to the disc, users need to actually play the medium to identify the type.

In terms of this, the following considers methods for simply showing the type of a disc to the use at insertion of the disc or when the disc is inserted and can not be seen from outside but not being played. This is for preventing as much as possible that the user has a wrong type of a medium and plays back wrong contents.

The first method is to show a logo specific to the disc in the period from when the disc is inserted in the player and the disc type is identified by the player to when the playback of content recorded on the disc is started.

The identification of a disc includes two steps. One is identification of physical characteristics of the medium, and the other is identification of the application format of the data recorded on the disc. The identification of physical characteristics is based on the difference of the recording density and the material of the medium, by which CD, DVD-ROM, DVD-R, BD-ROM and BD-RE can be identified, for example. The identification of the application format is to identify the application format of data that can be recorded on a medium of the same type such as a DVD-R, by which DVD-Video, AVCHD can be identified, for example.

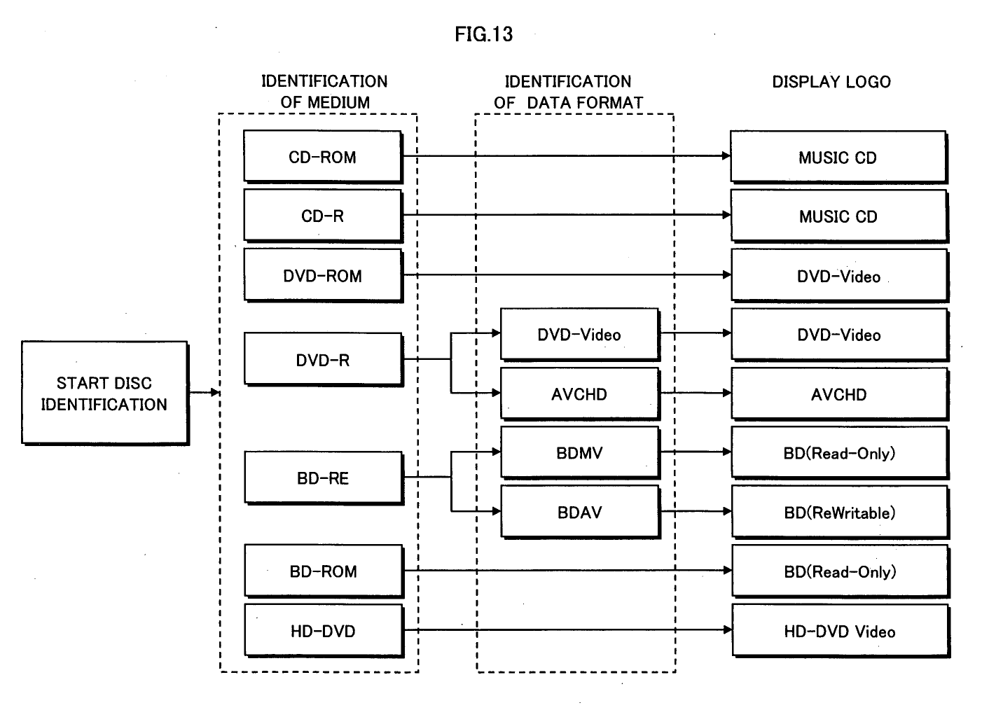

FIG. 13 shows methods for identifying a medium type. Optimization of the identification of physical characteristics of the medium and the identification of the application format is based on the medium data format supported by the player. Therefore, the following example explains a case where the player supports CD-ROM/CD-R for music use, DVD-Video recorded on DVD-ROM/DVD-R, AVCHD recorded on DVD-R, BDMV/BDAV contents recorded on a BD-RE medium, BDMV contents recorded on a BD-ROM medium and HD-DVD Video contents recorded on an HD-DVD medium.

When a medium is inserted in the player, the player identifies the medium based on the physical characteristics of the medium. At this stage, the player distinguishes a CD-ROM, a CD-R, a DVD-ROM, a DVD-R, a BD-ROM, a BD-RE and an HD-DVD, which are supported by the player. If the contents type is identified at the completion of the identification of the medium, the player displays the logo of the identified medium. If it is not clear whether the format of the data recorded on the medium is DVD-Video or the AVCHD based only on the identification of the medium, the player analyzes the recorded data and identifies the data format. If the data format is specified by the identification, the player displays the logo corresponding to the format.

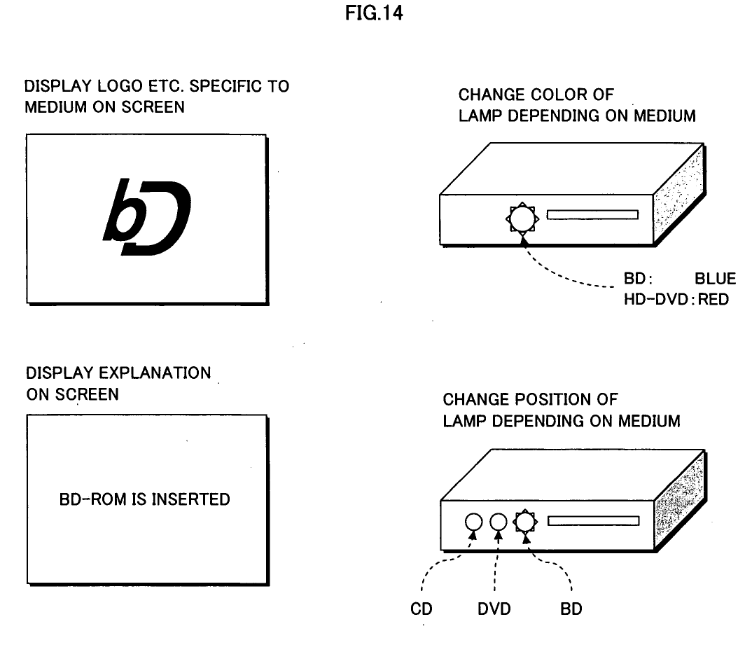

In the example above, the player displays the logo specific to the medium to show the medium type to the user. However, any methods or any combination of methods can be used as long as the medium type can be simply shown by the method. For example, FIG. 14 shows a method of displaying characters and icons, and a method of changing a color or a position of lamp on a screen, a front panel of the player or a remote control and so on.

With these methods for identification, the logo specific to the disc is displayed when the medium and the data format recorded thereon are identified. Accordingly, there is an advantage that the user can visually confirm that the disc that the user has inserted in the player is not wrong. If the user notices that the user has inserted a wrong disc, the user can replace the disc with a correct disc at the moment so as to prevent that a wrong disc is played back and time is wasted.

The second method is to show a logo specific to a disc in the case where the disc has already been inserted in the player but the playback is paused. The user can visibly confirm that a disc is inserted in the player, and also recognize the type of the medium. Accordingly, the user can easily judge whether to resume the playback of the disc or bring out the disc to replace it with another disc.

### The Third Embodiment

The following describes the third embodiment of the present invention.

The third embodiment relates to a method for simply showing to the user what operations are available in accordance with the medium type and the application format. This embodiment is basically based on the embodiments described above. The following mainly describes extended part and the difference from the embodiments above.

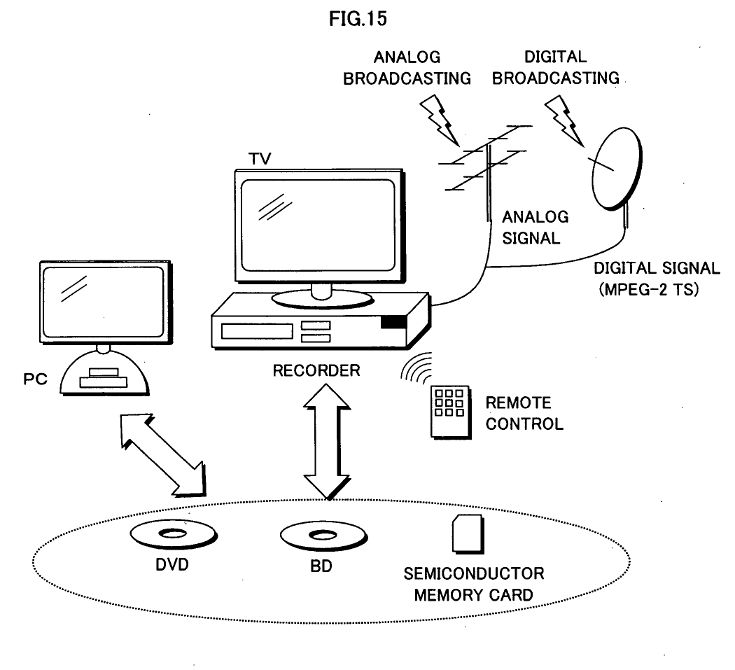

FIG. 15 shows a structure of apparatuses relating to the third embodiment. A recorder that receives broadcast signals and records the signals, and a DVD, a BD and a semiconductor memory card as media used with the recorder. Contents recorded on such media can be played back and recorded by a PC. A medium that has conventionally been able to record only data of the SD image quality can now record data of the HD image quality due to the advent of the AVCHD standard. As a result, the scope of choices is widened. This also causes confusion in the market.

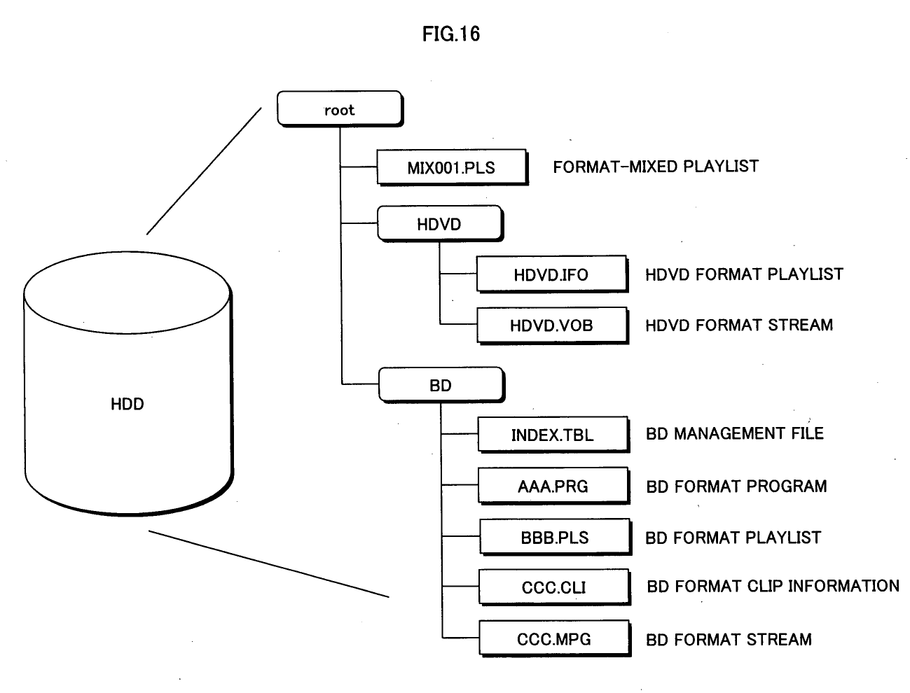

FIG. 16 shows contents recorded on the built-in HDD of the recorder that supports both BDs and HD-DVDs. As shown in the first embodiment, the data recorded in the HD-DVD format is stored in the HDVD folder and folders included therein, in conformity with the HD-DVD standard. In the same manner, the data recorded in the BD format is stored in the BD folder and folders included therein, in conformity with the BD standard.

In the case of such a BD/HD-DVD hybrid recorder, there is a demand for a function of flexibly creating a play list for the contents recorded on the built-in HDD, not depending on the application format. Since such a play list is in conformity with neither of the standards, it can be managed as reproduction path information (a MIX001.PLS file shown in FIG. 16) created in parallel with the BD and HDVD folders.

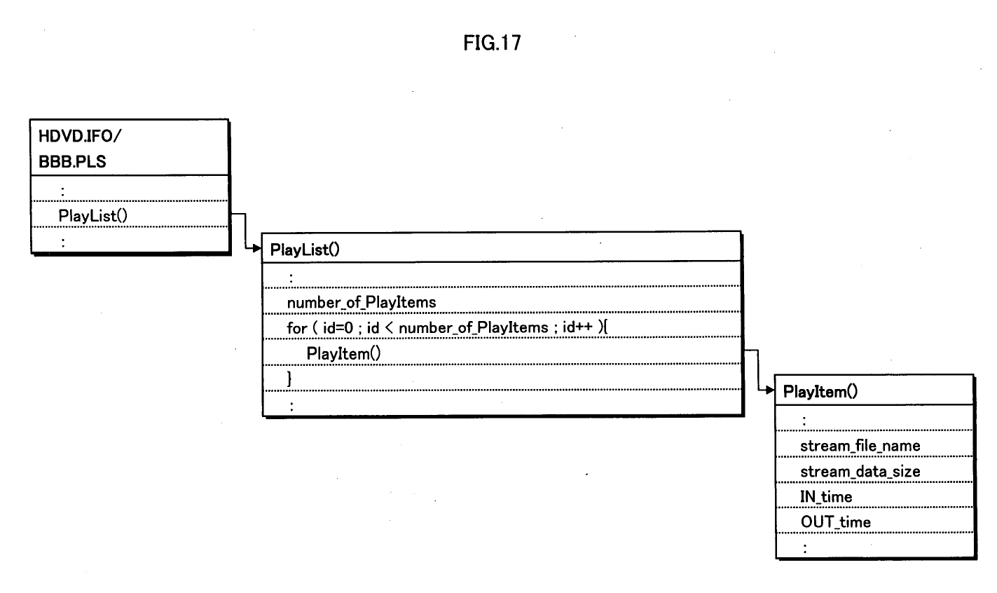

FIG. 17 is an example of the play list information. It is possible to define such play list information for both the BD and the HD-DVD. In a PlayList( ), a PlayItem corresponding to sequential reproduction sections of a stream is defined. Each PlayItem includes stream file information (stream_file_name) indicated by the PlayItem, data size information (sream_data_size) in the stream section to be referred to, start/end time information (IN_time, OUT_time) of the stream section to be referred to. By describing a plurality of PlayItems, it is possible to allow the user to play back specific sections of every stream in combination.

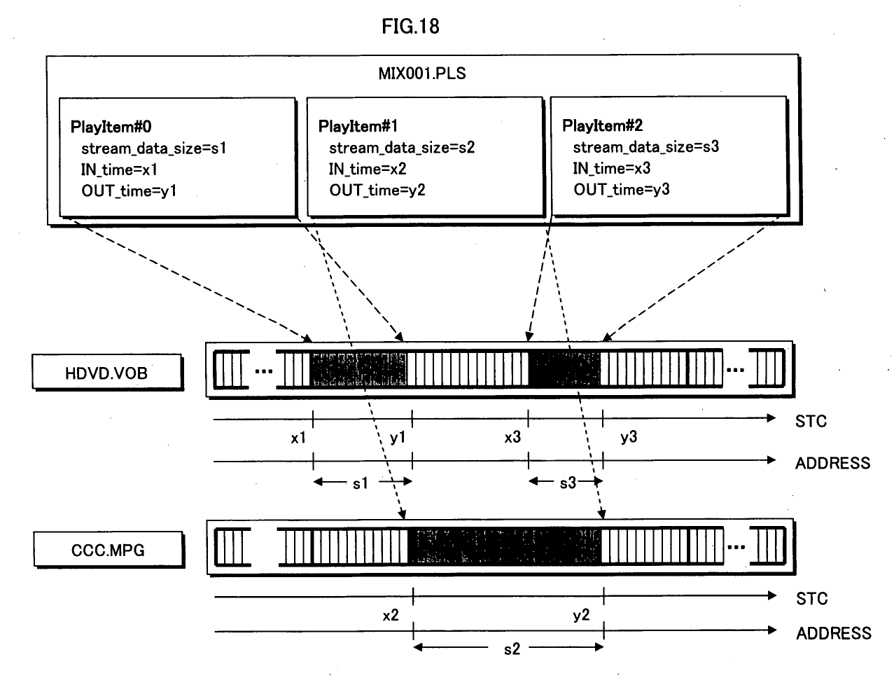

FIG. 18 shows an example of a play list (MIX001.PLS) for contents of both the BD and the HD-DVD. The MIX001.PLS includes three PlayItems. Each of the first and the last PlayItems refers to one section of a stream of the HD-DVD, and the second PlayItem refers to one section of a stream of the BD.

The total play time of this play list is (y1−x1)+(y2−x2)+(y3−x3), and the total data size of the streams is s1+s2+s3.

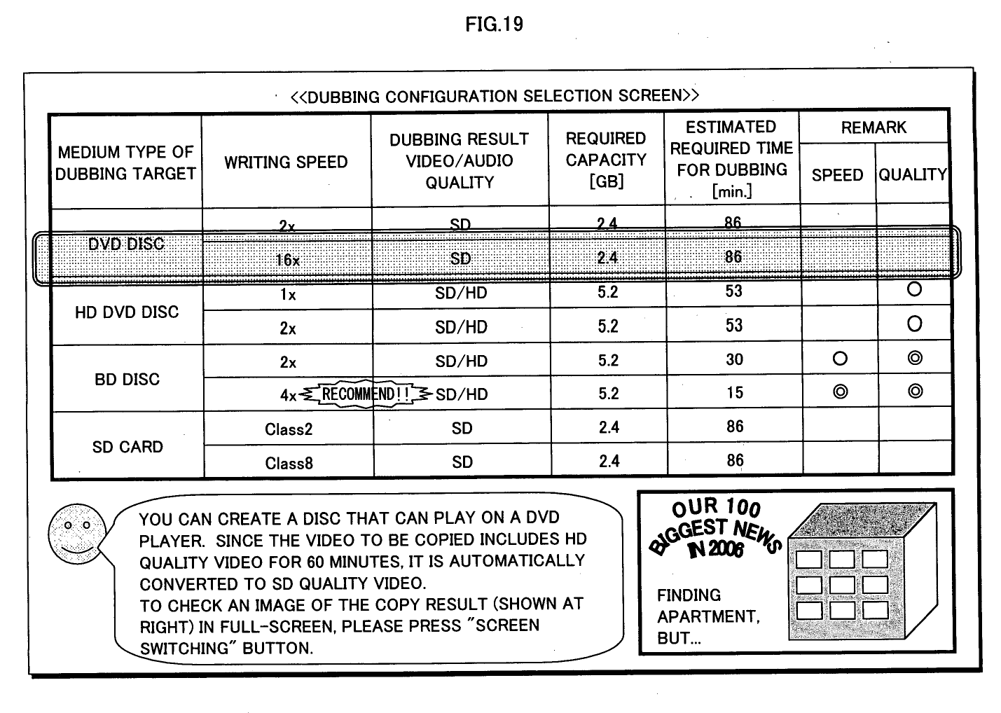

Here, in the case of writing out a video (a play list) recorded by the user on the built-in HDD to a disc, there is a possibility that the HDD stores a play list in the mixed/single format. Including this case, for dubbing such a play list to several media, it is convenient for the user if the characteristics of each medium are shown in a list. FIG. 19 shows an example of such a list.

FIG. 19 shows an example of a configuration screen used for dubbing performed by the recorder from the built-in HDD to a disc. The list shows a type of the media as the dubbing destination, the writing speeds (of the media), the qualities of copied video/audio as rough guides, required capacities (for the media), and estimated times for the dubbing. In the rightmost fields, remarks as to the dubbing speeds and the dubbing qualities are shown.

Also, at the bottom left corner, a comment for a currently selected dubbing configuration (dubbing to 16× DVD disc with the SD image quality) is shown. This comment explains in simple expressions that since the video to be copied includes an HD quality video, the dubbing is performed while converting the video to be in the DVD-Video standards such that the DVD player can playback the video.

At the bottom left corner, preview is performed for checking the video quality of the copied video. This preview can be shown in full-screen by pressing a “screen switch” button so that the user can check the quality precisely.

By showing the dubbing configuration in the form of a list, it is possible to easily tell the user the most suitable dubbing medium (in FIG. 19, it is judged that the 4× BD disc is the most suitable), the video quality as a result of the dubbing, and how much capacity and time are required.

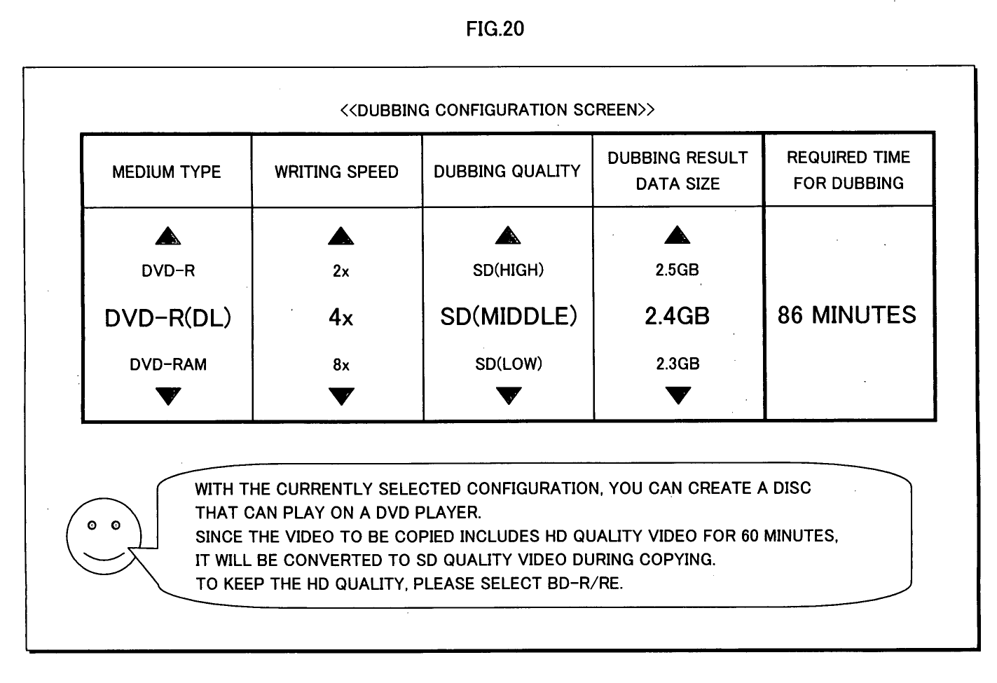

FIG. 20 shows another example of a dubbing setting screen. In this example, the user can change a specific parameter with up and down keys as checking the current parameter. The time required for the dubbing with the selected parameters is shown in a frame at the right. In other words, the time required for the dubbing is updated every time the medium type, the writing speed, the dubbing quality and the data size after the dubbing are changed by the user.

In the same manner as in FIG. 19, FIG. 20 shows an explanation of the currently selected dubbing configuration (dubbing to 4× DVD-R (DL) disc), and a guidance message for recommending use of a BD medium for the most suitable dubbing in terms of the dubbing time and the quality.

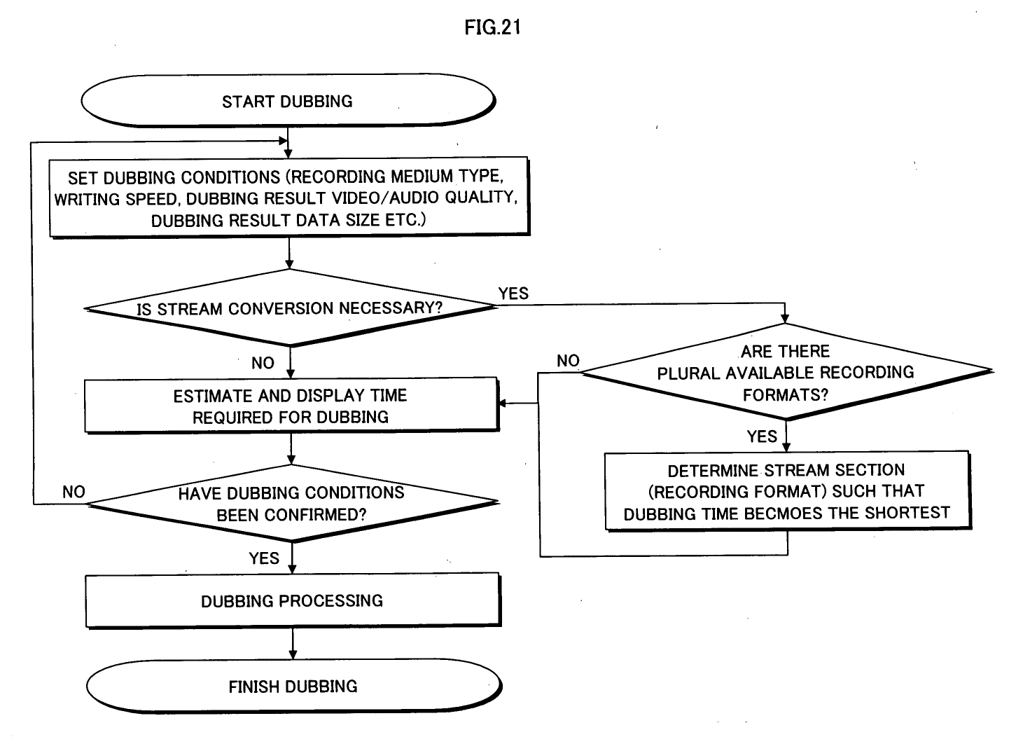

FIG. 21 shows a flow of the dubbing configuration required for providing such a user interface.

If the user instructs dubbing, the dubbing configuration including the type of the recording medium, the writing speed to the recording medium, the video/audio quality after the dubbing, the data size after the dubbing, and so on. Next, the recorder checks whether conversion of the stream is required for the dubbing configuration.

Whether the conversion is required is determined based on the relation between the application format on the HDD and the application form at after the dubbing is performed. Usually, if the application formats are different, the stream formats are different, and the conversion is required.

If there is any section (PlayItem) that requires the conversion, the recorder checks whether there are a plurality of formats that can be recorded on the media selected as the dubbing destination. If there are a plurality of selectable formats, the recorder selects an application format for the dubbing such that the dubbing time is the shortest. If it is impossible to select from a plurality of formats, the recorder estimates the time length required for the dubbing, and shows the time to the user.

If the user is satisfied with the dubbing configuration, the dubbing processing is started and the dubbing operation finishes. If the user is not satisfied, the dubbing configuration screen is to be displayed again.

In the explanation above, if there are a plurality of selectable formats, the recorder automatically selects an application format for the dubbing such that the dubbing time is the shortest. However, it is possible to ask the user again here, or automatically selects an application format such that the degradation of the image quality is the minimum.

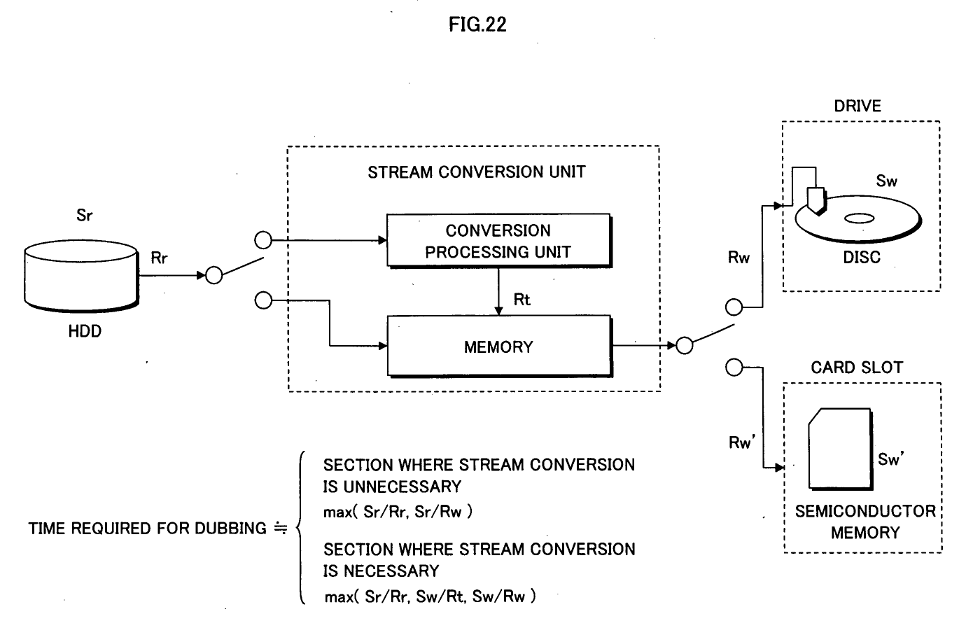

The estimation of the dubbing time is performed in the manner shown in FIG. 22. FIG. 22 shows a method for dubbing contents recorded on an HDD to a disc.

The contents to be copied are recorded on the HDD. Here, the reading speed of the HDD is Rr, the data size to be read is Sr, the processing speed of a conversion processing unit (transcoder) included in the stream conversion unit is Rt, the writing speed to the medium as the dubbing destination is Rw, and the data size to be written is Sw.

Regarding a section in which the conversion of the stream is not necessary, the data is read from the HDD, and directly transferred to the memory without going through the conversion processing unit, and recorded on a disc or a card. Therefore, if these operations are performed in parallel, the time required for the dubbing is the longest one between the time required for reading the data from the HDD (Sr/Rr) and the time required for writing the data on the disc (Sr/Rw).

Regarding a section in which the conversion of the stream is necessary, the data is read from the HDD, and the data converted by the conversion processing unit at the rate of Rt is transferred in the memory and recorded on a disc or a card. Therefore, if these operations are performed in parallel, the time required for the dubbing is the longest one among the time required for reading the data from the HDD (Sr/Rr), the time required for converting the stream format (Sw/Rt), and the time required for writing the data on the disc (Sw/Rw).

The “time required for the dubbing” described above does not include format conversion processing for the data base part and the finalize processing required depending on the type of the medium. However, the time required for the format conversion for the data base is as short as negligible compared to the format conversion of the stream. Therefore, the estimated time for processing the stream is practical enough for the user.

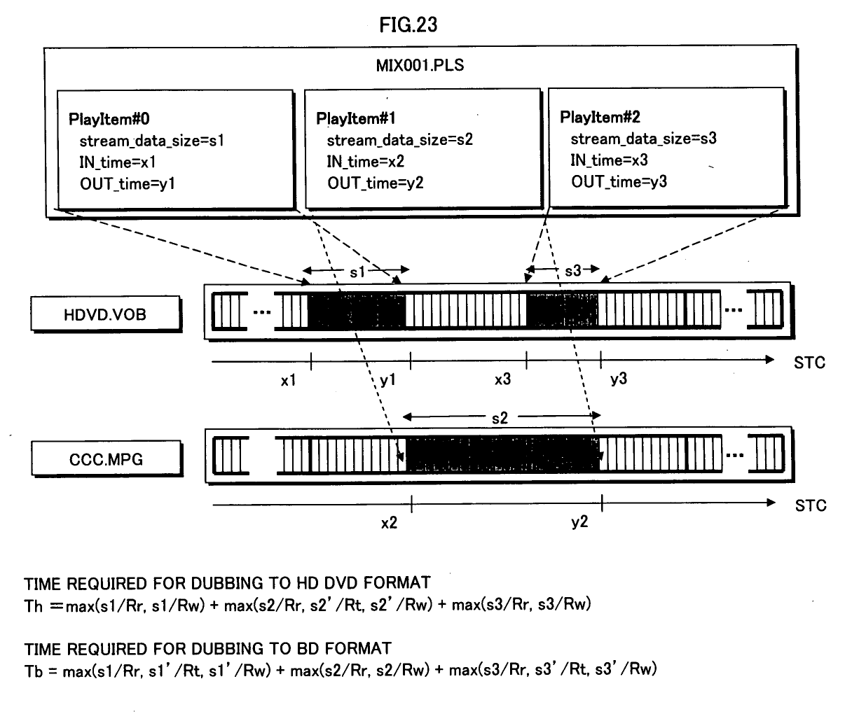

FIG. 23 shows methods for calculating time required for dubbing the MIX001.PLS including the both formats with converting the format to the HD-DVD format (Th in FIG. 23) and time required for dubbing the MIX001.PLS with converting the format to the BD format (Tb in FIG. 23). s1′ in the drawing represents a data size after the format of the stream of the PlayItem#0 having the data size s1 is converted to the BD format. This is same to s2′ and s3′. With this method, it is possible to estimate the time for conversion from the both stream format with a sufficient accuracy.

When the plurality of the application formats are selectable as FIG. 21 shows, the calculation and comparison for selecting the shortest time can be realized as shown in FIG. 23.

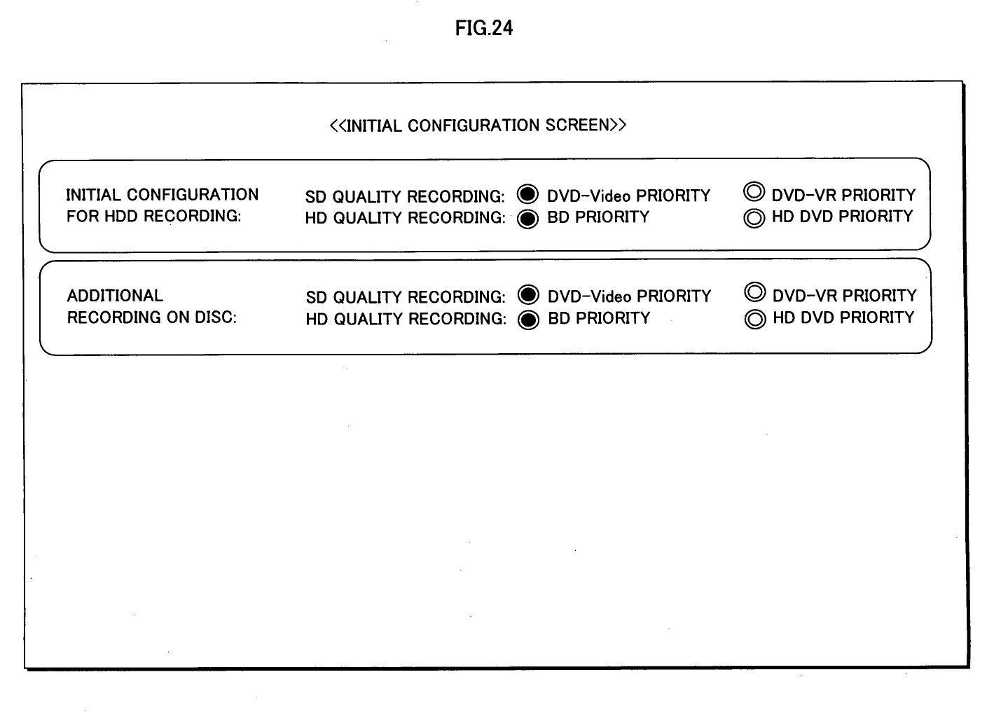

Here, as shown in FIG. 24, to prevent the case where there are a plurality of formats on the built-in HDD of the hybrid recorder that supports a plurality of application formats such as the BD and the HD-DVD, the application format for recording on HDD may be selected on the initial configuration screen in accordance with the user's preference. As a result, it becomes possible to avoid unnecessary format conversion, and the dubbing can be performed efficiently in terms of both time and the quality.

Also, by having the user select an application format not only for the recording on the built-in HDD, but also for the writing to the recording medium, the initial configuration screen can be used as a default of the dubbing screen shown in FIG. 19 and FIG. 20.

### The Fourth Embodiment

This embodiment relates to an improvement for recording content received in a form of broadcast signals after duplicating the format of the content. Here, “duplicating the format (format duplication)” means to convert the content to two or more pieces of data in different application formats, and write the pieces of data in the built-in medium.

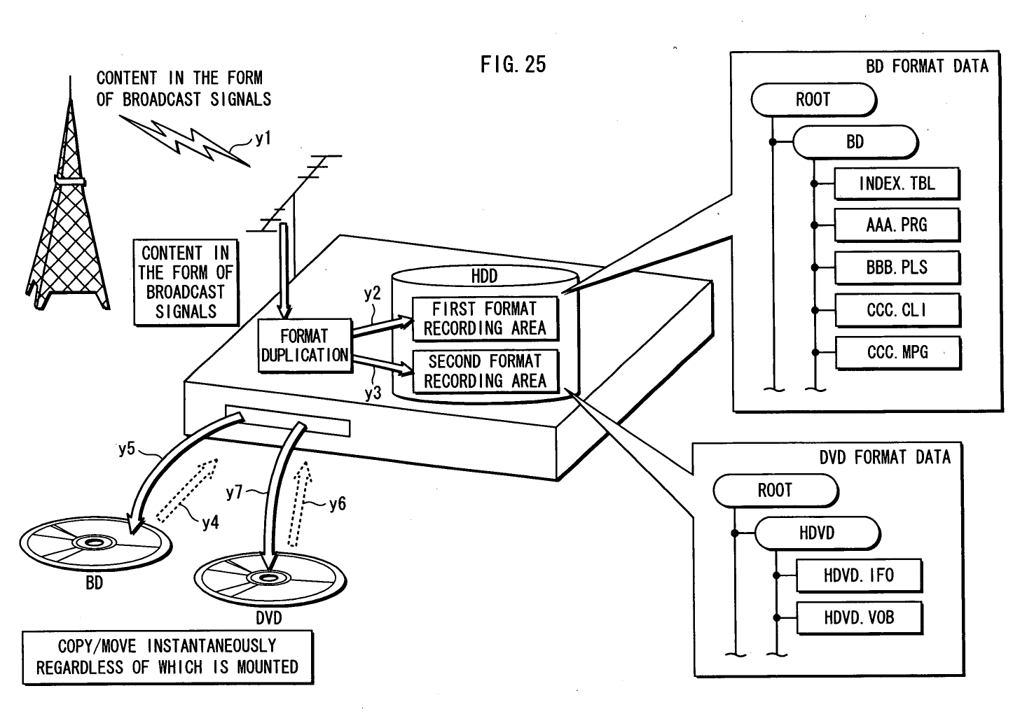

In this embodiment and the subsequent embodiments, it is assumed that the contents to be recorded are TV programs. FIG. 25 schematically shows content management based on the format duplication. The signs shown in FIG. 25 schematically represent traffic of a content in accordance with the format duplication. As an arrow y1 shows, the content transmitted from a broadcast station in a form of broadcast signals is received by an antenna of the recording/playback apparatus. Then, as arrows y2 and y3 show, the content is converted within the recording/playback apparatus into BD format data and DVD format data, and stored in the HDD. In this way, in this embodiment, the format of the content transmitted from the broadcast station is duplicated, and the content is recorded into the HDD, as two pieces of data, namely the BD format data and the DVD format data. Regarding the HDD in this embodiment, a recording area for BD format data is called “the first format recording area” and a recording area for DVD format data is called “the second format recording area”. Also, data recorded on the HDD or the like in a form that is dependent on the recording format of any one out of the BD format, the DVD format and so on is called “format-dependent data”.

A merit of performing the format duplication in order to record the broadcast signal into two or more different formats is that when a user performs copy or move of a TV program recorded on a HDD as a built-in medium to an optical disc medium, the data writing completes in a shorter period.

Here, the “move” is processing for copying a TV program to the optical disc medium and deleting the TV program recorded on the built-in medium as a copy source. In FIG. 25, when a BD is loaded into the recording/playback apparatus as an arrow y4 shows, BD format data is read from the first format recording area of the HDD, and the data is written into the BD-ROM as an arrow y5 shows. As a result, it is possible to perform the copy and the move to the BD at a high speed. When a DVD is loaded into the recording/playback apparatus as an arrow y6 shows, DVD format data is read from the second format recording area of the HDD, and the data is written into the DVD-Video as an arrow y7 shows. As a result, it is possible to perform the copy and the move to the DVD at a high speed.

The conventional mainstream method for recording a broadcast content on the built-in recording medium is to record the content in a single application format. If this is the case, if the format of the data recorded on the built-in medium is different from the format of the data acceptable to the optical medium, it is necessary to convert the TV program to be in the format that is acceptable to the optical disc medium. The format conversion should be performed before the copy or the move is performed. Accordingly, the processing time becomes long, and this is a problem. On the other hand, by recording the received broadcast wave on the built-in medium after converting the data to be in two or more formats corresponding to a plurality of envisioned optical disc medium types, it is possible to realize high-speed copy and move of the content from the built-in medium to the Blu-ray/HD-DVD drive.

If a content is converted into pieces of data in two or more application formats when acquired, it is possible to speed up the copy and the move from the built-in medium to the removable medium.

### Presentation of Amount of Free Space to Users

However, this can be a problem even though it realizes such high-speed dubbing. Because if the content is converted to contents in two or more formats and recorded, the built-in medium will be filled to capacity more quickly than expected by the users. To avoid such a negative effect, the recording apparatus of this embodiment presents to the user, after the recording, the total of an actual free disk space on the built-in medium and a prescribed offset. The prescribed offset represents the size of a disc space occupied by any of two or more pieces of application data to be deleted by priority, among pieces of application data recorded in different application formats.

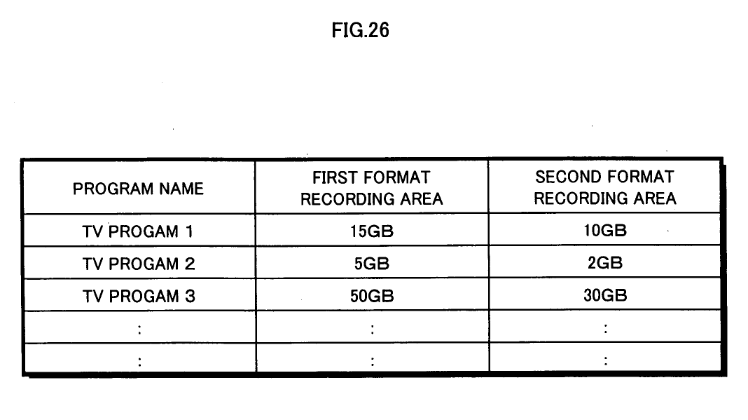

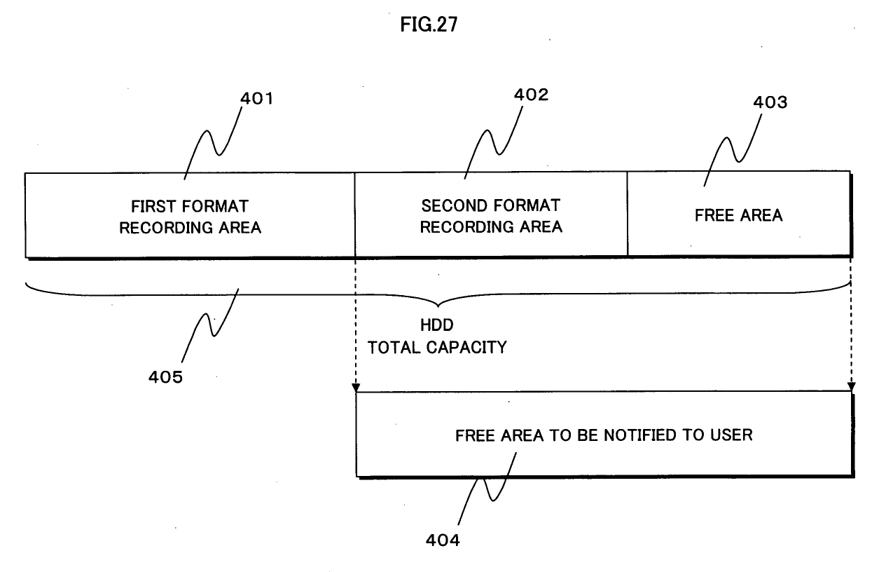

Here, for the purpose of the format duplication, it is assumed that the built-in medium has a first format recording area and a second format recording area. FIG. 26 shows contents recorded on the first format recording area and the second format recording area. This drawing shows that TV programs 1, 2 and 3 are recorded on the medium. Among these TV programs, the TV program 1 requires 15 GB of the first format recording area, and 10 GB of the second format recording area. The TV program 2 requires 5 GB of the first format recording area, and 2 GB of the second format recording area. The TV program 3 requires 50 GB of the first format recording area, and 30 GB of the second format recording area. The following describes how to present the free disc space to the user if the TV programs are recorded in this way. FIG. 27 shows how to present the free disc space to the user at recording.

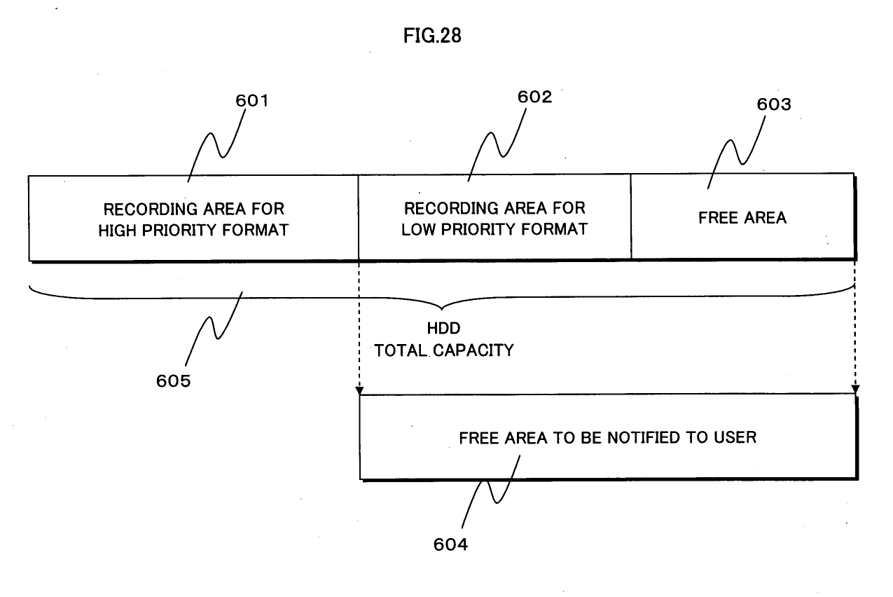

A recording area 401 for the first format shows the total amount of the recording area-occupied by the TV programs 1, 2 and 3 recorded in the first format. A recording area 402 for the second format shows the total size of the recording area occupied by the TV programs 1, 2 and 3 recorded in the second format. Usually, when the user additionally schedules recording for example, conventional video recording apparatuses presents, to the user, a free area 403 as the free disk space, which is the difference calculated by subtracting the total occupied area, namely the total of the broadcast data recording area 401 for the first format and the broadcast data recording area 402 for the second format, from the total capacity 405 of the HDD. However, there is a problem that the free disk space presented to the user is small in view of the recording time, because the data is recorded in the two different formats at the same time. To solve this problem, the recording apparatus of this embodiment presents, to the user, the total of the actual free area 403 of the HDD and the size of the recording area occupied by data to be deleted by priority. FIG. 28 shows how to present the free disc space to the user if a recording area of the built-in medium is divided into a recording area for a low-priority format and a recording area for a high-priority format.

A recording area 601 is a high-priority recording area. Therefore, the free disk space to be presented to the user at the scheduling of the recording is the total size of the actual free space and the recording area for a low-priority format.

The following explains how to specify the recording area for the data to be deleted by priority. For specifying such an area, the recording apparatus prompts the user to select one of the formats to give priority, and adds the size of the recording area for the unselected format to the actual free space size. As a result, it is possible to bridge the gap between the free disk space recognized by the user and the writable amount of data.

The format-dependent data to be deleted by priority may be specified based on the following criteria as well.

### First Criterion: Usage Frequency of Disk

The frequency of usage shows how frequently each type of optical disc media available with the recording apparatus is used.

For example, the recording/playback apparatus stores therein the usage history for each of Blu-ray disks, HD-DVD discs and DVD discs. If the Blu-ray discs are most frequently used, format-dependent data for HD-DVD discs and DVD discs are to be specified as data that is “to be deleted by priority”. In this case, only the format-dependent data for Blu-ray discs recorded on the HDD is presented to the user.

As described above, since data that is dependent on the format that corresponds to the discs that are not frequently used by the user is selected as data to be deleted by priority, it is possible to increase the possibility that the recording/playback apparatus can copy the data from the built-in medium to a portable medium without performing re-encoding.

### Second Criterion Usage History of Quality Modes

The recording/playback apparatus may store therein the usage history of quality modes that have been used at recordings onto discs. Among pieces of format-dependent data, data that corresponds to a quality mode that has not been frequently used is to be selected as data that is “to be deleted by priority”.

If the user uses the recording/playback apparatus for the purpose of recording broadcast programs of the SD quality, the DVD-Video format or the DVD-Video Recording format will be frequently used in terms of the disc capacity and the image quality. In this case, the usage frequency of Blu-ray discs and HD-DVD discs will be low. Therefore, format-dependent data for Blu-ray discs and HD-DVD discs are to be considered as data that is “to be deleted by priority”.

If the user uses the recording/playback apparatus for the purpose of recording broadcast programs of the HD quality, Blu-ray discs or HD-DVD discs will be frequently used because the user wishes to record as many HD-quality broadcast programs as possible. Accordingly, the usage frequency of the DVD-Video or the DVD-Video Recording format will be low. Therefore, format-dependent data of DVD-Video format and the DVD-Video recording format are to be considered as data that is “to be deleted by priority”.

By selecting the data to be deleted by priority in this manner, it is also possible to increase the possibility that the recording/playback apparatus can copy the data from the built-in medium to a portable medium without performing re-encoding.

### Third Criterion: User's Preference

Recording/playback apparatuses of recent years have a user profile function. The user profile function is to automatically acquire, from a plurality of contents, contents that have attribute that match keywords that show the user's preference. The keywords are set by the user in advance. An Example of the keyword is names of genres and performers. Here, the attributes are transmitted in one-to-one association with broadcast contents, in a form of an Electronic Program Guide. By conducting a search through the EPG for keywords as described above, it is possible to automatically acquire contents that have attributes that match the keywords that show the user's preference. In Japan, the attributes such as genres are transmitted in the form of the Electronic Program Guide (EPG) or the like together with broadcast waves. Accordingly, it is relatively easy to acquire the attributes. Also, similar EPGs can be acquired in the United States and Europe. Although the priorities are configured based on the genres in the explanation above, it is possible to prompt the user to enter, for example, the names of performers and bands that appear in TV programs as attributes of the TV programs, and configure the priorities based on these attributes.

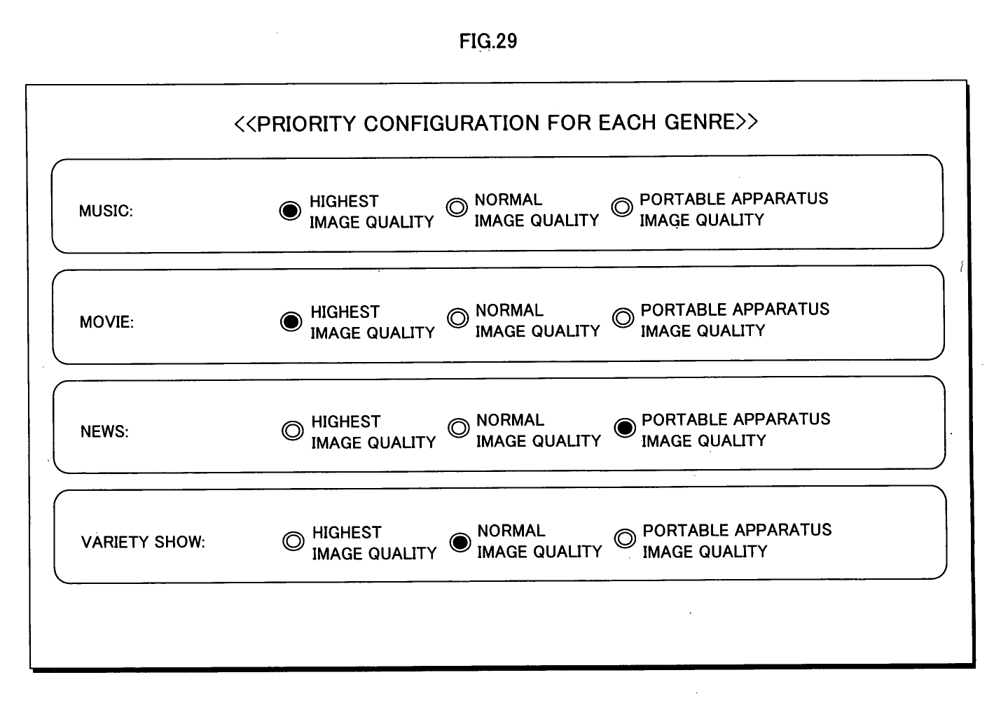

On the other hand, the recording/playback apparatus accepts from the user, for each of the contents acquired by the keyword search, a configuration for saving the content. Here, a configuration for saving is made by displaying buttons that correspond to three levels, namely a highest image quality mode, a normal image quality mode and the portable apparatus image quality mode, and accepting a confirmation operation on any of the buttons. FIG. 29 shows an example GUI for accepting a user's policy for saving data. From the GUI of this drawing, it is possible to configure a policy for saving data, for each of a plurality of genres, namely music programs, movies, news and variety shows. It is also possible to determine the format-dependent data that should be recorded by priority, by prompting the user to configure the image quality mode via such a GUI.

In the example of FIG. 29, the optical disc medium format is hidden from the user. However, if the highest image quality mode has been selected by the user, the priority of the format-dependent data that corresponds to Blu-ray discs or HD-DVD discs is to be increased, and if the normal image quality mode has been selected by the user, the priority of the format-dependent data that corresponds to DVD discs is to be heightened. If the portable apparatus image quality mode has been selected by the user, the priority of the format-dependent data that has a resolution that is lower than 320×240, etc. and is suitable for SD-Video is to be heightened.

For example, usually, it is enough for the user to watch news programs only once, and the quality of the video and the audio of such programs is only necessary to be clear enough to make the user understand the contents. Accordingly, the user may select the image quality mode for the portable apparatus, on the assumption that the user will watch the news outside during travel to or from work.

On the other hand, many users wish to save movies, documentaries, music programs and so on with high image and audio qualities. Accordingly, the user may select the highest image quality mode that corresponds to the Blu-ray discs or the HD-DVD format.

For variety shows that the user wishes to watch only once, the user may usually select the normal image quality mode.

It is possible to obtain a space for a new recording by selecting format-dependent data that has an attribute that matches the user's preference and has been recorded in a quality mode that is not suitable for the user's policy for saving, as data to be deleted by priority.

### Management Information

The following explains management information used for efficiently managing format-dependent data that is “to be deleted by priority”.

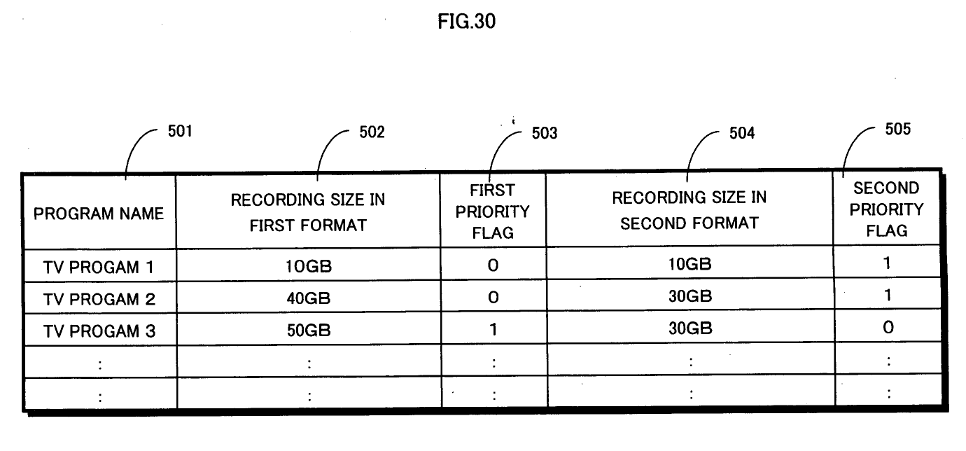

FIG. 30 shows the management information used for managing format-dependent data that is “to be deleted by priority”. As FIG. 30 shows, the management information includes a program name 501, a recording area size 502 in the first format, a first priority flag 503 that shows whether the first format data is to be deleted by priority, a recording area size 504 in the second format, and a second priority flag 505 that shows whether the second format data is to be deleted by priority. The priority flags 503 and 505 are determined by evaluation of TV programs based on the three criteria described above. The following describes the management information of FIG. 30.

In FIG. 30, the size of the high-priority recording area 601 of FIG. 29 is represented as the total size of the recording areas for pieces of format-dependent data that are determined as having a high priority. Specifically, the size of the high-priority recording area 601 is the total size of the format-dependent data of the second format of the TV program 1 (10 GB), the format-dependent data of the second format of the TV program 2 (10 GB), and the format-dependent data of the first format of the TV program 3 (50 GB).

The size of the format-dependent data to be deleted by priority is the total size of the format-dependent data of the first format of the TV program 1 (10 GB), the format-dependent data of the first format of the TV program 2 (40 GB), and the format-dependent data of the second format of the TV program 3 (30 GB).

The following explains an advantage of giving a priority order to pieces of format-dependent data recorded by the format duplication.

When the user attempts to record a TV program on a built-in medium on which some TV programs have already been recorded, it sometimes happens that the HD drive does not have enough free space. In such a case, if a priority order has been given to the pieces of format-dependent data that have been recorded by the format duplication, the recording apparatus can delete the pieces of data in the priority order of lowest to highest so as to increase the actual free space without hampering convenience at the copying by the user.

From another viewpoint, even if the user has given a high priority to the second format-dependent data of a low image quality in terms of the price of the medium, if the first format-dependent data exists on the built-in medium and has not been overwritten by an additional recording, it is possible to play back the highest quality data among the pieces of format-dependent data of the same TV program that correspond to two or more application formats recorded on the built-in medium.

In other words, in the status where the UI shows that only one program is stored, it is possible to play back the highest quality data among the two or more pieces of format-dependent data of the same content recorded on the HDD, according to the user's operation input from the remote control and so on. As a result, for example, after watching outdoors a low-resolution content that has been recorded for the purpose of taking out, the user can continue watching the content at home with a high image quality.

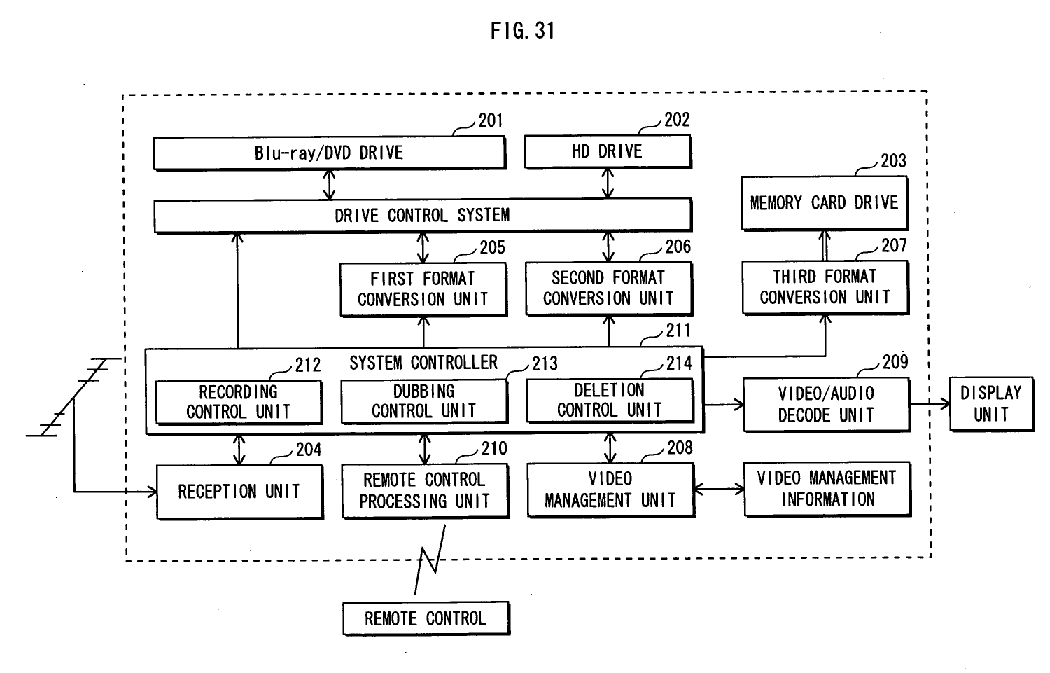

The following describes the internal structure of the recording/playback apparatus structured from the above-described viewpoint. FIG. 31 shows the internal structure of the recording apparatus of the fourth embodiment. The recording apparatus of this embodiment is structured from a Blu-ray/DVD drive 201, a HD drive 202, a memory card drive 203, a reception unit 204, a first format conversion unit 205, a second format conversion unit 206, a third format conversion unit 207, a video management unit 208, a video/audio decode unit 209, a remote control processing unit 210, and a system controller 211.

### Blu-ray/DVD Drive 201

The Blu-ray/DVD drive 201 identifies the disc type when an optical disc medium such as a BD and a DVD is loaded, and performs access control such as reading and writing on the disc medium using an optical pickup that is suitable for the identified type.

### HD Drive 202

The HD drive 202 is a large-capacity hard disk drive for storing TV programs converted to be in the first format and the second format.

### Memory Card Drive 203

A semiconductor memory card as a portable medium can be coupled to the memory card drive 203. The memory card drive 203 performs access control on the semiconductor memory card.

### Reception Unit 204

The reception unit 204 receives broadcast signals via an antenna.

### First Format Conversion Unit 205

The first format conversion unit 205 converts content, acquired in the form of the broadcast signals, into format-dependent data in the first format. The converted format-dependent data is to be recorded on the HD drive 202. The following explains an example case of the conversion where the first optical disc medium is a BD-RE or a BD-R.

If the signals to be received are terrestrial digital broadcast signals or BS digital broadcast signals, the signals are transmitted in the form of MPEG2 Transport Streams. The first format conversion unit 205 converts a MPEG2 Transport Stream by adding an appropriate header thereto, without converting the video signals and the audio signals included therein, and passes the result to the HD drive 202 via a disc drive control system. Here, the header is, for example, an ATS (Arrival Time Stamp) that shows a time when each packet included in the MPEG2 Transport Stream arrives at the antenna.

### Second Format Conversion Unit 206

The second format conversion unit 206 converts the content into data in a format recordable on the second optical disc medium. The converted data is to be recorded on the HD drive 202. Assume here for example that the final purpose is to record content on a HD-DVD that has the capacity of 15 GB (single layer) or 30 GB (double layer), which is smaller than the capacity of the Blu-ray disc (BD-RE/R), namely 25 GB (single layer) or 50 GB (double layer). In this case, the received broadcast signals are to be decoded. Then, either or both of the decoded video and audio signals will be re-encoded at a bit rate that is lower than the bit rate at the reception. The second format conversion unit 206 adds, for example, a header for the HD-DVD to the re-encoded data, and passes the result to the HD drive 202 via the disc drive control system so as to record the data.

### Third Format Conversion Unit 207

In view of that the user may bring out the recorded contents with a portable terminal or the like, the third format conversion unit 207 performs conversion for recording the contents at a low resolution of 320×240, 320×180 or the like. Also, if a content that is the same as the terrestrial broadcast is provided in the form of the one-segment broadcasting, the third format conversion unit 207 receives and records it.

### Video Management Unit 208

After the recording has been completed, the video management unit 208 stores, as video management information, information of the program recorded on the HD drive 202, the size thereof, and so on. The video management information is to be used for presenting, to the user, a recordable time length and available bit rates based on the remaining capacity of the HDD when the user starts the next recording or schedules a recording of a program. As described above, the contents received in the form of broadcast signals are converted by the first format conversion unit 205 and the second format conversion unit 206 to two or more pieces of format-dependent data in different formats, and they are synchronously recorded on the HD drive 202. Accordingly, the video management unit 208 records/manages the sizes of the pieces of data in the different formats as the recording area size 502 in the first format and the recording area size 504 in the second format, together with the program name 501. Also, although not illustrated in this figure, information associated to each TV program, such as recording date and time is also recorded together with the program name and the recording area sizes.

### Video/Audio Decoding Unit 209

The video/audio decoding unit 209 refers to the video management information that is under the management of the video management unit 208, and selects one with the highest quality format out of the pieces of format-dependent data recorded on the HD drive 202. The video/audio decoding unit 209 decodes the selected data for playback. As a result, the user can watch the TV program with the highest quality at any time.

### Remote Control Processing Unit 210

The remote control processing unit 210 receives and processes transmission signal that has been transmitted from a remote control operated by the user.

### System Controller 211

The system controller 211 includes a CPU (central processing unit) and a ROM (read only memory), and controls the whole recording/playback apparatus. The ROM stores therein, for example, programs to be executed by the CPU. In accordance with a notification from a remote control processing unit 210, the system controller 211 changes video signals to be transferred to the display part of a TV or the like, by which an interactive GUI (Graphical user interface) can be realized. As the control of the whole apparatus, the system controller 211 performs recording of TV programs, dubbing of TV programs, and deletion of TV programs. To realize this control, the system controller 211 includes a recording control unit 212 that controls schedule recording and manual recording, a dubbing control unit 213 that controls dubbing, and a deletion control unit 214 for deletion processing.

The following explains processing procedures performed by the recording/playback apparatus structured as described above, with reference to flowcharts.

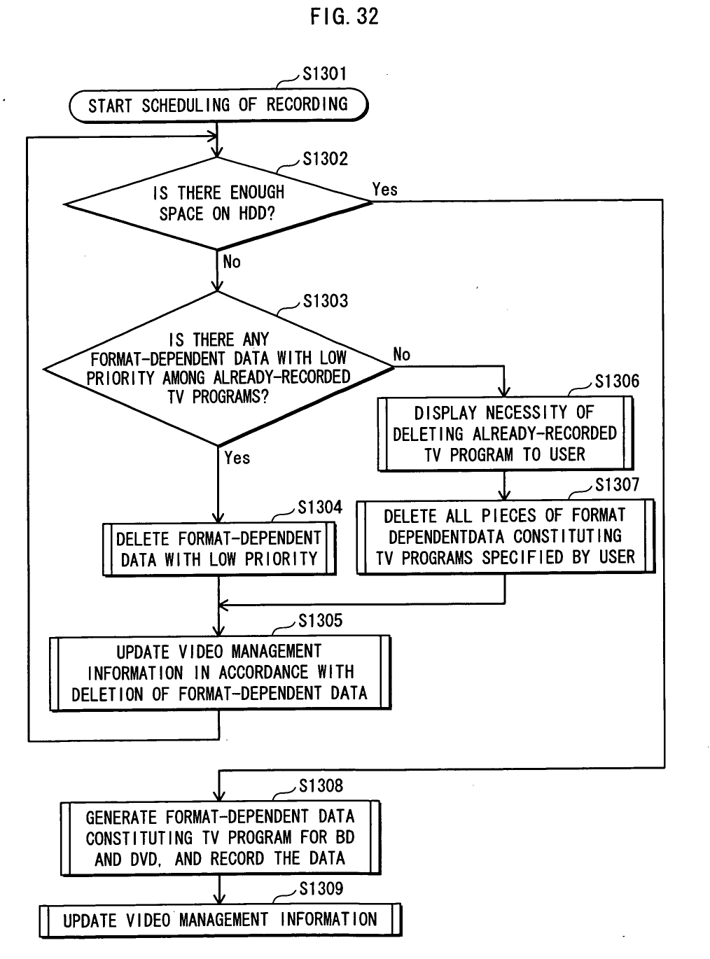

FIG. 32 is a flowchart showing processing procedures for scheduling a recording. Firstly, scheduling of the recording is started by the user (Step S1301). Next, the recording/playback apparatus judges whether the remaining capacity of the HD drive is enough for the size of the TV program to be recorded, based on the details of the scheduled recording (Step S1302). Here, if there is not enough space, the recording/playback apparatus judges whether already-recorded pieces of format dependent data that constitute TV programs include any with a low priority (Step S1303). If there are such pieces of format-dependent data, the recording/playback apparatus deletes one of the pieces of data with a low priority (Step S1304), and updates the video management information in accordance with the deletion of the data (Step S1305). If there is no piece of format-dependent data with a low priority, the recording/playback apparatus notifies the user of that it is necessary to delete some of recorded programs (Step S1306), deletes all the pieces of format-dependent data of TV programs specified by the user's operation (Step S1307), and updates the video management information in accordance with the deletion of the data (Step S1305). These steps S1303, S1304, S1305, S1306 and S1307 are repeated until there is enough remaining free space in the HD drive unit 202.

When enough space is secured on the HD drive 202 by the deletion of TV programs, the recording/playback apparatus schedules the recording. At the scheduled recording start time, the recording/playback apparatus records format-dependent data that constitutes the TV program on the HD drive 202 (Step S1308), and updates the video management information after completing the recording (Step S1309).

The following gives a supplemental explanation of Step S1305, based on the specific example of FIG. 30.

In the case where three TV programs, namely a TV program 1, a TV program 2 and a TV program 3, are recorded as shown in FIG. 28, the format-dependent data whose priority flag is “0” is to be deleted by priority. For example, if the free disk space is 10 GB short for newly scheduling a recording, the recording/playback apparatus may delete the first format-dependent data of the TV program 1, and update the recording area size of the format-dependent data of the TV program 1 to 0 GB.

In Step S1303, since the recording/playback apparatus automatically deletes the format-dependent data with a low priority without asking the user, the user is not required to be aware of that the same TV program is recorded in duplicate on the HD drive unit 202 in two formats.

As described above, according to this embodiment, the present invention does not make the user aware of that the same TV program is recorded in duplicate on the HD drive unit 202 in two formats. Moreover, regarding the free disk space to be presented to the user at recordings, the recording/playback apparatus hides the size of the data that has been recorded with a low priority through the above-mentioned priority configuration, and show it as a free space. Accordingly, the recording/playback apparatus is capable of copying or moving TV programs recorded on the HD drive 202 to an optical disc medium such as a Blu-ray, a HD-DVD and a DVD at a high speed via the HD drive 202 regardless of the type of the destination medium without making the user aware of the medium format. Also, regarding playback of contents, the recording/playback apparatus has an advantage that it is capable of automatically select one with a higher image quality from two formats and playing back it.

Note that various changes to the above-mentioned technical features may be made without departing from the scope of the invention. The following describes specific examples of such changes.

### Fourth Criterion

In addition to the first to third criteria described above, the following fourth criterion may be used to specify format-dependent data to be deleted by priority.

The fourth criterion is an idea of selecting a format at scheduling of a recording according to a recording time and a broadcast program to be recorded. More specifically, since the upper limit of the bit rate is determined (e.g. 24 Mbps for BS digital broadcast programs and 16.8 Mbps for terrestrial digital broadcast programs), if the type of the program to be recorded (i.e. BS digital broadcast or terrestrial digital broadcast) and the recording time become clear, it is possible to give a high priority to a medium that has an optimum capacity, i.e. that will leave the smallest free space when a content recorded on the HDD has been copied or moved to the medium.

For example, if the required recording area size is a little smaller than 25 GB, a high priority may be given to the format suitable for a single layer Blu-ray disc. If this is the case, data that corresponds to a disc format of a single layer HD-DVD disc can be handled as format-dependent data that is “to be deleted by priority” without any problem.

If the required recording area size is a little smaller than 15 GB, a high priority may be given to the format suitable for a single layer HD-DVD disc. If this is the case, data that corresponds to a disc format of a single layer Blu-ray disc can be handled as format-dependent data that is “to be deleted by priority” without any problem.

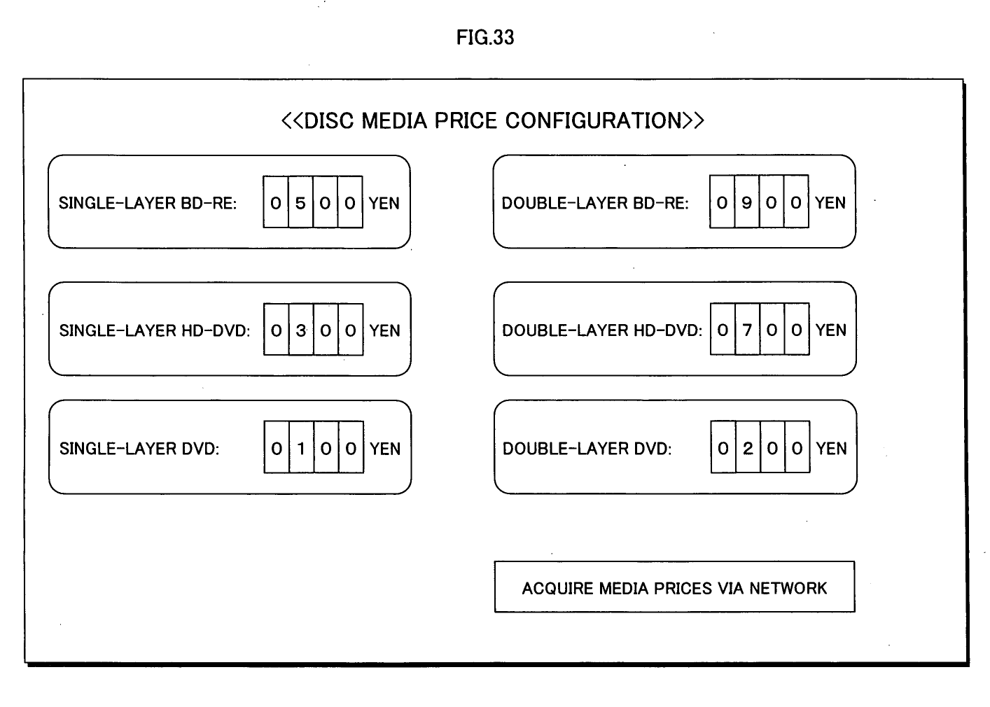

In this way, by calculating the size of format-dependent data that occupies the HD drive 202 and is to be eventually recorded on an optical disc medium at the recording scheduling based on the broadcast wave type and the recording time, it is possible to give a high priority to an optical disc medium format that will leave the smallest free space, and handle other format data as data “to be deleted by priority”. FIG. 33 shows an example GUI for determining priorities of formats based on prices of media. This example shows a list of prices of a single layer BD-RE disc, a double layer BD-RE disc, a single layer HD-DVD disc, a double layer HD-DVD disc, a single layer DVD disc, and a double layer DVD disc, and enables the user to select any of the discs to be used by priority.

In this example, a high priority is given to the medium that will leave the smallest free space. However, it is possible to determine the format-dependent data to which a high priority is to be given based on a per-disc price of each medium or a per-bit price (bit price) of each medium. In other words, when it is judged at the scheduling that a 25 GB recording area is required in the same manner as described above, an optical disc medium that can store 25 GB at the lowest cost may be given a high priority. If this is the case, the single layer Blu-ray disc (25 GB optical disc medium) and the double layer HD-DVD disc (30 GB optical disc medium) are the candidates. If the market price of the 30 GB optical disc medium is lower than the 25 GB optical disc medium, the format suitable for the 30 GB optical disc medium may be given a high priority, even though a large disc space will be left when 25 GB data has been recorded thereon. If this is the case, the recording/playback apparatus may prompt the user to enter the price of each optical disc medium, or acquire the price from distributors of optical media via a network.

As the recording size is confirmed at the scheduling, the user can copy or move contents to an optical disc medium at the lowest cost.

### Fifth Criterion

In addition to the first to fourth criteria described above, the following fifth criterion may be used to specify format-dependent data to be deleted by priority.

The fifth criterion is an idea of determining priorities of the formats according to channels.

For example, Japanese BS digital broadcast provides Hi-Vision TV programs with high image quality on channels such as the NHK Hi Vision, the WOWOW, and all-movie channels. Also, some terrestrial broadcast channels like all-news channels provide many programs that can be judged to worth only one-time viewing, such as news and variety shows. In this case, the recording/playback apparatus enables the user to input a per-channel priority configuration. The per-channel priority configuration is for determining a quality mode to be used for each channel.

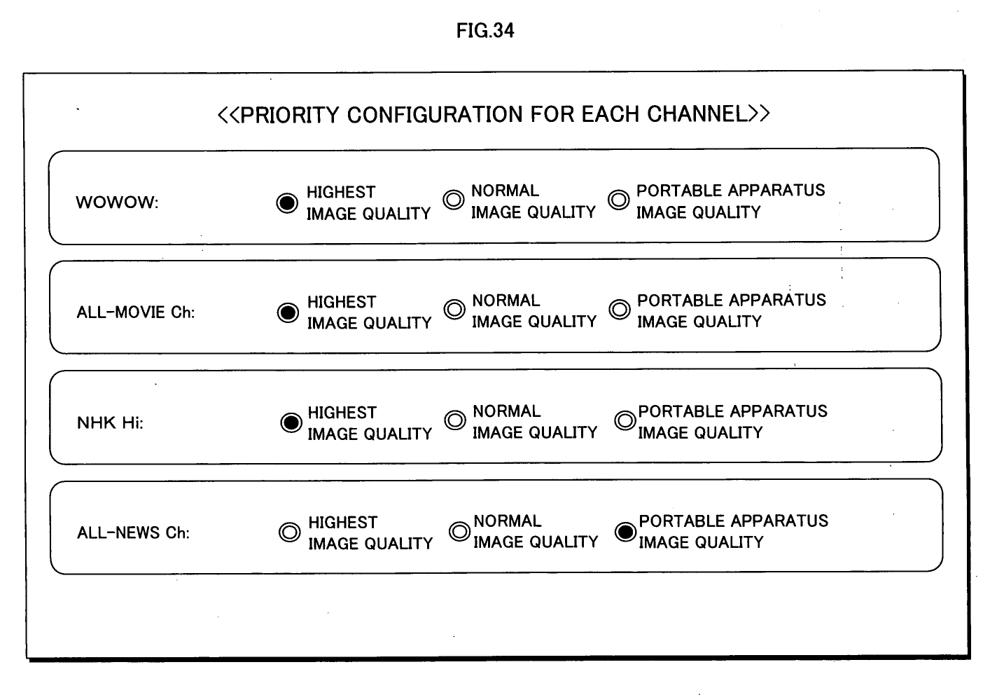

FIG. 34 is an example GUI for accepting the priority configuration for each of channels. In this drawing, famous Japanese broadcast providers such as the WOWOW, an all-movie channel, the NHK Hi and an all-news channel are listed in the vertical direction, and for each of the channels, the user can select one out of three image quality modes, namely the highest image quality mode, the normal image quality mode and the portable apparatus image quality mode.

For example, if the user selects the highest image quality mode for the WOWOW channel and the NHK Hi channel, the recording/playback apparatus uses the BD-R format or the BD-RE format by priority, and handles the other formats as the format-dependent data that is “to be deleted by priority”.

If the user selects the portable apparatus image quality mode, the recording/playback apparatus uses the SD-Video format by priority, and handles the other formats as the format-dependent data that is “to be deleted by priority”. Also, if the user selects the normal image quality mode, the recording/playback apparatus uses the format-dependent data corresponding to the HD-DVD-VR format or the DVD format, which has an image quality lower than that of that of the BD-R and the BD-RE, and handles the format-dependent data corresponding to the other formats as the format-dependent data that is “to be deleted by priority”.

### Criterion for Deletion

The flowchart of FIG. 32 explains which data is to be deleted when the free disk space of the HD drive 202 is not enough, based on the priorities that have been set by the user. However, instead of the priorities given by the user, the recording/playback apparatus may use the priorities that are based on the recording dates of the TV programs, the relative merits of the image qualities and the audio qualities among the formats, the usage history showing optical medium types that have been often used by the user, and necessity of re-encoding of video and audio signals, and so on. Moreover, the recording/playback apparatus may use combinations of these factors for giving priorities.

### Fifth Embodiment

In the embodiments above, the format duplication is adopted for recording contents on the built-in medium, and the recording/playback apparatus prompts the user to configure the priorities in order to delete one of the two or more pieces of format-dependent data corresponding to the same content. However, the fifth embodiment relates to improvements with which the recording/playback apparatus prompts the user to designate an attribute “media mode” in advance, and performs dubbing such as copy and move according to the media mode. The media mode is an attribute of a content, and designates an optical disc medium on which the content is to be recorded.

Among the components of the recording apparatus of the embodiments above, the improvements of the recording/playback apparatus exist in the recording control unit 212 and the dubbing control unit 213. The following describes the recording control unit 212 and the dubbing control unit 213.

### Improvements of Recording Control Unit 212

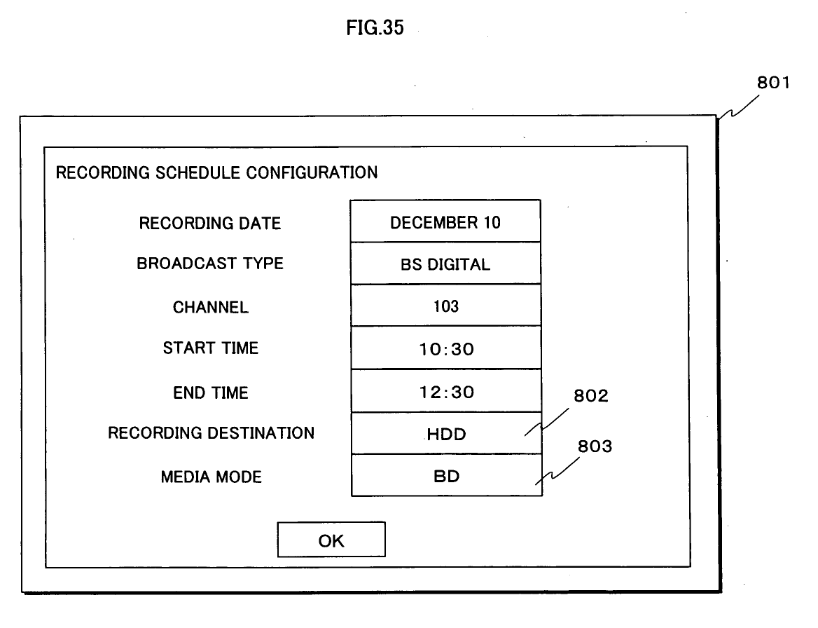

The recording control unit 212 displays a recording configuration GUI for setting recording schedule of TV programs, and receives user's instructions for scheduling the recording via this recording configuration GUI. FIG. 35 shows a recording configuration GUI 801 for scheduling recording of TV programs. Using the remote control, the user selects a recording data, a broadcast type, a channel, a start time, an end time, a recording destination 802, and a media mode 803 for a TV program.

The recording destination 802 shows an optical disc medium as a recording destination of the TV program. For example, if an optical disc medium such as a BD is selected, format-dependent data of the TV program is to be directly recorded on a BD via the Blu-ray/DVD drive 201, and if the HD drive 202 is selected, the format-dependent data of the TV program is to be recorded on the HD drive 202.

The media mode 803 is for designating a disc that is suitable for recording the TV program. For example, if the HD drive 202 is selected as the recording destination 802 and the BD is selected as the media mode 803, the recording/playback apparatus instructs the first format conversion unit 205 to perform processing for converting the TV program to be in the BD application format, and instructs the HD drive 202 to record the data.

The recording schedule of TV programs configured by the user via the recording configuration GUI 801 is to be recorded on the HD drive 202 in a form of a “recording information table”.

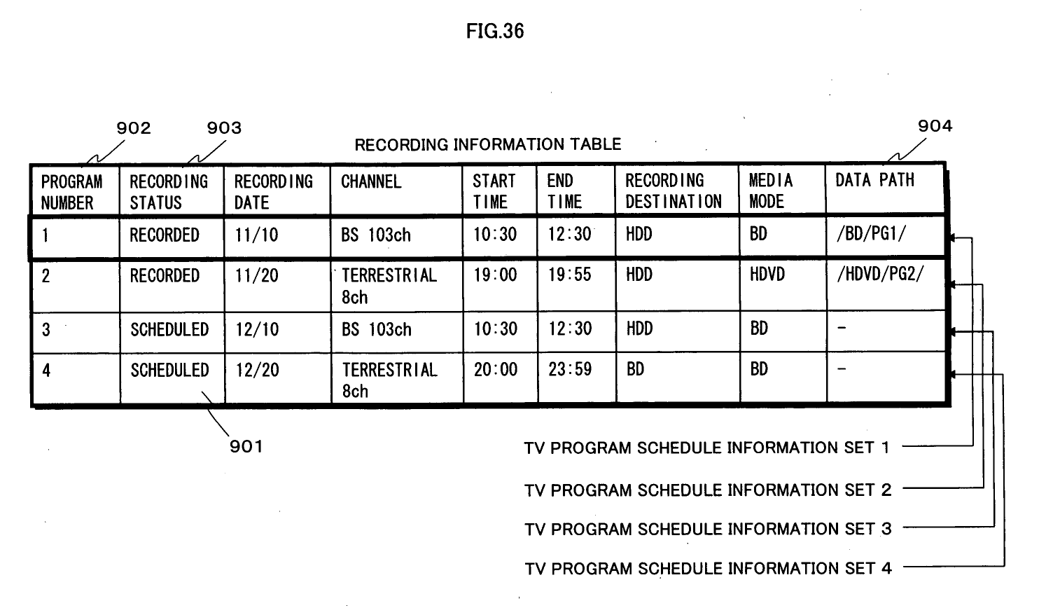

FIG. 36 shows a recording information table 901.

The recording information table 901 is a table with which a program number 902, a recording status 903, a recording date, a channel, a start time, an end time, a recording destination, a media mode, and a data path 904 can be set for each TV program. Each record formed by each row of the recording information table is called a “TV program schedule information set”, and identified by the program number shown at the left end, e.g. as a TV program schedule information set 1, 2, 3, 4.

In each TV program schedule information set, values input by the user via the recording configuration GUI 801 are to be set to the recording date, the channel, the start time, the end time, the recording destination and the media mode. The program number 902 is a management number in the recording apparatus. For newly scheduling a recording, the recording control unit 212 assigns a number that has not been used in the recording information table 901. The recording status 903 shows the status of the TV program recording. “Recorded” shows that the recording has been completed, and “Scheduled” shows that the recording has not been completed. The data path 904 shows a location of the recorded data on the optical disc medium or the memory card drive 203. This concludes the explanation of the details of the improvements of the recording control unit 212.

### Details of Processing Performed by Dubbing Control Unit 213

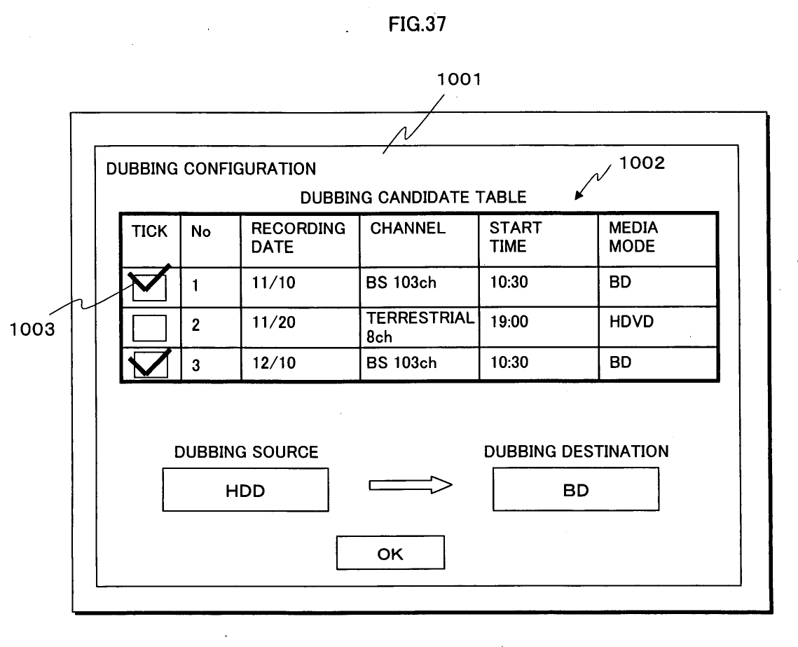

The dubbing control unit 213 searches for a TV program from the recording information table 901 based on a dubbing check box 1003 configured via a dubbing configuration GUI 1001 shown in FIG. 37, reads the format-dependent data of the TV program from the HD drive 202, and writes the data after converting it to format-dependent data that suits the application format of the recording-destination optical disc medium. FIG. 37 shows the dubbing configuration GUI 1001 used for copying TV programs recorded on the HD drive 202 to an optical disc medium such as a BD and an HDVD.

The dubbing configuration GUI 1001 has a dubbing candidate table 1002. The dubbing candidate table 1002 is a list of TV programs that can be copied, formed from the recording information table 901. The dubbing check box 1003 is provided in the dubbing candidate table 1002. The user ticks the box of a program that the user wishes to copy to an optical disc medium. After the user configures the dubbing check box 1003, when the user presses the OK button, the dubbing is started.

In this regard, if the media mode 803 of the recording information table 901 is the same as the optical disc medium as the dubbing destination, the recording apparatus writes the AV stream of the TV program data on the optical disc medium without performing data conversion. If the media mode 803 is not the same as the optical disc medium as the dubbing destination, the recording apparatus records the AV stream on the optical disc medium while converting the data to be in the format that suits the optical disc medium, using the first format conversion unit 205 and the second format conversion unit 206.

With the stated structure, it is possible to perform the dubbing to an optical disc medium desired by the user at a high speed based on in-advance designation of an optical disc medium by the user as the media mode 803.

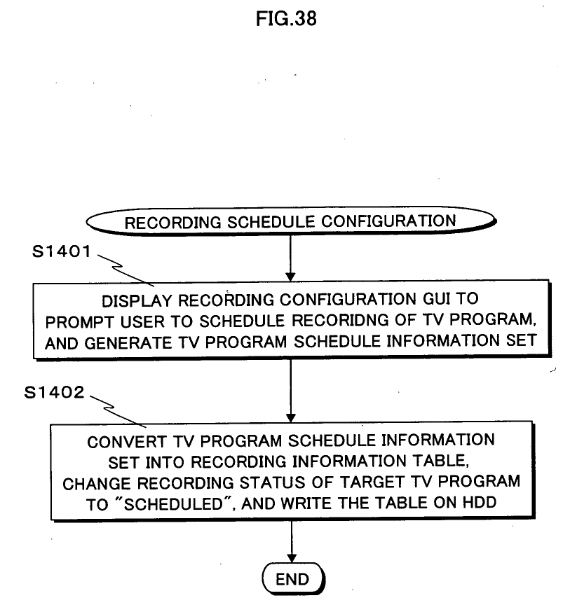

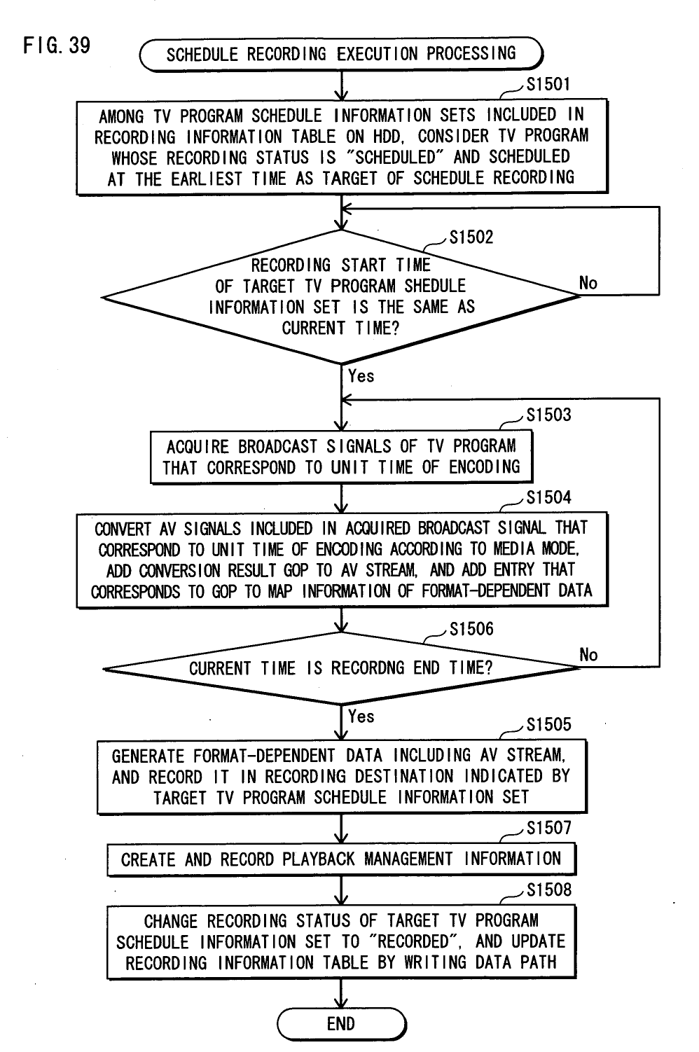

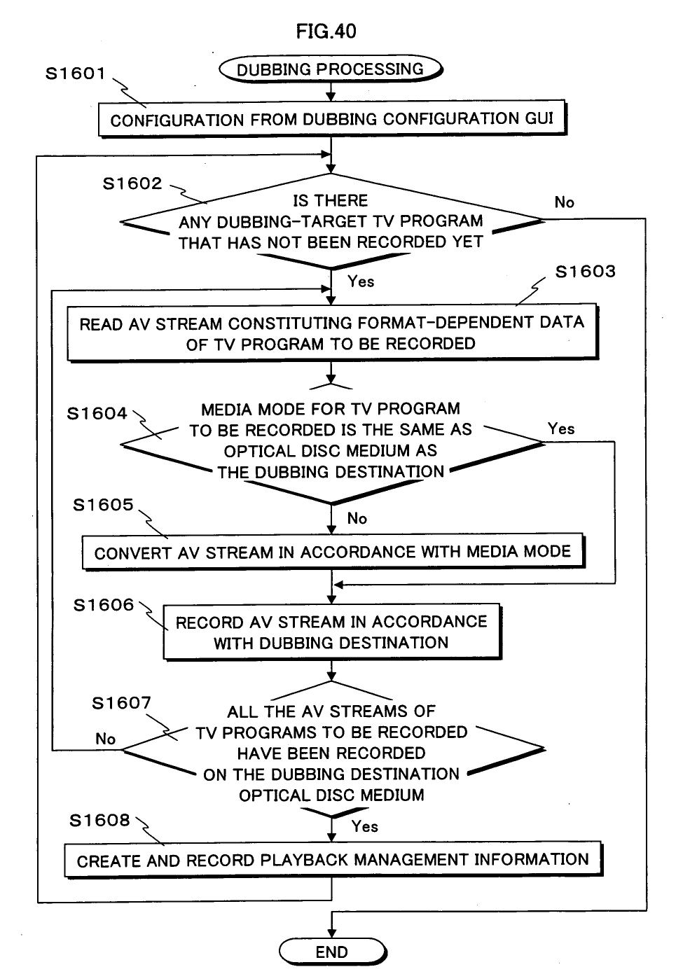

Next, the following describes processing procedures of an information recording method performed by the recording apparatus pertaining to this embodiment, with reference to FIG. 38, FIG. 39 and FIG. 40.

FIG. 38 is a flowchart showing processing procedures performed by the user to schedule recording of TV programs.

In Step S1401, the recording apparatus displays the recording configuration GUI 801 to prompt the user to schedule recordings of TV programs, and generates a TV program schedule information set.

In Step S1402, the recording apparatus converts the TV program recording schedule information to the recording information table 901, sets the recording status 903 of the target TV program to be “Scheduled”, and writes the table on the HD drive 202.

This concludes the explanation of the processing procedure for scheduling recording of TV programs performed by the recording apparatus pertaining to this embodiment.

FIG. 39 is a flowchart showing processing procedures for recording a TV program in accordance with recording schedule information configured by the user.

In Step S1501, the recording apparatus reads the recording information table 901 recorded on the HD drive 202. With reference to the TV program schedule information sets, the recording apparatus considers the TV program whose recording status is “scheduled” and the scheduled at the earliest time as the target of the schedule recording.

In Step S1502, the recording apparatus compares the recording start time of the target TV program schedule information set with the current time, and waits until the current time reaches the recording start time. When the current time reaches the recording start time, the recording apparatus moves to Step S1503.

In Step S1503, the recording apparatus acquires broadcast signals of the TV program that correspond to a unit time of the encoding. Specifically, the broadcast signals for 0.5-1 second, which corresponds to a GOP, is the broadcast signals that correspond to the unit time.

In Step S1504, the recording apparatus converts the AV signals included in the acquired broadcast signals for one second according to the media mode 803 of the TV program indicated by the recording information table 901, and adds the conversion result GOP as part of the AV stream to the AV stream 6. Also, the recording apparatus generates an entry corresponding to this GOP, and adds it to map information of the format-dependent data. In the case of BD format data, a pair of (i) the PTS of the I-picture, which is positioned at the top of the PTSs, and (ii) the packet number of the Source packet storing this I-picture are generated as the entry, and added to the EP_map, which is the map information of the BD format data. In the case of the DVD format data, a pair of the playback time of the GOP and the total byte count of the GOP are generated as an entry and added to the TimeMap as the map information of the DVD format data.

In Step S1506, the recording apparatus compares the recording end time of the TV program with the current time. If the recording end time and the current time are not the same, the recording apparatus returns to the Step S1503 to repeat the processing. If the recording end time and the current time are the same, the recording apparatus moves to Step S1507.

In Step S1505, the recording apparatus generates format-dependent data mainly composed of the AV stream acquired by repeating the conversions of Steps S1503 and S1504, and records the data on the recording destination 802 of the TV program as indicated by the recording information table 901.

For example, if the media mode 803 is BD, the AV stream 6 acquired by the conversion of the broadcast signals is to be recorded as an AV stream (CCC.MPG) that suits the application format of the BD. If the media mode 803 is HDVD, the AV stream 6 acquired by the conversion of the broadcast signals is to be recorded as an AV stream (HDVD.VOB, etc.) that suits the application format of the HD-DVD.

In Step S1507, the recording apparatus generates playback management information, including the playback time of the AV stream of the TV program, the decode parameters and so on, which are required for playback, so as to suit the application format corresponding to the media mode 803, and records the information on the recording destination 802 of the TV program. The playback management information is, for example, INDEX.TBL, BBB.PLS, CCC.CLI for the BD, and HDVD.IFO of the HDVD.

In Step S1508, the recording apparatus changes the recording status 903 of the target TV program schedule information set from “Scheduled” to “Recorded”, and updates the recording information table by writing the location where the format-dependent data is recorded into the data path 904.

This concludes the explanation of the processing procedure for recording a TV program in accordance with the recording schedule information configured by the user.

FIG. 40 is a flowchart showing processing procedures for copying a TV program to an optical disc medium according to dubbing configuration information configured by the user.

In Step S1601, the user selects, via a dubbing configuration GUI 1001, dubbing targets from among the TV programs recorded on the HD drive 202.

In Step S1602, the recording apparatus checks whether there are any dubbing target TV programs that have not been copied to the optical disc medium. If all the dubbing target TV programs have been copied to the optical disc medium, the recording apparatus finishes the processing. If any of the dubbing target TV programs have not been copied to the optical disc medium, the recording apparatus selects one of them and moves to Step S1603.

In Step S1603, the recording apparatus reads the AV stream constituting the format-dependent data of the target TV program from the HD drive 202. The data size to read is to be adjusted according to the size of the HD drive 202. For example, it is preferable that the data size to read is adjusted to be the size for one second.

In Step S1604, the recording apparatus checks the media mode 803 of the target TV program in the recording information table 901, and judges whether the media mode is the same as the destination optical disc medium. If it is the same, the recording apparatus moves to Step S1606. If it is not the same, the recording apparatus moves to Step S1605.

In Step S1605, the recording apparatus converts the AV stream constituting the format-dependent data of the target TV program so as to suit the application format of the dubbing destination optical disc medium. This conversion is performed according to the media mode.

In Step S1606, the recording apparatus writes the format-dependent data of the TV program onto the dubbing destination optical disc medium.

In Step S1607, the recording apparatus checks whether all the AV streams included in the format-dependent data of the TV program have been recorded. If all the AV streams have been recorded, the recording apparatus moves to Step S1608. If not, the recording apparatus moves to Step S1603.

In Step S1608, the recording apparatus generates playback management information, including the playback time of the AV stream of the TV program, the decode parameters and so on, which are required for playback, so as to suit the application format of the optical disc medium, and records the information on the optical disc medium. The playback management information is, for example, INDEX.TBL, BBB.PLS, CCC.CLI for the BD, and HDVD.IFO of the HDVD. After that, the recording apparatus returns to Step S1602.

This concludes the explanation of the processing procedure for copying a TV program to an optical disc medium according to the dubbing configuration information.

With the stated method, it is possible to perform the dubbing to an optical disc medium desired by the user at a high speed based on in-advance designation of an optical disc medium by the user as the media mode 803.

Note that various changes to the above-mentioned technical features may be made without departing from the scope of the invention. The following describes specific examples of such changes.

### Notification of Dubbing Time

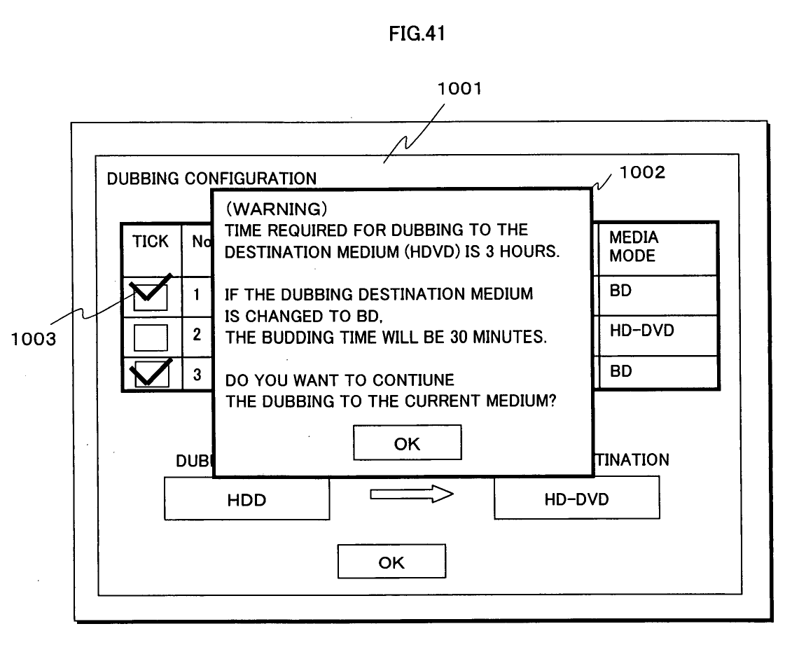

In the case where the media mode of the TV program as the dubbing target configured through the dubbing configuration GUI 1001 is different from the dubbing destination the disc medium, the dubbing time required for each medium may be calculated in view of the progression of the format conversion. If the dubbing time for another format is shorter than the dubbing time for the dubbing destination medium, the dubbing time for each optical disc medium may be notified to the user. FIG. 41 shows a GUI used for notifying the user of a time required for the dubbing, with respect to each disc medium.

The GUI of FIG. 41 shows that three hours are required for copying the data to the disc medium (HD-DVD) designated by the media mode. The GUI also includes a warning message showing that the dubbing time is 30 minutes if the dubbing destination disc medium is changed to a BD. With such a message, the user can know which medium is preferable for copying the data at high speed.

### Unit of Configuration of Media Mode

It is possible to configure the media mode at once, instead of setting it for each of the recording programs one by one. If this is the case, the user can omit the operations for setting the media mode for each of the recording programs.

### Criterion for Selection of Format: Data Size

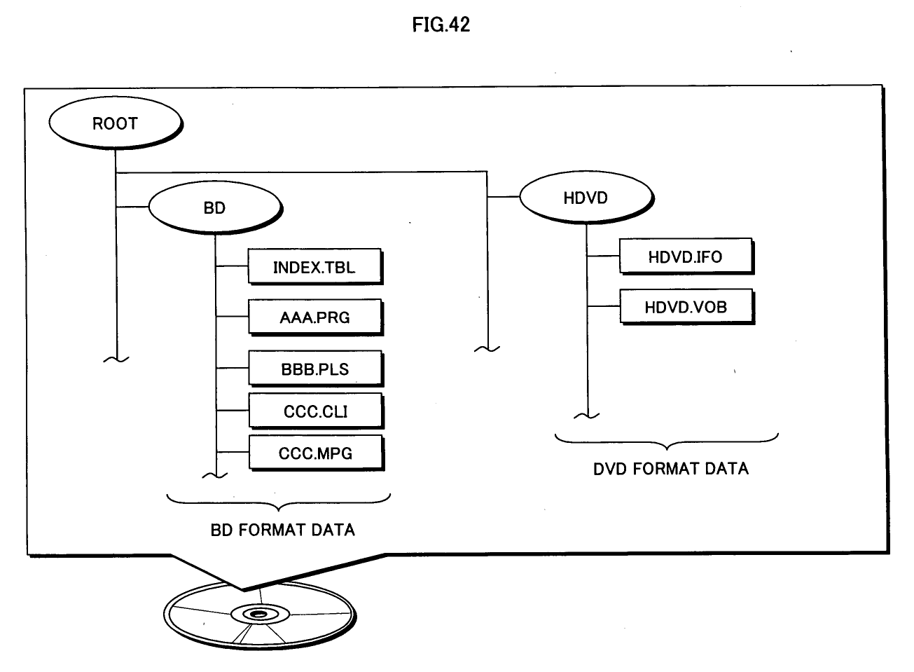

If an optical disc medium that can record a plurality of application formats is selected as the recording destination, it is preferable that the data size is used as the criterion for selection of the format. FIG. 42 shows a disc having recorded thereon subdirectories, namely an HDVD directory and a BD directory, under a root directory. Under the BD directory, there are pieces of BD-ROM format data (INDEX.TBL, AAA.PRG, BBB.PLS, CCC.CLI, and CCC.MPG). Under the HDVD directory, there are pieces of DVD format-dependent data (HDVD.IFO and HDVD.VOB). In the case of copying format-dependent data of a TV program recorded on the HD drive 202 to such an optical disc medium on which there are both the DVD-video format-dependent data and the BD-ROM format-dependent data, the data size of each application format data recorded on the optical disc medium may be calculated, and the dubbing may be performed in accordance with the application format having a larger data size.

### Criterion for Selection of Format: Writing Date

In the case of copying format-dependent data of a TV program recorded on the HD drive 202 to an optical disc medium that can record a plurality of application formats, the writing date of the files in the respective formats recorded on the optical disc medium may be compared with each other, and the dubbing may be performed in accordance with the format to which the file that has been recorded most recently belongs. For example, in the case of dubbing to a DVD on which both BD application format data and HD-DVD application format data are recorded, the writing dates of files constituting the BD application format and the HD-DVD format are compared with each other. If the BD file that has been recorded most recently is INDEX.TBL and the recording date thereof is Dec. 25, 2006, and the HD-DVD file that has been recorded most recently is HDVD.IFO and the recording date thereof is Jan. 1, 2006, it can be found that BD file is the newest file. If this is the case, the recording apparatus copies the format-dependent data of the TV program recorded on the HD drive 202 in accordance with the BD application format. With the stated structure, it is possible to perform the dubbing in the format that the user often uses for the optical disc medium.

### Criterion for Selection of Format: Media Mode

In the case of copying format-dependent data of a TV program to an optical disc medium that can record a plurality of application formats, the data may be recorded in the format indicated by the medium mode 803 of the TV program. For example, in the case of copying format-dependent data of a TV program that is recorded on the HDD and whose media mode 803 is BD, the dubbing is to be performed in accordance with the BD application format, and in the case of copying format-dependent data of a TV program that is recorded on the HDD and whose media mode 803 is HD-DVD, the dubbing is to be performed in accordance with the HD-DVD application format.

### Sixth Embodiment

In this embodiment, an optical disc medium having a multilayer structure is used. This embodiment relates to a modification that realizes the format duplication on such an optical disc medium.

In this embodiment, an optical disc medium (hereinafter called a BD/DVD hybrid disc) having a physical structure of a BD on the first layer and a physical structure of a DVD disc on the second layer is used for explanation.

With a BD/DVD hybrid disc, it is possible to record/play back data on the first layer (BD) using a blue-violet laser (wavelength: 405 nm), and on the second layer (DVD) using a red laser (wavelength: 650 nm). For example, a conventional DVD player equipped with only a red laser device is capable of playing back only data recorded on the DVD recording layer, and a conventional BD player equipped with only a blue-violet laser device is capable of playing back only data recorded on the BD layer.

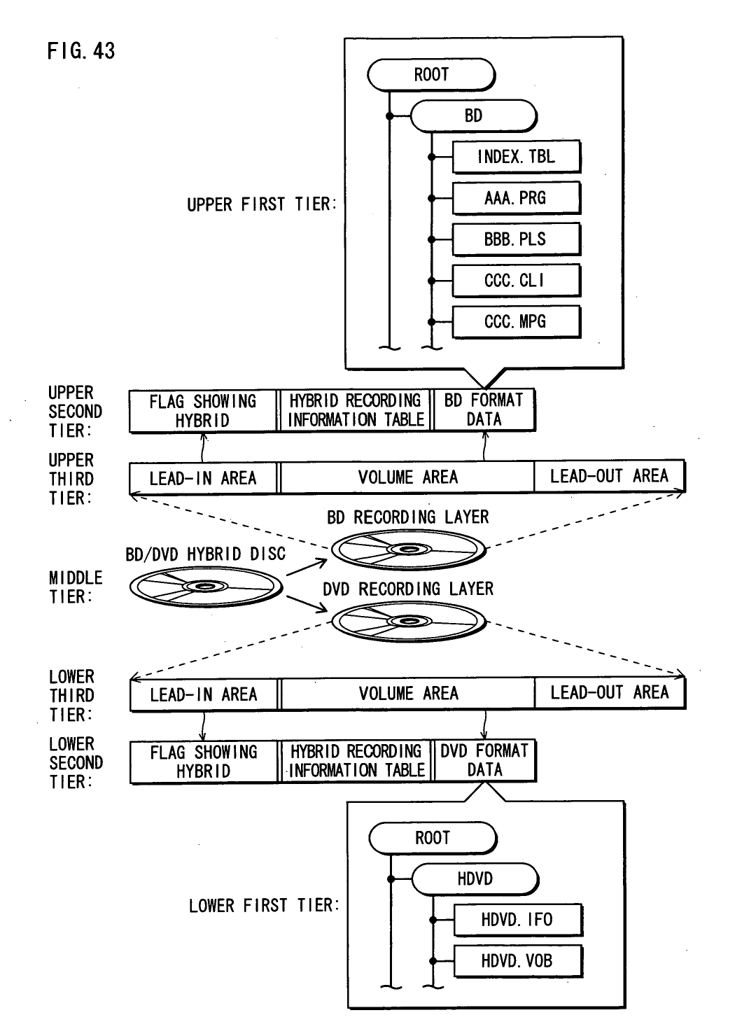

FIG. 43 shows an internal structure of a hybrid medium. In this figure, the middle tier represents a physical structure of the hybrid medium. As shown at the middle tier in the figure, the hybrid medium includes a BD recording layer and a DVD recording layer.

The upper third tier depicts that a track spirally formed on the BD recording layer has been drawn out to the sides. This upper third tier shows that this track consists of a lead-in area, a volume area, and a lead-out area. The upper second tier shows the internal structures of the lead-in area and the lead-out area. According to the upper second tier, a flag showing that this disc is a “hybrid medium” is recorded on the lead-in area. The lead-in area is the area to be read first when the optical disc medium is loaded. Accordingly, it is possible to have the recording/playback apparatus perform operations that are unique to hybrid media. With such a structure, even if this hybrid medium is loaded into a recording/playback apparatus that can record on/read from only one of the layers, the flag will be interpreted by the recording/playback apparatus. Also, it is possible to allow the recording/playback apparatus to perform only playback when the flag is TRUE.

The volume area on the BD recording layer stores a hybrid recording information table and BD format data. The upper first tier shows the internal structure of the BD format data. The BD format data is constituted of files such as INDEX.TBL, AAA.PRG, BBB.PLS, CCC.CLI, and CCC.MPG.

The lower third tier depicts that a track spirally formed on the DVD recording layer has been drawn out to the sides. This lower third tier shows that this track consists of a lead-in area, a volume area, and a lead-out area. The lower second tier shows the internal structures of the lead-in area and the lead-out area. According to the lower second tier, a flag showing that this disc is a “hybrid medium” is recorded on the lead-in area. The volume area on the DVD recording layer stores a hybrid recording information table and DVD format data. The lower first tier shows the internal structure of the DVD format data. The DVD format data is constituted of files such as HDVD.IFO and HDVD.VOB.

Here, regarding two-layer hybrid media, a problem is how to even out the usage rates of the both layers.

If the total capacity of the BD recording layer is 30 GB and the total capacity of the DVD recording layer is 4.7 GB, it is necessary to manage the areas such that the usage of 30 GB of the BD recording layer is equivalent to the usage of the 4.7 GB of the DVD recording layer in terms of the recording time.

This is for the following reason. The distribution of hybrid media that have both the BD recording layer and the DVD recording layer means that the distribution of BD discs and DVD discs on the market is under a complicated situation where the difference between BD discs and DVD discs are not clear for the users. The manufactures and the users demand recording/playback apparatuses that can use both BD discs and DVD discs for recording and playback.

Under such a complicated situation, the recording/playback apparatus is required to handle the two recording layers on equal terms. When the usage rates of the two layers are not the same, the recording/playback apparatus has to calculate the free disc space to be presented to the user based on the higher usage rate between the two. For example, if the usage rate of one layer is ¾ and the usage rate of the other layer is ½, the usage rate of the former layer should be presented to the user as the usage rate of the medium. If this is the case, ¼ as the differential area will be left unused. This lowers the usage efficiency of the medium.

The following explains pieces of format-dependent data recorded on each recording layer. The format-dependent data is consisted of plural pieces of data such as an AV stream, map information and playlist information. The AV stream is a multiplexed stream obtained by multiplexing a video stream and an audio stream that are encoded in MPEG2, MPEG4-AVC or the like. The AV stream is called as a VOB (Video Object) according to the DVD-Video-Recording standard, and called as an AVClip according to the Blu-ray Disc Rewritable standard.

The map information shows correspondence between address information of an access unit (i.e. a playback unit that can be decoded individually) of the above-described video stream, and the playback start time on the playback time axis of the video stream. The time map is called as a Time Map according to the DVD-Video-Recording standard, and called an EP_map according to the Blu-ray Disc Rewritable standard.

The playlist information defines one or more playback sections by a pair of information sets showing the start point and the end point. Among the components described above, the AV stream is encoded by variable-length encoding, and it is possible to change the size of the area to occupy on the hybrid medium by changing the bit rate for encoding the AV stream.

Accordingly, to even out the usage rates as described above, a bit rate that is calculated based on the size of the AV stream of the format-dependent data recorded on one recording layer and the free disk space on the layer measured at the time when the format-dependent data is recorded is applied to the AV stream of the format-dependent data recorded on the other recording layer. As a result, it is possible to even out the usage rates of the two recording layers.

For example, if there is 20 GB free space on the BD recording layer and an AV stream of a TV program for two hours having 10 GB is to be recorded on the BD recording layer, the bit rate for the DVD recording layer having 4 GB free space is determined for the format conversion of the AV stream such that the size of the AV stream of the TV program will be 4×10/20=2 GB. With the stated structure, it is possible to even out the remaining capacities of the BD and DVD layers.

However, if a recording apparatus that can access only one of the layers records data on the hybrid medium, the usage rates will be uneven regardless of the above-described attempt to even out.

As a result, at the duplication of the format, inconsistency will be caused where one of the recording layers has enough space to record the content but the other recording layer does not have enough space.

In such a case, substitute data will be written onto the other layer. The substitute data is digest data generated from the content, a thumbnail of the content, or still image data corresponding to the content.

The digest data is obtained by cutting out part of the TV program data. In the case where the digest data is recorded on the recording layer that does not have enough space, even if the hybrid medium is loaded into a playback apparatus that can play back only one of the layers, the user can see what is recorded on at least the other layer by viewing the digest version.

In the case where a representative thumbnail of the TV program or a still image showing the program content acquired from the EPG or the like is used as the substitute data, even if the hybrid medium is loaded into a playback apparatus that can playback only one of the layers, the user can see what is recorded on at least the other layer by viewing the thumbnail or the still image.

This concludes the explanation of the recording medium pertaining to this embodiment. The following explains the recording/playback apparatus pertaining to this embodiment. The structure of this recording/playback apparatus is almost the same as those of the embodiments described above. Accordingly, only the improvements are described here.

### Improvements of the Blu-Ray/DVD Drive 201

The Blu-ray/DVD drive 201 pertaining to this embodiment is different from that of the other embodiments above in that it can load an optical disc medium having a multilayer structure where there are two layers on one side and physical structures of the first and second layers are different, and record/play back data on both of the recording layers of the BD/DVD hybrid disc. The Blu-ray/DVD drive 201 records/plays back data on the first layer (BD) using a blue-violet laser, and on the second layer (DVD) using a red laser. The Blu-ray/DVD drive 201 switches between the lasers to be used for recording/playback of each layer. When starting writing, the Blu-ray/DVD drive 201 writes a flag in the lead-in area of each recording layer. The flag shows that the optical disc medium is a hybrid disc having a BD recording layer and a DVD recording layer.

Here, note that the flag showing that the optical disc medium is a hybrid disc having a BD recording layer and a DVD recording layer may be recorded in advance when the disc is manufactured. With this structure, since it is secured that the flag always exists, the Blu-ray/DVD drive 201 can easily recognize that the disc is a hybrid disc only by checking the flag.

The dubbing control unit 213 switches the layers to which the data is to be copied, according to the media mode 803. For example, in the case of a BD/DVD hybrid disc, the dubbing control unit 213 copies data to the DVD recording layer if the media mode 803 of the recorded TV program is DVD, and copies data to the BD recording layer if the media mode 803 of the recorded TV program is BD. With the stated structure, the user can perform the dubbing at a high speed even if the disc is a hybrid disc.

The following explains control performed by the dubbing control unit 213 during the dubbing processing.

### Dubbing Processing

For dubbing, the user's operations are input via the dubbing configuration GUI. The dubbing configuration GUI 1001 has the dubbing candidate table 1002, as described in the fifth embodiment. The dubbing control unit 213 starts the dubbing processing when the user ticks the dubbing check box 1003 and presses the OK button on the dubbing configuration GUI 1001. At this moment, if a BD/DVD hybrid disc is loaded into the drive, a sign “BD/DVD” is displayed as the dubbing destination.

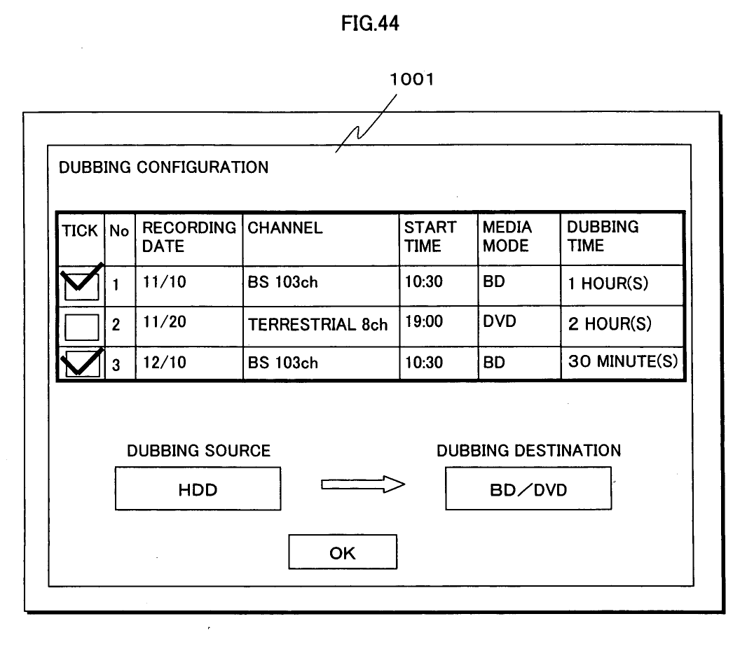

FIG. 44 shows the dubbing configuration GUI 1001 used for copying a recorded TV program to a BD/DVD hybrid disc.

When instructed to perform dubbing via the dubbing configuration GUI 1001, the dubbing control unit 213 searches the recording information table 901 for a TV program whose dubbing check box 1003 has been ticked, acquires the stream of such a TV program, and writes the stream on each of the layers on the BD/DVD hybrid disc. Since an ideal recording destination, that is, the media mode has been set for the TV program as the content, the dubbing control unit 213 directly selects the layer (designated layer) onto which the AV stream constituting the TV program should be written. As described in the fifth embodiment, the stream has been recorded on the built-in medium in the format that corresponds to the media mode. Accordingly, the writing to the designated layer can be realizes as file copy.

Regarding the recording layer that has not been selected, i.e. undesignated layer, an optimum bit rate for the undesignated layer recording will be calculated. The recording/playback apparatus performs re-encoding of the AV stream included in the content based on the calculated bit rate, and writes the content that includes the re-encoded AV stream onto the undesignated layer.

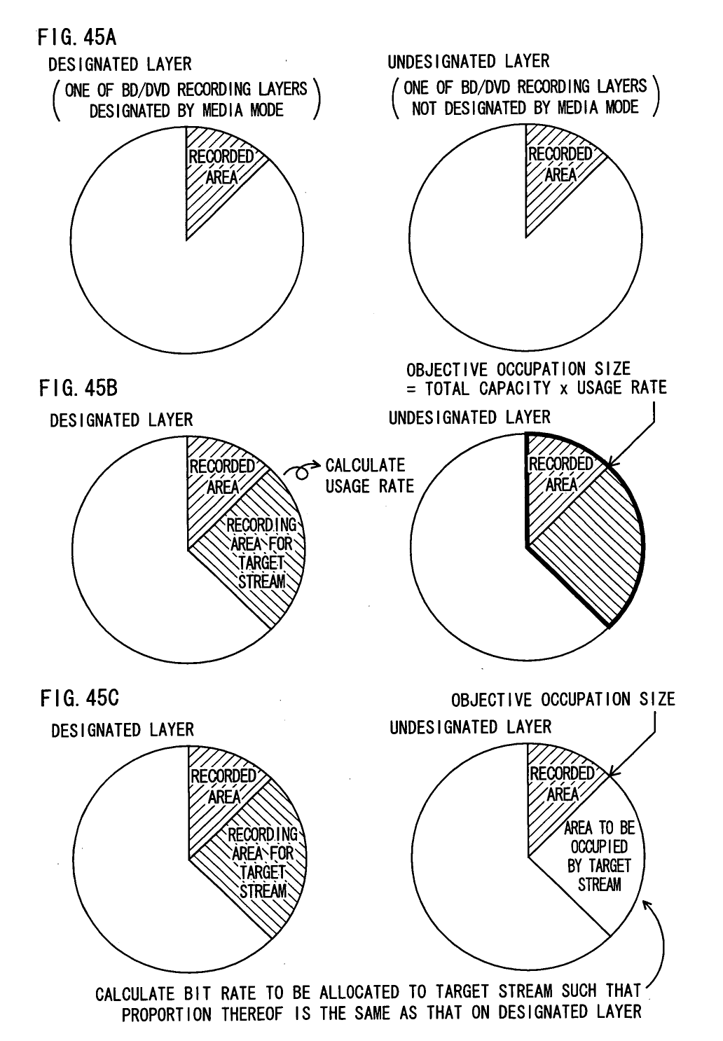

FIG. 45A to FIG. 45C are pie charts showing transitions of usage rates of the designated layer and the undesignated layer. FIG. 45A shows the initial status. Here, it is assumed that there is a recorded area whose proportion is shown by the shaded sector. If the recording layer that matches the media mode given to the TV program is the designated layer, the AV stream is to be written on this designated layer. FIG. 45B shows a status where the AV stream is recorded only on the designated layer.

Next, in order to duplicate the format, the AV stream has to be recorded on the layer that does not match the media mode of the TV program, i.e. the undesignated layer as well. For this purpose, the recording/playback apparatus firstly calculates the proportion of the designated layer under the status where the target AV stream is recorded on the designated layer.

This proportion can be obtained by dividing the total of the size of the recorded area and the size of the recording area on which the target AV stream is recorded, by the total size of the designated layer. As the usage rate of the designated layer is obtained in this way, it is possible to obtain an objective occupation size that the recorded area should occupy on the undesignated layer by multiplying the total capacity of the undesignated layer by the usage rate.

The size of area to be occupied by the target AV stream on the undesignated area can be obtained by subtracting the size of the recorded area on the undesignated layer from the objective occupation size obtained above. Then, the bit rate to be allocated to the AV stream to be recorded on the undesignated layer can be obtained by dividing the AV stream occupation area size by the playback time length of the AV stream. By performing the above-described calculation, even if the sizes of the recorded areas on the designated layer and the undesignated layer are not the same, the recording/playback apparatus can even out the sizes when performing the dubbing.

For example, if the media mode 803 included in the recording information table 901 is BD, the AV stream of the TV program is to be recorded as it is on the BD recording layer of the BD/DVD hybrid disc. On the other hand, the AV stream of the TV program is to be recorded on the DVD recording layer after being re-encoded at an above-described optimum bit rate such that the usage rates of the both layers become the same.

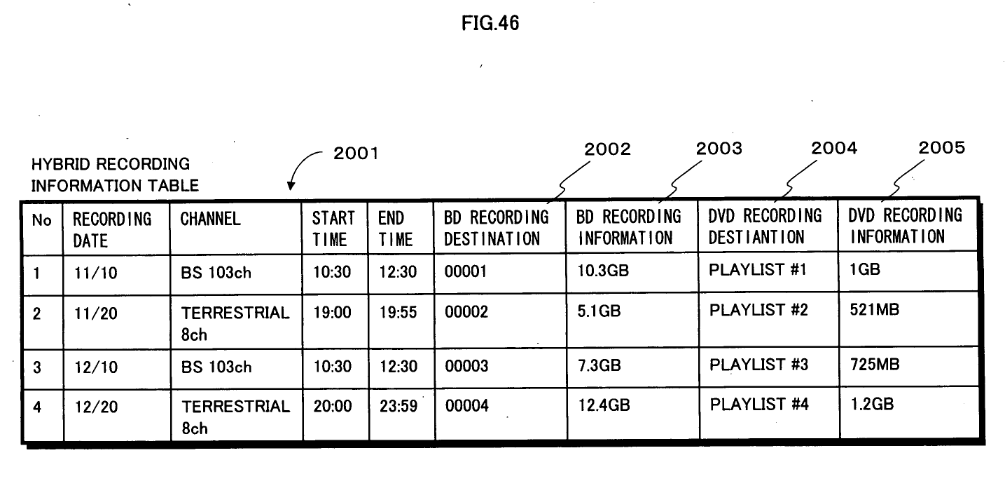

After that, the recording/playback apparatus generates a hybrid recording information table 2001 illustrated in FIG. 46, and write it on each layer.

FIG. 46 is an example of the hybrid recording information table 2001. As FIG. 46 shows, the hybrid recording information table 2001 includes, for each TV program recorded on the BD/DVD hybrid disc, a recording date, a channel, a start time, an end time, a BD recording destination 2002, BD recording information 2003, a DVD recording destination 2004, and DVD recording information 2005. The recording date, the channel, the start time and the end time can be acquired from items of the corresponding TV program included in the recording information table 901. The BD recording destination 2002 is information to be used for specifying a location in the BD application format of a TV program recorded on the BD recording layer. In FIG. 46, the BD recording destination 2002 indicates a playlist file number. The BD recording information 2003 is information used for judging whether the format-dependent data of a TV program recorded on the BD recording layer has been changed from when it was recorded. The DVD recording destination 2004 is information to be used for specifying a location in the DVD application format of a TV program recorded on the DVD recording layer. In FIG. 46, a playlist number is used as the DVD recording destination 2004. The DVD recording information 2005 is information used for judging whether the format-dependent data of a TV program recorded on the DVD recording layer has been changed from when it was recorded.

If one of the two layers does not have an enough space to record contents even though the other layer has an enough space, the recording/playback apparatus generates substitute data. The substitute data is any one of digest data generated from the content, a thumbnail of the content, and still image data corresponding to the content. Such substitute data is to be written on the layer that does not have enough space. This concludes the explanation of the processing procedure for the dubbing. The following explains processing procedures for deletion.

### How to Choose Designated Layer and Undesignated Layer

In this embodiment, a recording layer that corresponds to the media mode shown in the fifth embodiment is selected out of the BD recording layer and the DVD recording layer as a designated layer, and the other is selected as an undesignated layer. However, the designated layer and the undesignated layer may be selected based on any attribute given to the content, instead of the media mode. For example, the designated layer and the undesignated layer may be selected based on the priority flag of the fourth embodiment, instead of the media mode. Specifically, the recording layer that corresponds to the format-dependent data whose priority flag is “1” is selected as the designated layer, and the recording layer that corresponds to the format-dependent data whose priority flag is “0” is selected as the undesignated layer. Then, the recording/playback apparatus reads pieces of the format-dependent data recorded on the HD drive 202, respectively corresponding to the BD and the DVD, and writes them onto the designated layer and the undesignated layer respectively. In the fourth embodiment, since the BD format-dependent data and the DVD format-dependent data have been simultaneously generated at the recording, it is unnecessary to perform the format conversion at the execution of the dubbing. As a result, it is possible to perform the writing onto the designated layer and the undesignated layer at a high speed.

### Deletion Processing

The deletion control unit 214 of this embodiment displays a program navigator, and receives designation of TV programs to be deleted from the user via the check boxes of the program navigator.

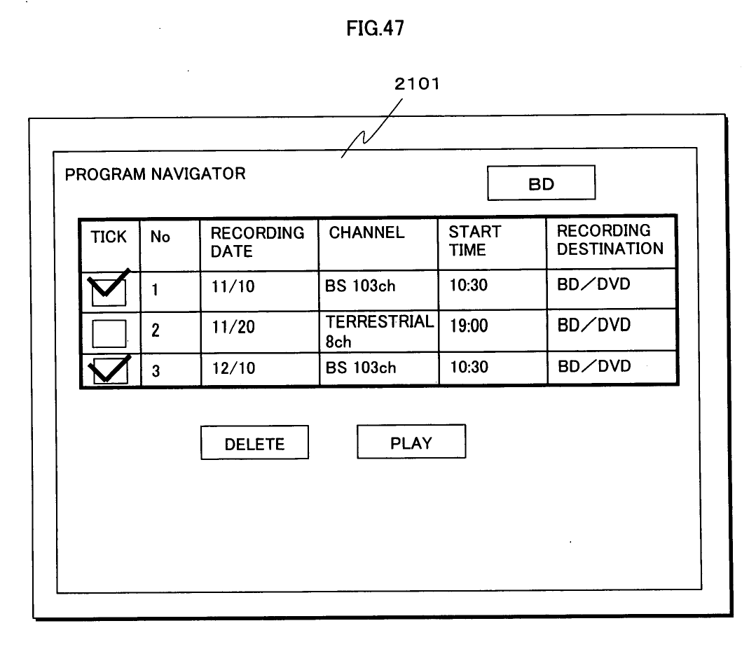

Here, the “program navigator” is for graphically displaying a plurality of TV programs recorded on the HD drive 202. FIG. 47 shows a program navigator 2101 for TV programs recorded on the BD/DVD hybrid disc. The program navigator 2101 shows a list of TV programs recorded on the BD recording layer. The list shows information of the TV programs using the program number, the recording date, the channel, the recording start time, and the recording destination. Such a list is generated based on the hybrid recording information table 2001, data recorded on the BD layer, and so on. A check box is provided for each item. The user ticks the check box and presses the delete button, and then the TV program deletion processing is started.

The deletion control unit 214 specifies the location of the BD format-dependent data of the TV programs that have been ticked to be deleted, based on the hybrid recording information table 2001 and management information recorded on the BD, such as playlists. Next, the deletion control unit 214 refers to the hybrid recording information table 2001 to confirm that the specified location exists on the BD recording destination 2002 and the BD recording information 2003 matches the information that can be obtained from the actual data. If this is confirmed, the deletion control unit 214 acquires the DVD recording destination 2004 in the same row as the BD recording destination 2002. Then, the deletion control unit 214 deletes the BD format-dependent data to be deleted. The format-dependent data includes an AV stream and management information such as a playlist to be used for instruction of playback of the AV stream.

After completing the data on the BD recording layer, the deletion control unit 214 deletes data on the DVD recording layer. Firstly, the deletion control unit 214 confirms that the information that can be obtained from the actual data of the DVD recording destination 2004 matches the DVD recording information 2005. If they match, the deletion control unit 214 deletes the data indicated by the DVD recording destination 2004. If not, or if the DVD recording destination 2004 can not be specified, the deletion control unit 214 does nothing as to the DVD layer. Finally, the deletion control unit 214 a row of the hybrid recording information table 2001 where the BD recording destination 2002 is the same as the location of the deleted recording destination, and write the hybrid recording information table 2001 on both BD and DVD layers. With such a structure, it is possible to record/delete the same TV program onto/from both the BD and DVD layers. Also, for example, other recording apparatuses that do not recognize the hybrid recording information table partially delete or sort TV programs recorded on the BD recording layer of the BD/DVD hybrid disc, the recording apparatus of this embodiment can recognize that the data has been edited or rewritten when the disc is loaded again. This is because other apparatus can not rewrite the hybrid recording information table 2001, and the recording apparatus of this embodiment can recognize that the BD recording information 2003 is different from the data actually recorded on the BD recording layer. In such a case, the recording apparatus of this embodiment does not delete the TV program recorded on the DVD layer. Therefore, the data is prevented from being deleted mistakenly.

As a result, users can view the same program even with a playback apparatus that can only play back data recorded on the DVD layer, and a playback apparatus that can only playback data recorded on the BD recording layer.

In this embodiment, if the BD recording information 2003 does not match the data actually recorded at the BD recording destination 2002, or if the DVD recording information 2005 does not match the data actually recorded at the DVD recording destination 2004, the recording apparatus of this embodiment does not delete data, by judging that the TV programs recorded on the BD recording layer of the BD/DVD hybrid disc has been partially deleted or sorted by another recording apparatus that does not recognize the hybrid recording information table 2001. However, the recording apparatus of this embodiment may display a warning message to prompt the user to judge whether to delete the data of the TV program or not. As a result, it is possible to realize TV program deletion that reflects the user's intention.

The following explains processing procedures for recording, dubbing, and deletion of TV programs, with reference to flowcharts.

The processing procedures for recording TV programs are the same those explained in the fifth embodiment. Therefore, explanations thereof are omitted here.

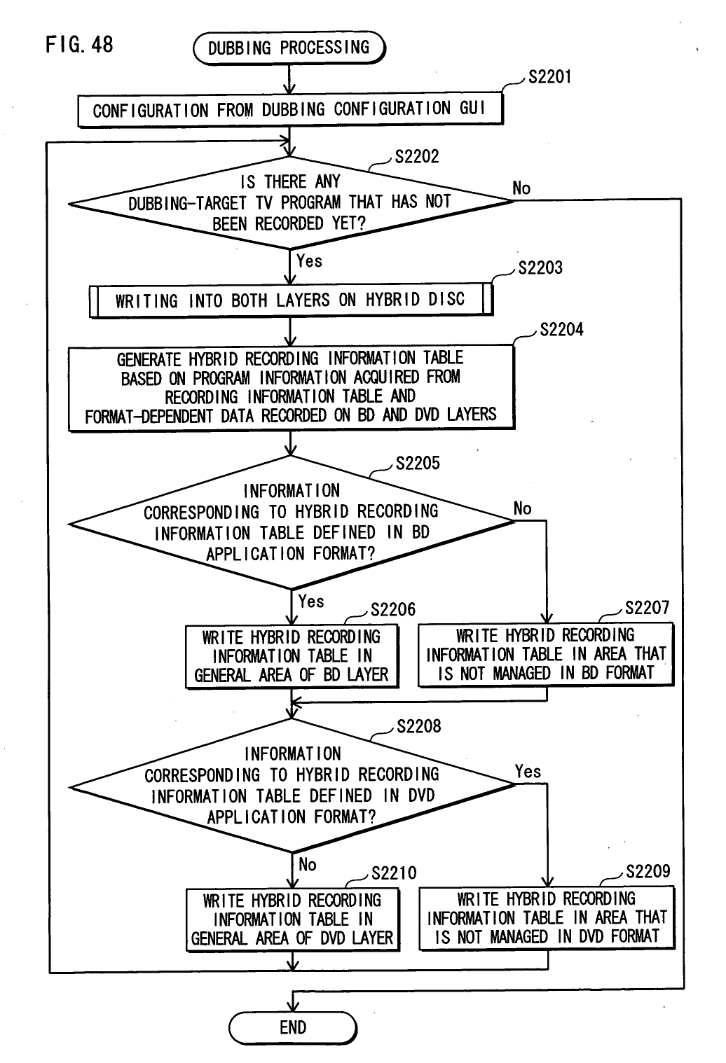

FIG. 48 is a flowchart showing processing procedures for copying TV program to a BD/DVD hybrid disc in accordance with the dubbing configuration information configured by the user.

In Step S2201, the user selects, via a dubbing configuration GUI 1001, dubbing targets from among the TV programs recorded on the HD drive 202.

In Step S2202, if all the dubbing target TV programs have been copied to the BD/DVD hybrid disc, the recording apparatus finishes the processing. If any of the dubbing target TV programs have not been copied to the BD/DVD hybrid disc, the recording apparatus selects one of them and moves to Step S2203.

In Step S2203, the recording apparatus writes data on the both layers of the BD/DVD hybrid disc. In this regard, the recording apparatus reads an AV stream constituting the format-dependent data of the target TV program from the HDD 202. Regarding the designated layer, the recording apparatus writes the AV stream as it is. Regarding the undesignated layer, the recording apparatus re-encodes the AV stream included in the format-dependent data of the TV program, and writes the re-encoded stream. At this moment, the recording apparatus writes the management information such as the playlist as well.

Step S2204, the recording apparatus generates a hybrid recording information table 2001 based on the program information acquired from the recording information table 901 and the pieces of format-dependent data respectively recorded on the BD recording layer and the DVD recording layer.

In Step S2205, the recording apparatus judges whether any data corresponding to the hybrid recording information table 2001 is defined in the BD application format. If data corresponding to the hybrid recording information table 2001 is defined in the BD application format, the recording apparatus records the hybrid recording information table 2001 in a general recording area on the BD recording layer in Step S2206. If not, the recording apparatus write the hybrid recording information table 2001 in an area that is not managed in the BD application format. This is for preventing an apparatus that records/plays back only BD application format data from deleting the hybrid recording information table 2001.

In Step S2208, the recording apparatus judges whether any data corresponding to the hybrid recording information table 2001 is defined in the DVD application format. If data corresponding to the hybrid recording information table 2001 is defined in the DVD application format, the recording apparatus records the hybrid recording information table 2001 in a general recording area on the DVD recording layer in Step S2209. If not, the recording apparatus write the hybrid recording information table 2001 in an area that is not managed in the DVD application format. This is for preventing an apparatus that records/plays back only DVD application format data from deleting the hybrid recording information table 2001.

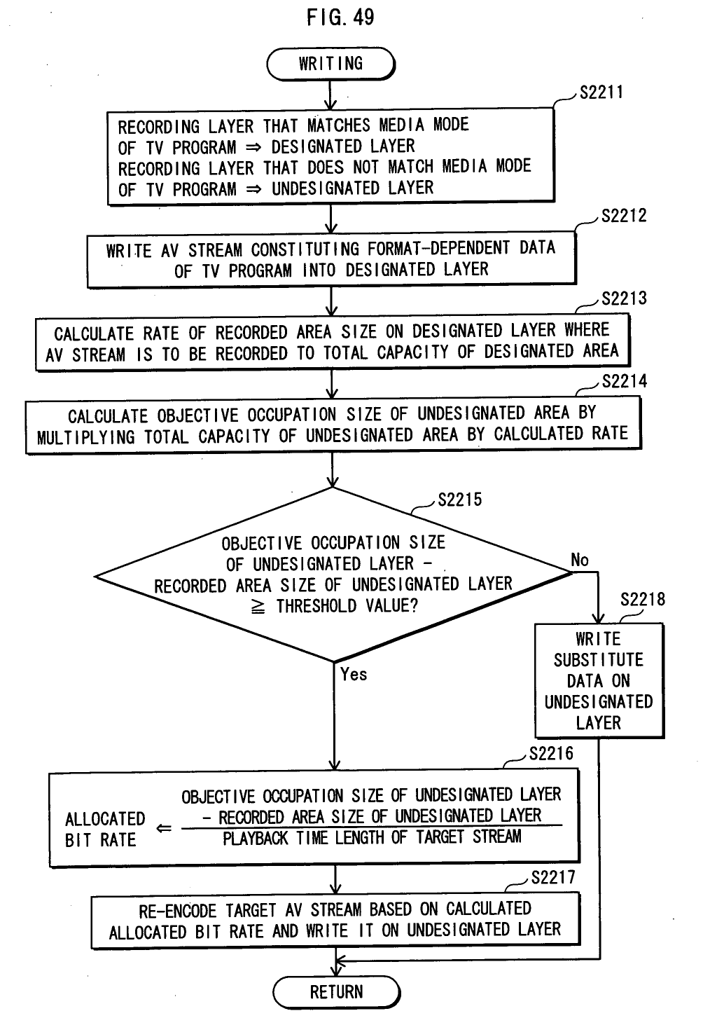

FIG. 49 is a flowchart showing processing procedures for writing data onto the both layers of a BD/DVD hybrid disc. Firstly, in Step S2211, the recording apparatus determines, as the designated layer, a recording layer that matches the media mode of the TV program as the content, and determines, as the undesignated layer, a recording layer that does not match the media mode of the TV program as the content.

In Step S2212, the recording apparatus writes the AV stream constituting the format-dependent data of the TV program onto the designated layer.

In Step S2213, the recording apparatus calculates the rate of the recorded area size on the designated layer where the AV stream is to be recorded to the total capacity of the designated area.

In Step S2214, the recording apparatus calculates the objective occupation size of the undesignated area by multiplying the total capacity of the undesignated area by the calculated rate.

Step S2215 is for judging whether a value obtained by subtracting the size of the recorded area on the undesignated layer from the objective occupation size of the undesignated layer is greater than a prescribed value. If the judgment result is “YES”, the recording apparatus moves to Step S2216. In Step S2216, the value obtained by subtracting the size of the recorded area on the undesignated layer from the objective occupation size of the undesignated layer is divided by the playback time length of the AV stream constituting the format-dependent data of the TV program to calculate the bit rate to be allocated. Then, based on the allocated bit rate calculated in Step S2217, the recording apparatus re-encode the target AV stream, and write the re-encoded AV stream on the undesignated layer.

If the judgment result of Step S2215 is “NO”, the recording apparatus generates substitute data and writes it on the undesignated layer.

This concludes the explanation of the processing procedures for copying a TV program to a BD/DVD hybrid disc in accordance with the dubbing configuration information configured by the user.

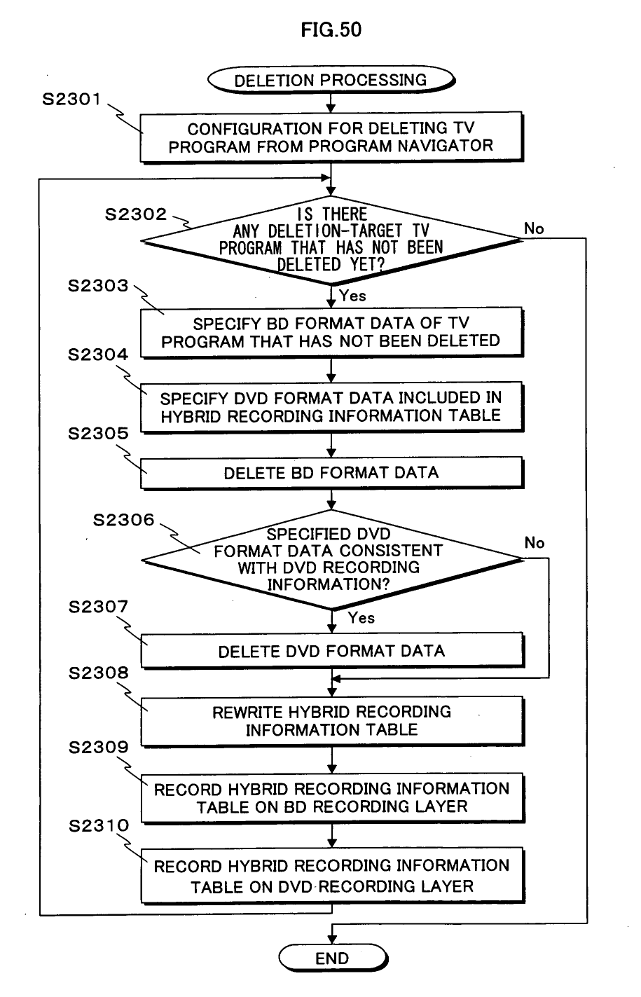

Next, the following explains deletion of a TV program according to this embodiment, with reference to FIG. 50.

FIG. 50 is a flowchart showing processing procedures for deleting a TV program from a BD/DVD hybrid disc in accordance with deletion configuration information configured by the user.

In Step S2301, the recording apparatus displays a program navigator 2101 that shows program information recorded on one of the layers of the BD/DVD hybrid disc, in order to prompt the user to designate a TV program to be deleted. In the example of FIG. 50, a list of TV programs recorded on the BD is generated based on the format-dependent data recorded on the BD recording layer and the hybrid-recording information table 2001.

In Step S2302, the recording apparatus checks whether there is any deletion-target TV program that has not been deleted yet. If all the deletion-target programs have been deleted, the recording apparatus finishes the processing. If there are deletion-target TV programs that have not been deleted, the recording apparatus selects one of them and moves to Step S2303.

In Step S2303, the recording apparatus specifies the location of the format-dependent data of the TV program to be deleted, from among the pieces of format-dependent data of the TV programs recorded on the BD recording layer.

In Step S2304, the recording apparatus refers to the BD format dependent data to be deleted and the hybrid recording information table 2001, and specifies the location of the format-dependent data of the same TV program recorded on the DVD layer. The recording apparatus specifies such a program in the following manner: The recording apparatus searches for a row of the Hybrid recording information table 2001 where the BD format-dependent data and the BD recording destination 2002 matches, and checks the consistency between the BD format data and the BD recording information 2003 in the row found by the search. For example, the recording apparatus checks whether the size of the AV stream of the BD format-dependent data is the same as the size shown in the BD recording information 2003. If the consistency is confirmed, the recording apparatus specifies the location of the format-dependent data of the TV program recorded on the DVD layer.

In Step S2305, the recording apparatus deletes the BD format-dependent data. At this moment, the recording apparatus deletes the management information such as the playlist as well as the AV stream.

In Step S2306, the recording apparatus checks the consistency between the format-dependent data of the TV program recorded on the DVD recording layer, which has been specified in Step S2304, and the DVD recording information 2005 shown in the same row in the hybrid recording information table 2001. For example, the recording apparatus checks whether the size of the AV stream of the DVD format-dependent data is the same as the size shown in the DVD recording information 2005. If the consistency is confirmed, the recording apparatus moves to Step S2307, and if not, moves to Step S2308.

In Step S2307, the recording apparatus deletes the DVD format-dependent data. At this moment, the recording apparatus deletes the management information such as the playlist as well as the AV stream.

In Step S2307, the recording apparatus corrects the hybrid recording information table 2001. If BD format-dependent data is shown in any row of the hybrid recording information table 2001, the recording apparatus deletes the row.

In Step S2309, the recording apparatus writes the hybrid recording information table 2001, which has been corrected in Step S2308, onto the BD.

In Step S2310, the recording apparatus writes the hybrid recording information table 2001, which has been corrected in Step S2308, onto the DVD.

This concludes the explanation of the processing procedures for deleting a TV program from a BD/DVD hybrid disc in accordance with the deletion configuration information configured by the user.

With the stated structure, regarding optical disc media such as a BD/DVD hybrid disc having a multilayer structure including a first layer and second layer each having a different physical structure, it becomes possible to record/delete the same TV program onto/from the both format layers. Accordingly, even a player that can play back only one of the physical layers can play back the same TV program.

Note that various changes to the above-mentioned technical features may be made without departing from the scope of the invention. The following describes specific examples of such changes.

### Judgment of Sameness of TV Program

In this embodiment, the hybrid recording information table 2001 is used for securing the consistency of the BD/DVD to record/delete the same TV program. However, the recording apparatus may analyze the AV streams on the BD/DVD and extract image feature quantity to judge which AV streams includes the same contents. With such a structure, it is unnecessary to record the hybrid recording information table on the disc.

### Selection of Recording Layer

The layer on to which the each of AV streams of the TV programs recorded on the HD drive 202 is to be copied may be determined based on the resolution of the AV stream. For example, the video of the AV stream of the TV program having the SD image quality (720×480) may be recorded on the DVD layer, and that having the HD image quality (1920×720) may be recorded on the VD recording layer by priority. As a result, it is possible to record the AV stream in accordance with the feature of each format, and effectively use the capacity of the hybrid disc. Although it is explained in this embodiment that the same TV program is copied on each of the BD and DVD layers, it is possible to record the TV program onto the layer that has recorded data most recently. With such a structure, it is possible to perform the recording in the format that the user often uses.

### BD/DVD Formats Simultaneous Conversion

When performing real time recording, the recording apparatus may convert the AV stream to be in both BD and DVD formats, and record them on the BD and DVD layers respectively. Also, when performing dubbing, the recording apparatus may convert the AV stream to be in both BD and DVD formats, and copy them onto the BD and DVD layers respectively.

### Criteria for Deletion

Regarding the deletion performed in this embodiment, the sameness of the contents on the designated layer and the undesignated layer is judged using the data size of the AV stream of the TV program recorded on the BD recording layer. However, any information may be used for the judgment as long as it can be used for judging whether the format-dependent data of the TV program recorded on the BD recording layer, which exists at the time the hybrid recording information table 2001 is generated, is the same as the format-dependent of the TV program recorded on the BD recording layer, which exists at the time of the deletion. For example, hash data of the AV stream to be recorded may be used.

### Format Conversion Methods

At the dubbing from the HD drive 202 to the BD, the recording apparatus repeats reading of part of the AV stream that correspond to a unit time and writing of the read data onto the BD-ROM as to the whole AV stream. It is preferable that the conversion of the DVD format-dependent data is performed during this reading operation. By performing the conversion during such a reading, it is possible to reduce the time required for converting the format of the AV stream for the DVD format after completing the dubbing to the BD. Accordingly, it is possible to perform the dubbing to the DVD at a high speed.

### Designation of Recording Layer by User

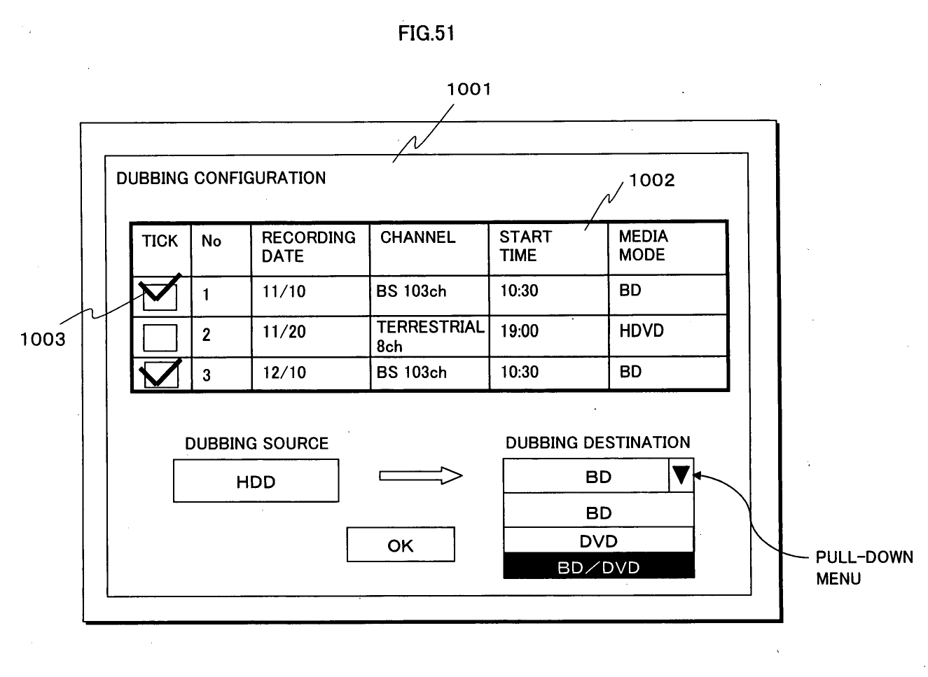

As FIG. 51 shows, a GUI for selecting a dubbing destination may be provided. In FIG. 51, a pull-down menu shows a list of dubbing destinations, and user can select one of the media formats to which the data is to be copied. For example, if the BD is selected as the dubbing destination, all the TV programs will be recorded as BD format data, and if the DVD is selected as the dubbing destination, all the TV programs will be recorded as DVD format data, and if the BD/DVD is selected as the dubbing destination, the TV programs will be recorded in both BD and DVD formats. With this structure, it is possible to reflect the user's preference as to which layer to use as the dubbing destination.

### Selection of Recording Layer

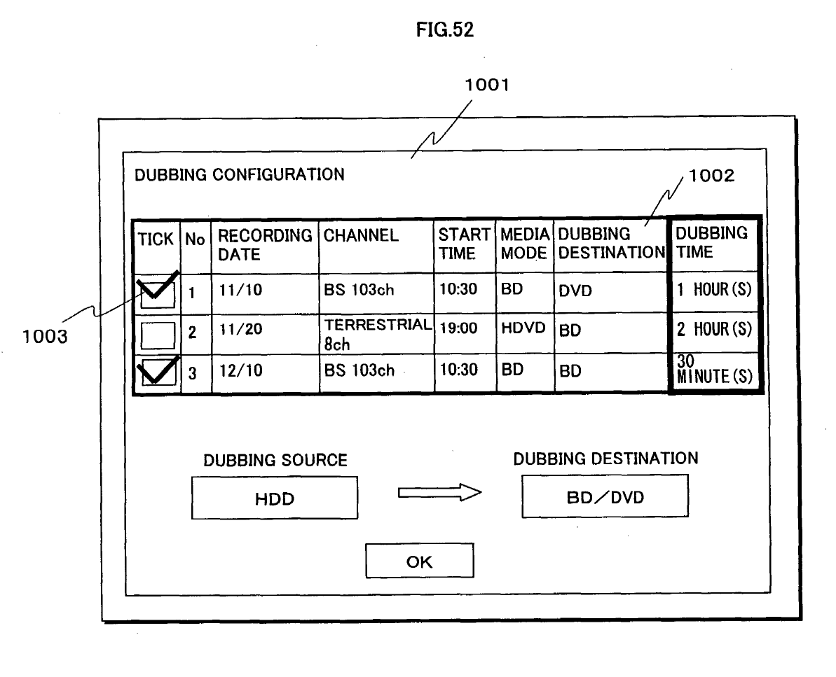

It is possible to allow the user to select a recording target layer for each TV program. With this structure, the user's preference can be reflected more precisely. FIG. 52 shows a GUI that enables the user to select either of the layers of a hybrid medium on which a TV program is to be recorded. A time required for the dubbing of the TV program may be calculated and displayed at the right most column of the dubbing configuration GUI 1001 as useful information for the user for selecting a format.

### Selection of Recording Layer According to Free Disc Space

In this embodiment, the same TV program is copied on each of the BD and DVD layers. However, the recording apparatus may acquire the free disc size of each of the BD and DVD layers, and record data only on the layer having a larger free disc space. With such a structure, it is possible to effectively use the capacity of the BD/DVD hybrid disc.

### Scope of Applicable Recording Media

In this embodiment, a medium having different physical layers, such as BD/DVD hybrid disc, is explained as an example. However, the present invention is also applicable to a recording medium that records different formats on the same physical layer, as illustrated in FIG. 42.

Also, although a BD/DVD hybrid disc is explained as an example in this embodiment, the present invention is applicable to any optical disc media that has multilayer structure including layers of different physical types, in addition to the BD/DVD hybrid disc. For example, it is possible to embody the present invention with combinations of the BD and the HDVD, the DVD and the HDVD and soon by changing the media type. Moreover, although the BD/DVD having two layers is explained as an example in this embodiment, the recording/playback apparatus of the present invention is also applicable with a disc that has three or more layers, such as BD/DVD/HDVD. This can be embodied by simply increasing the structure elements of the medium, and adding appropriate processing. Although an optical disc medium is explained as an example in this embodiment, the present invention is applicable in the same manner to semiconductor memories such as a SD card that includes a plurality of formats. This can be embodied by changing the disc drive, and providing reading control and writing control according to the physical structure of the medium.

### The Seventh Embodiment

This embodiment relates to improvements of a hybrid medium that has a BD-RE recording layer and a BD-ROM recording layer.

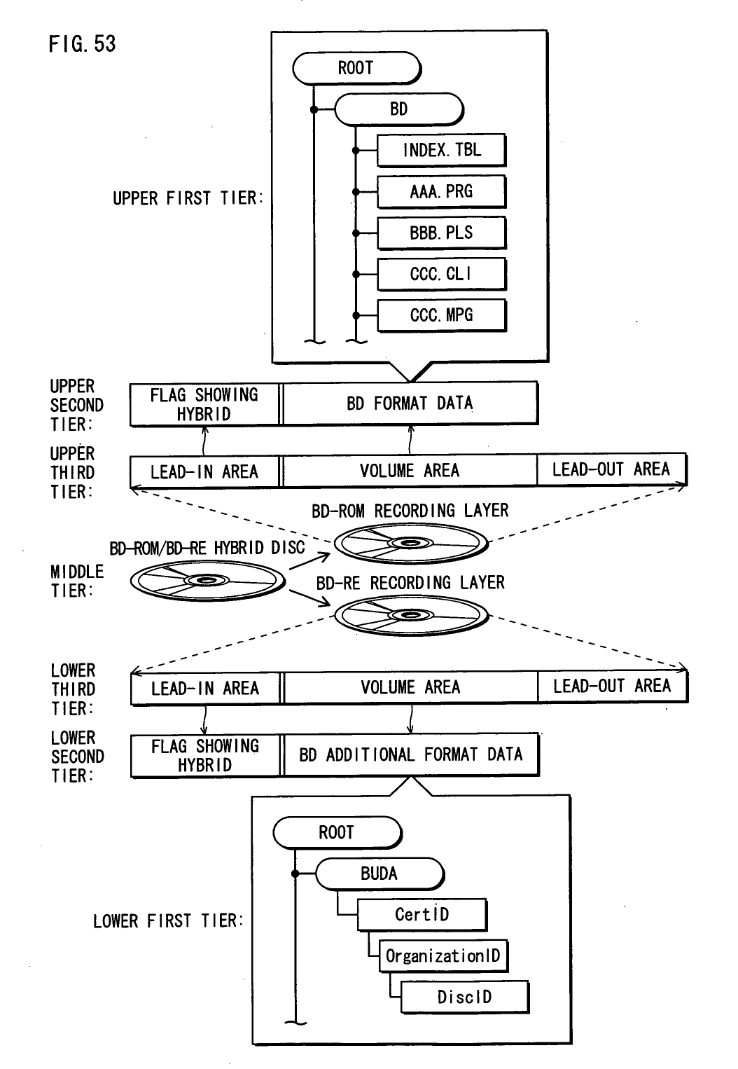

FIG. 53 shows an internal structure of a hybrid medium that has a BD-RE recording layer and a BD-ROM recording layer. In this figure, the middle tier represents a physical structure of the hybrid medium. As shown at the middle tier in the figure, the hybrid medium includes a BD-ROM recording layer and a DVD-RE recording layer.

The upper third tier depicts that a track spirally formed on the BD-ROM recording layer has been drawn out to the sides. This upper third tier shows that this track consists of a lead-in area, a volume area, and a lead-out area. The upper second tier shows the internal structures of the lead-in area and the lead-out area. According to the upper second tier, a flag showing that this disc is a hybrid disc having the BD-ROM recording layer and the BD-RE recording layer is recorded on the lead-in area.

The volume area on the BD-ROM recording layer stores a BD format data. The upper first tier shows the internal structure of the BD format data. The BD format data is constituted of files such as INDEX.TBL, AAA.PRG, BBB.PLS, CCC.CLI, and CCC.MPG.

The lower third tier depicts that a track spirally formed on the BD-RE recording layer has been drawn out to the sides. This lower third tier shows that this track consists of a lead-in area, a volume area, and a lead-out area. The lower second tier shows the internal structures of the lead-in area and the lead-out area. According to the lower second tier, a flag showing that this disc is a hybrid disc having the BD-ROM recording layer and the BD-RE recording layer is recorded on the lead-in area.

The volume area on the BD-RE recording layer stores data (addition format data) in the format for being added to the BD format-dependent data. The lower first tier shows the internal structure of addition format data.

The following explains the BD-ROM recording layer and the BD-RE recording layer in detail.

The BD-ROM recording layer is used for storing a basic content. The basic content is recoding data dependent on the application format of the BD, which is described in the embodiments above.

Interactive control using such BD format-dependent data is realized by operation mode objects.

The operation mode objects include an operation mode object for a movie mode and an operation mode object for a virtual machine mode.

The operation mode object for a movie includes navigation commands that show control procedures. This operation mode object is called a movie object.

The operation mode object for a virtual machine includes an application management table used for having the platform of the playback apparatus perform application signaling. This operation mode object is called a BD-J object.

The following explains Java™ applications, whose operations are defined by the operation mode object for the virtual machine mode. A Java™ application explained here is assumed to be controlled by an Application Manager via an xlet interface. The xlet interface has four statuses, namely “loaded”, “paused”, “active” and “destroyed”. Using the Java™ application, it is possible to realize a screen including button display, text display, online display and on, based on the HAVi framework, in combinations with moving pictures. The user can give instructions to this screen using remote control.

The application management table (AMT) of the BD-J object is a table for implementing the above-described application signaling, defined in “GEM 1.0.2 for package media targets”. The “application signaling” is control of startup and execution, using the “title” of a BD application as a life cycle.

An index table defines which between the Movie object and the BD-J object to use.

The index table (INDEX.TBL) is information structured by associating a title number with program identification information. The program identification informs the playback apparatus of an operation mode object to be referred to for dynamic control at branching to a title having a corresponding title number.

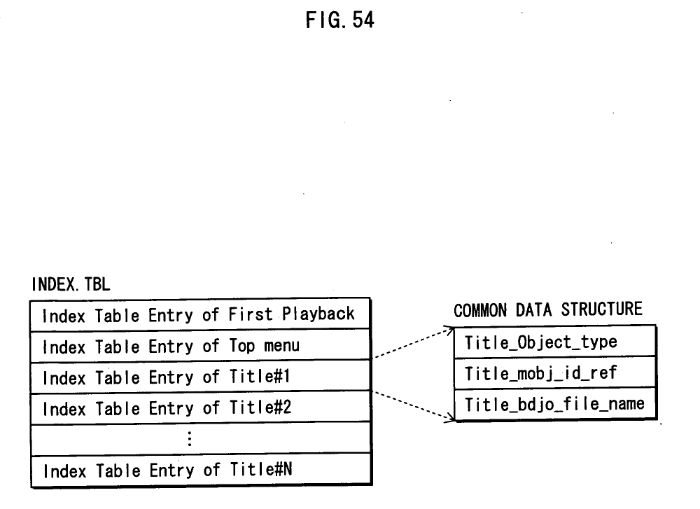

FIG. 54 shows an internal structure of the INDEX.TBL. The INDEX.TBL is the uppermost class table that defines the title structure of the BD-ROM. The INDEX.TBL shown on the left side of the FIG. 54 includes Index Table Entry for First Playback to be stored in the BD-ROM disc, Index Table Entry for TopMenu, Index Table Entry for Title #1, Index Table Entry for Title #2 . . . #N. This table specifies, for all the titles, the TopMenu and the FirstPlayback, a Movie object or a BD-J object that is to be referred first. Every time the tile or menu is called, a BD-ROM playback apparatus firstly refers to the INDEX.TBL, and then refers to a Movie object and a BD-J object.

The “FirstPlayback” is to be set by the content provider, and shows a Movie object and a BD-J object that are to be automatically executed when the disc is loaded. The Topmenu shows a Movie object and a BD-J object that are to be called when a command such as “MenuCall” is executed according to the user's operation from the remote control. This index table defines playback processing to be performed first when an optical disc medium is loaded or when a menu is called.

The above-mentioned Index Table entry is defined by a common data structure shown on the right side of the drawing. As FIG. 54 shows, the common structure includes “Title_object_type”, “Title mobj_id_ref” and “Title_bdjo_file_name”.

The “Title_object_type” shows association with a BD-J object when it is set to “10”, and shows association with a Movie object when it is set to “01”.

The “Title_mobj_id_ref” shows an identifier of a Movie object that is associated with the title.

The “Title_bdjo_file_name” specifies a name of a BD-J object that is associated with the title.

The BD-RE recording layer is used for storing additional contents to be downloaded and data to be used by the application. The merge management information, which shows how to merge the downloaded additional content to the data on the BD-ROM, is also stored on the BD-RE recording layer.

The playback apparatus of this embodiment recognizes the BD-ROM recording layer and the BD-RE recording layer as a virtual file system. The virtual file system structures a virtual BD-ROM package (virtual package) in which the additional contents stored on the BD-RE recording layer and the content recorded on the BD-ROM recording layer are combined based on the merge management information stored on the BD-RE recording layer. The java platform on the playback apparatus can refer to the virtual package and the original BD-ROM recording layer without distinguishing between them. During playback of the virtual package, the playback apparatus controls the playback using both the data on the BD-ROM recording layer and the data BD-RE recording layer. These are the components of the playback apparatus.

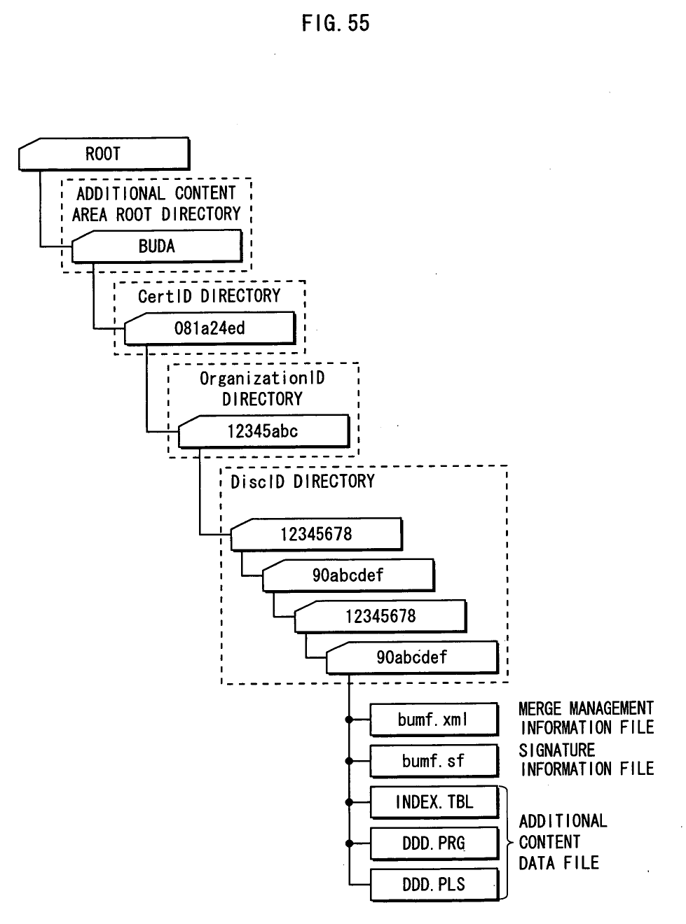

FIG. 55 shows a directory structure of the BD-RE recording layer. The BD-RE recording layer includes an additional content area root directory, a CertID directory, an OrganizationID directory, DiscID directory, a merge management information file, a signature information file, and an additional content data file. The additional content area root directory is directly under the root directory of the BD-RE recording layer, and shows a root of the additional content area. The name of this directory is a fixed value (BUDA) within a directory name distribution media character number.

The CertID directory is a directory whose name is the ID derived from the merge certificate (bd.cert) recorded on the BD-ROM recording layer. The name is consisted of 8 characters obtained by representing in hexadecimal the first 32 bits included in the 160 bits of the SHA-1 digest value of the merge certificate.

The OrgarnizationID directory is a directory whose name is consisted of 8 characters obtained by representing the 32-bit identifier (OrganizationID) in hexadecimal. This 32-bit identifier is described in the BD management information (INDEX.TBL) recorded on the BD-ROM recording layer and specifies the provider of the movie.

The DiscID directory is structured from four subdirectories. Each subdirectory has a name consisted of 8 characters. These 8 characters are obtained by dividing the 128 bit identifier (DiscID), which is described in the BD management information (INDEX.TBL) on the BD-ROM recording layer, into four 32-bit parts, and representing each of the 32-bit parts in hexadecimal.

Under the DiscID directory, there are a merge management information file, a signature information file, and an additional content data file. The merge management information file is structured from file location information for each of files that are recorded on the BD-RE recording layer and constitute the virtual package, and virtual path information used for accessing the files on the virtual package.

The merge management information file includes the merge management information used for structuring the virtual package based on the additional content data files on the BD-RE recording layer and the files on the BD-ROM recording layer. This merge management information file is stored in the DiscID directory, with a file name “bumf.xf”.

The signature information file shows an electronic signature of the provider issued for the merge management information file. The signature information file is stored in the DiscID directory, with a file name “bumf.sf”.

The electronic signature is usually obtained by calculating a hash value for information that should be protected against tampering, and encrypting the hash value using any secret key. Regarding the signature information file of this embodiment, the hash value of the merge management information file is encrypted using a private key that corresponds to the merge certificate recorded on the BD-ROM recording layer.

The merge certificate is used for authentication of the merge management information file, and includes a public key that is made public by the provider. The certificate provided by the provider is stored on the BD-ROM recording layer, with a filename “bd.cert”. As a file format of the merge certificate, the X.509 may be used, for example. The detailed specifications of the X.509 are disclosed in “CCITT Recommendation X.509 (1988), “The Directory—Authentication Framework”, published by the CCITT.

The additional content data file is a group of files to be added to, or to be used for updating the original content recorded on the BD-ROM recording layer. The additional content data file stores the movie objects, the playlist information, and the AV streams.

The following describes the detail of the merge management information, and the process for structuring the virtual package based on the merge management information using the BD-ROM recording layer content and the additional content recorded on the BD-RE recording layer or in a local storage.

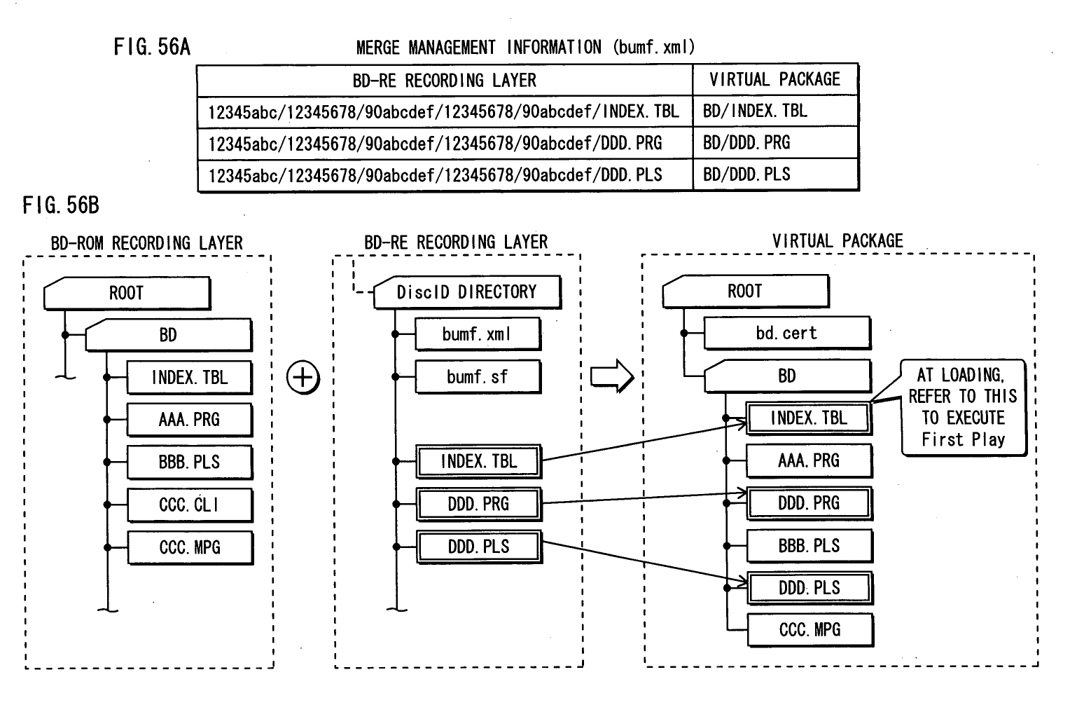

FIG. 56A shows the internal structure of the merge management information. The merge management information file is structured from file location information for each of files that are recorded on the BD-RE recording layer and constitute the virtual package, and virtual path information used for accessing the files on the virtual package.

As an example of the file storage location information for each file, FIG. 56A shows: 12345abc/12345678/90abcdef/12345678/90abcdef/INDEX.TBL; 12345abc/12345678/90abcdef/12345678/90abcdef/DDD.PRG; and 12345abc/12345678/90abcdef/12345678/90abcdef/DDD.PLS.

This example is based on FIG. 55, and the path from the CertID directory to the additional content data file is described.

Meanwhile, as path information for accessing the above files on the virtual package, BD/INDEX.TBL, BD/DDD.PRG and BD/DDD.PLS are described. As the virtual package is generated based on the merge management information, the files on the BD-RE recording layer can be accessed according to the path information included in the merge management information.

This concludes the explanation of the improvements of the hybrid medium. Next, the improvements of the recording/playback apparatus of this embodiment are explained. According to this embodiment, the system controller 211 includes a Java platform, and a virtual FileSystem unit. The following describes the Java platform and the Virtual FileSystem unit.

The Java platform is realized by fully incorporating the Java2 Micro_Edition (J2ME) Personal Basis Profile (PBP 1.0) and the Globally Executable MHP specification (GEM 1.0.2) for package media targets.

The Java platform includes a standard Java library for displaying JFIF (JPEG), PNG and other image data. Accordingly, the Java™ application can realize a GUI framework that is different from the GUI that can be realized by the IG stream in the HDMV mode. The GUI frame work of the Java™ application includes the HAVi framework defined in GEM 1.0.2 and the remote control navigation mechanism of the GEM 1.0.2.

The Virtual FileSystem unit structures the Virtual Package according to a method call from the Java™ application running on the Java platform.

Virtual Package information is for extending the directory-file structure of the BD-ROM by adding new file management information to volume management information that shows the directory-file structure of the BD-ROM recording layer. Here, the file management information to be added to the BD volume management information is file management information for the BD-RE recording layer. By generating the Virtual Package information to which the file management information has been added and passing it to the platform, the recording/playback apparatus can recognize various files on the BD-RE recording layer as if they exist on the BD-ROM recording layer.

FIG. 56B shows a process of generation of the virtual package performed by the recording/playback apparatus. On the left side of this figure, what recorded on the BD-ROM recording layer is illustrated, and in the middle, what is recorded in the DiscID directory on the BD-RE recording layer is illustrated. The right side shows what is included in the virtual package.

When a hybrid medium having a BD-ROM recording layer and a BD-RE recording layer is loaded, the playback apparatus finds the CertID directory based on the bd.cert, checks the DiscID and the Organization ID described in the INDEX.TBL, and determines the corresponding DiscID directory on the local storage. After confirming that the merge management information file has not been tampered with, using the signature information file included in the DiscID directory corresponding to the BD-ROM recording layer of the loaded hybrid medium, the recording/playback apparatus merges the additional content file stored in the DiscID directory to the content recorded on the BD-ROM recording layer, based on the merge management information, to generate a virtual package.

The virtual package exists virtually, and part of the package is consisted of files recorded on the BD-RE recording layer, and the others are recorded on the BD-ROM recording layer. However, the Java platform is controlled so that it can refer to the virtual package as if all the files are recorded on the BD-ROM recording layer. Specifically, the references to the BD-ROM recording layer are monitored, and if the path to the reference-target file is the same as the virtual path described in the merge management information, the reference target is changed to the file on the BD-RE recording layer described in the corresponding storage location information. In the case where a hybrid medium is loaded and a virtual package is generated, the BD-ROM recording layer and the BD-RE recording layer are accessed based on the INDEX.TBL recorded on the BD-RE recording layer as a result of the change described above.

Accordingly, when the hybrid medium is loaded, the playback apparatus generates a virtual package which combines the files on the BD-ROM recording layer and the files on the BD-RE recording layer, and executes playback according to the FirstPlay and MenuCall based on the index table recorded on the BD-RE recording layer.

Note that the playback apparatus may copy the data recorded on the BD-RE recording layer to the HD drive 202 before starting the first play and generate a virtual package from the data recorded on the HD drive 202 and the data recorded on the BD-ROM recording layer, and read the data written on the BD-RE recording layer from the HD drive 202. With such a structure, even in the case of playing back digital AV streams written on the BD-RE recording layer and digital AV streams written on the BD-ROM recording layer at the same time, it is possible to realize seamless playback of the streams, because such a structure does not cause seeks and playback between the BD-ROM recording layer and the BD-RE recording layer.

When reading the flag that is included in the lead-in and shows whether the disc is hybrid disc or not, the playback apparatus preferably reads the BD-RE recording layer first and then reads the BD-ROM recording layer to perform playback. With such a structure, it is possible to prevent the playback apparatus from performing playback by reading only the BD-ROM recording layer.

The recording apparatus may copy the download data (Data having the OrganizationID and DiscID that are the same as those of the data recorded on the BD-ROM recording layer) for the virtual package recorded on the HD drive 202, to the BD-RE recording layer, when ejecting the disc or according to the user's instruction. With such a structure, the user can carry the series of files, which are required for generating a virtual package, by storing them in a single disc.

Although a BD-ROM/BD-RE hybrid disc is explained as an example in this embodiment, the present invention is applicable to any optical disc media that has multilayer structure including layers of different physical types, in addition to the BD-ROM/BD-RE hybrid disc. For example, it is possible to embody the present invention with combinations of the BD-ROM and the BD-R, the BD-ROM and the DVD-RAM and so on by changing the media type.

As described above, according to this embodiment, it is possible to realize the extension by additional writing relating to the read only disc can be realized with use of only a single hybrid medium, because a series of files required for generating the virtual disc are recorded on the BD-RE recording layer of the hybrid medium and provided to the playback apparatus.

### Eighth Embodiment

The eighth embodiment relates to a method for informing the user of available operations according to the media type and the application format. Basically, this embodiment is based on the embodiments described above. Therefore, extension part and the difference are mainly explained here.

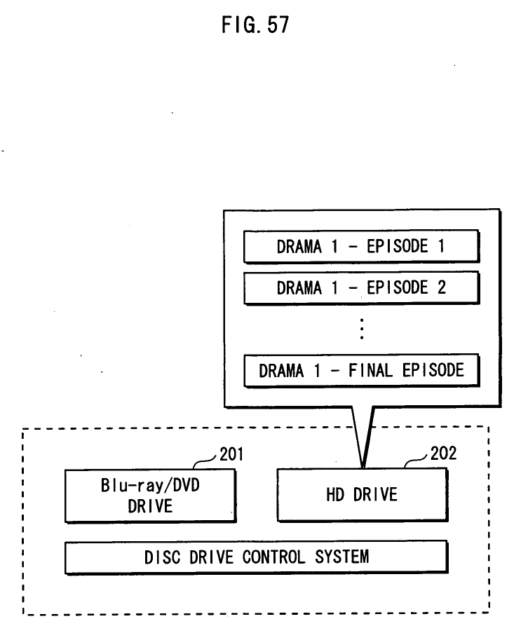

FIG. 57 explains how to record a plurality of contents such as a series of TV programs.

In FIG. 57, when recording contents such as a broadcast program, the recording/playback apparatus stores the contents in the HD drive 202. The format of the contents is converted to format-dependent data of the optical disc, with consideration of dubbing to the optical disc inserted in the optical disc drive 201. By changing in advance the format of the contents in accordance with the application format of the optical disc, it becomes possible to avoid unnecessary format conversion at the recording, and the recording can be performed at a high speed.

Since the format-dependent data is different for each recording medium type, it is effective that the format is the same as the format of the optical disc to be used as the recording destination. If the contents are recorded in the hard disk in the application format different from the format of the recording medium, it is necessary to convert the format again to the application format in conformity with the recording medium standard. This requires a lot of time, and the quality of contents might be degraded by the conversion.

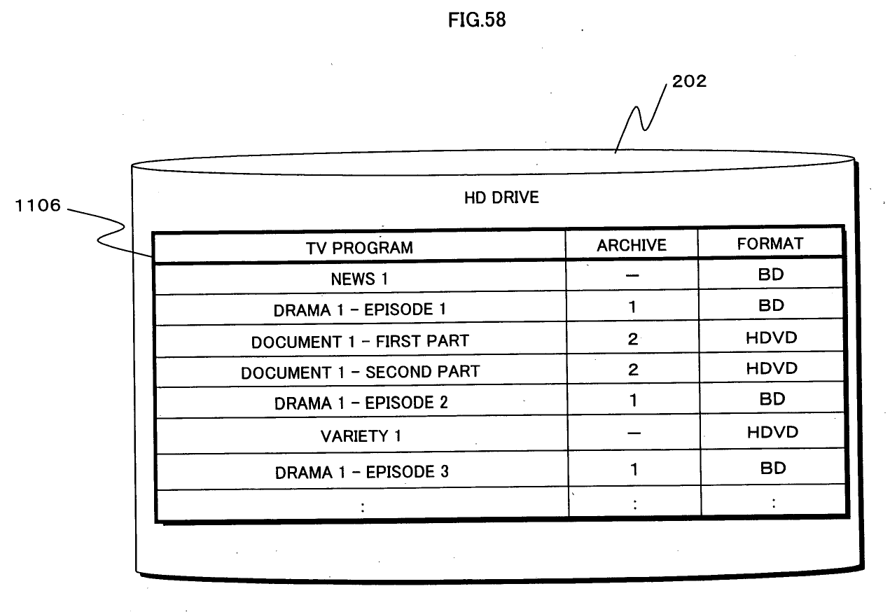

FIG. 58 shows an example of format-dependent data recorded on the HD drive 202.

If the contents to be recorded are a serial drama or a series of TV programs, the user might eventually bring the recorded contents together on one disc to watch them continuously or store them in an organized form. Accordingly, an identification code for bringing the series of format-dependent data together as an archive may be added to the contents such as the serial drama. If this is the case, if the application format is designated at the first recording of a TV program, the same application format may be automatically selected at the second recording and later.

Regarding the recording of a series of the contents, the optimum recording rate can be determined based on the total number of the contents, the recording time of each of the contents, and the capacity of one recording medium. As a result, it is possible to include all the series of format-dependent data in one recording medium. Also, a series of contents may be recorded on a plurality of media. If this is the case, the recording rate is determined such that the recording area size becomes the optimum for each disc.

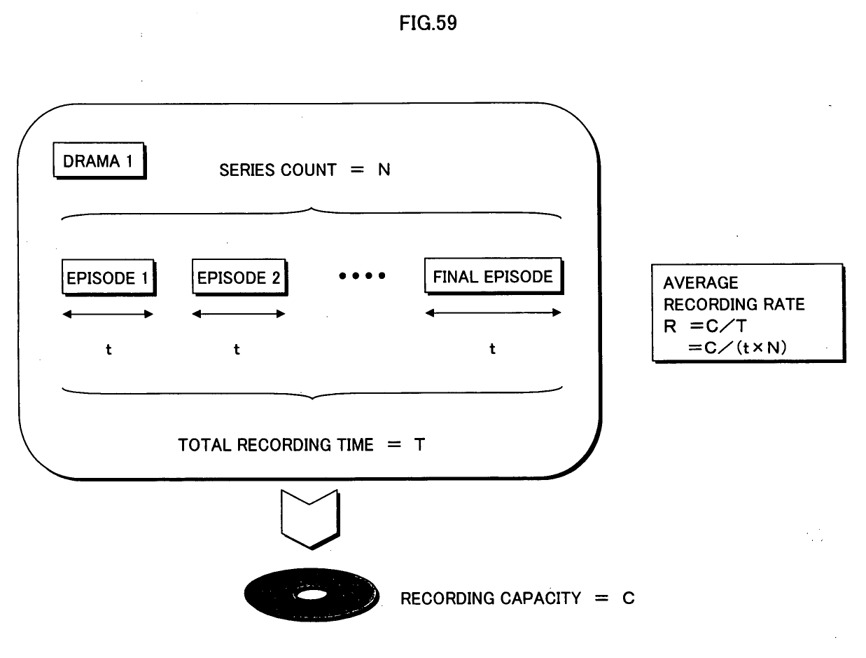

FIG. 59 shows a method for calculating the recording rate for recording the contents. Here, it is assumed that the number (series count) of a plurality of sequential contents is N, the recording time of each content is t, the total recording time of the contents is T, and the capacity of the medium used for the recording is C.

To include all the series of contents in one recording medium, the average contents recording rate R can be calculated by C/T. The capacity C of the recording medium is uniquely determined for each recording medium. Regarding the total recording time T, if all the contents have the same recording time, the recording time t can be obtained from the first episode, and the total recording time T can be obtained by t×N.

Accordingly, all the series of the contents can be recorded on one recording medium by recording the first episode at the average recording rate R obtained by R=C/(t×N).

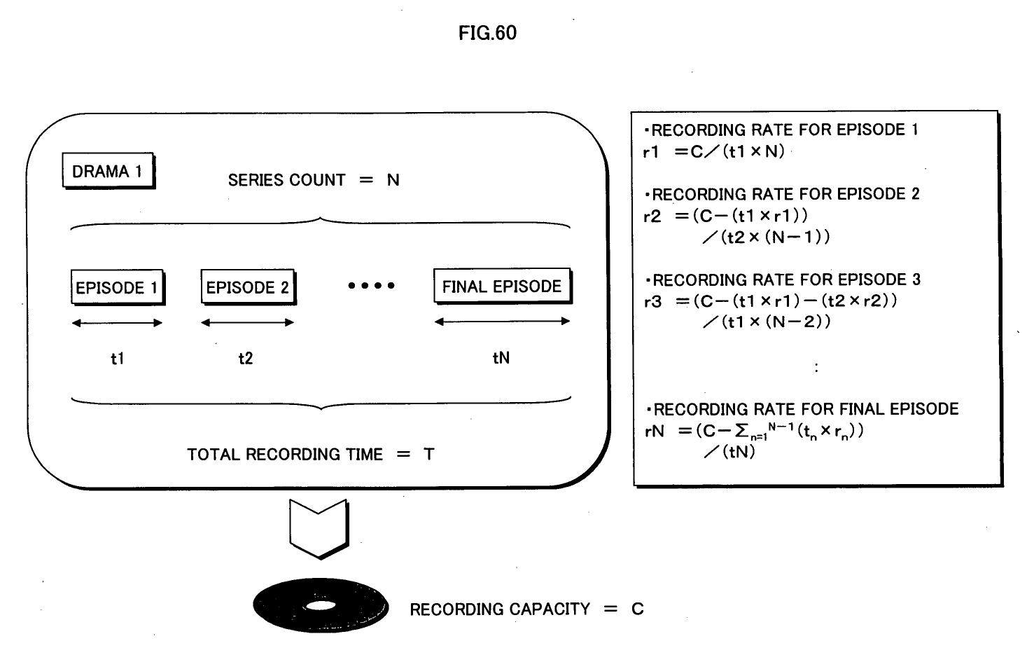

FIG. 60 shows a method for calculating a recording rate for recording a series of a plurality of contents respectively having different time lengths. The average recording rate for recording the first episode is calculated by C/(t1×N) based on an assumption that the recording times of all the episodes are the same as the recording time of the first episode, where the capacity of the recording medium is C, the total recording time is t1×N.

Regarding the recording of the second episode, since the recording size of the first episode is r1×t1, the remaining capacity of the medium is C−(r1×t1). The total of the remaining recording time is t2×(N−1), based on an assumption that the recording times of the remaining N−1 episodes are the same as the recording time of the second episode. Accordingly, the recording rate for the second episode is calculated by C−(t1×r1)/(t2×(N−1)).

All the contents can be included in one recording medium by calculating the recording rates for the third episode and later in the same manner.

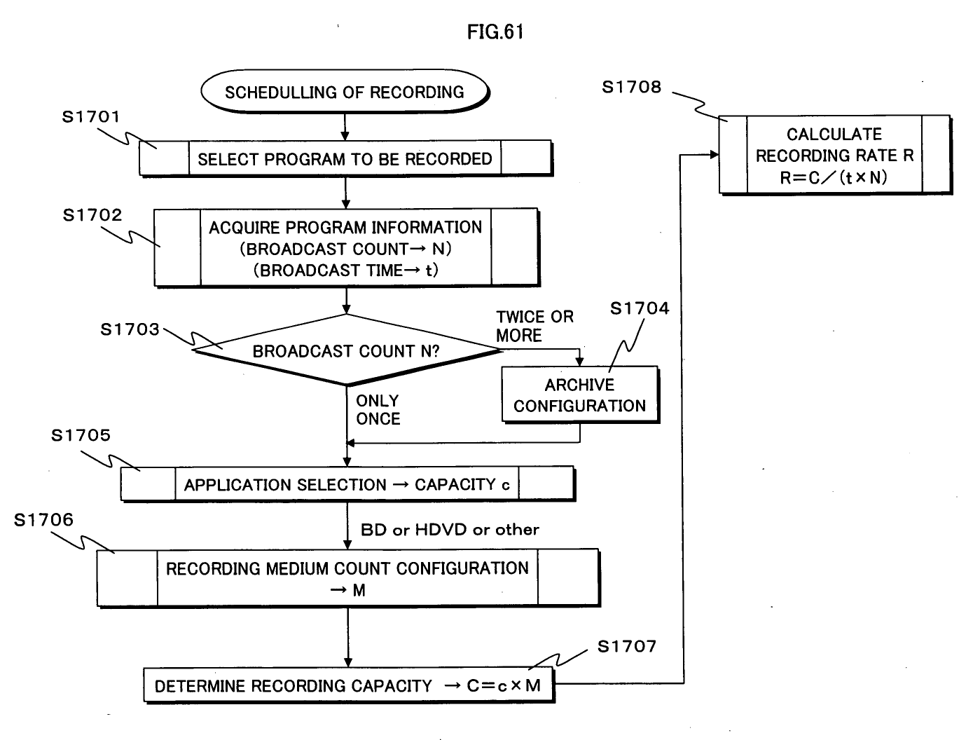

FIG. 61 is a flowchart for determining a recording mode for recording contents.

In Step S1701, the contents to be recorded are selected. In Step S1702, broadcast counts and the broadcast time of the selected contents is acquired as the program information. The program information can be automatically acquired by selecting a program name from a program guide such an EPG.

In Step S1703, the number of recordings is judged based on the broadcast counts acquired in Step S1702. If there are two or more contents to be recorded, archive configuration is performed in Step S1704 in order to record the plurality of contents tighter on a disc. The recording rate of the contents to be archived is calculated such that all the contents can be recorded together in the specified disc.

The contents configured by the same archive configuration are to be recorded in the same application format. Next, in Step S1705, the application format for the recording is selected. The application format corresponds to the recording medium, and the available recording area size C is determined for each selected application.

Next, in Step S1706, the number M of media used for the recording is set. In step S1707, the recording area size C available for recording all the contents can be calculated by C×M. In Step S1708, the recording rate R for recording the contents is calculated using the broadcast counts (=the number of recordings) N and the broadcast time t obtained in Step S1702 and the recording capacity C obtained in Step S1707. The method for calculating the recording rate R is described above.

### Notes

The present invention is described above based on the first embodiment to the eighth embodiment. However, they are only example systems that are expected to be most effective at present. Various changes may be made without departing from the scope of the invention. The following describes specific examples of such changes.

### Implementation as System LSI

The internal structure of the playback apparatus explained in the above embodiments, except the mechanical parts such as the drive, may be structured as a system LSI.

A system LSI is a packaged large-scale integrated chip constituted by mounting bare chips on a high-density substrate. By mounting a plurality of bare chips on a high-density substrate, a package in which a plurality of bare chips are provided with the outward appearance of a single LSI is also included as a system LSI (this type of system LSI is referred to as a multichip module).

Focusing now on the types of packages, system LSIs include QFP (quad flat packages) and PGA (pin grid arrays). With a QFP, pins are attached to the four-sides of the package. With a PGA, the majority of pins are attached to the bottom of the package.

These pins are charged with the task of being interfaces to other circuits. Given that the pins in a system LSI have this role as interfaces, the system LSI acts as the core of the playback device if other circuits are connected to these pins in the system LSI.

As well as into playback apparatuses, such a LSI can be incorporated into various kinds of apparatus capable of playing video, such as TVs, game machines, PCs, mobile phones equipped with a one-segment broadcasting receiver, and so on.

Note that a system LSI may also be referred to as an IC, an LSI, a super LSI, or an ultra LSI, depending on the degree of integration.

If a system LSI is embodied with FPGA, the hardware structure of each embodiment can be realized by connecting wirings of logic elements arranged in a matrix based on input/output combinations described in a LUT (Look Up Table). The LUT is to be stored in an SRAM. When using FPGA, since the SRAM is a volatile memory, it is necessary to write, into the SRAM, an LUT for realizing the hardware structure of each embodiment, based on configuration information. It is preferable that a video demodulation circuit including a decoder is realized with a DSP having a product-sum operation function.

Since the system LSI is used for realizing the functions of the playback apparatus and the recording apparatus, it is preferable that the system LSI conforms to a Uniphier architecture.

A system LSI conforming to the Uniphoer architecture includes the following circuit blocks:

Data Parallel Processor (DPP)

This processor is a SIMD type processor in which a plurality of element processors parallely process the same operation. Computing units respectively included in the element processors operate at the same according to a single instruction. As a result, decoding of a plurality of pixels constituting pictures can be performed in parallel.

Instruction Parallel Processor (IPP)

This processor is constituted from: a “Local Memory Controller” that includes an instruction RAM, an instruction cache, a data RAM and a data cache; a “Processing Unit” that includes an instruction fetch unit, a decoder, an execution unit and a register file; and a “Virtual Multi Processor Unit” that instructs the Processing Unit to execute a plurality of applications in parallel.

CPU Block

This block is constituted from: peripheral circuits, including an ARM core, an external bus interface (Bus Control Unit: BCU), a DMA controller, a timer and a vector interrupt controller; and peripheral interfaces, including a UART, a GPIO (General Purpose Input Output) and a synchronous serial interface. The controller described above is to be mounted as the CPU block on the system LSI.

Stream I/O Block

This block performs, via a USB interface and an ATA Packet interface, data input/output with a drive apparatus connected to an external bus, a hard disk drive apparatus and an SD memory card drive apparatus.

AV I/O Block

This block is constituted from an audio input/output, a video input/output and an OSD controller, and performs data input/output with a TV and an AV amplifier.

Memory Control Block

This block realizes reading from and writing to the SD-RAM connected to the block via an external bus, and includes an internal bus connection unit that controls internal connections among the blocks, an access control unit that performs data transmission with an SD-RAM connected to the outside of the system LSI, and an access schedule unit that arranges requests from each block to access the SD-RAM.

### Manufacturing of Program Pertaining to Present Invention

The program pertaining to the present invention is an object program that is in a form executable by a computer. The program includes one or more program codes that instruct the computer to execute each step of the flowcharts shown in the embodiments above and individual functions of each of the components. The program codes include various types, such as a native code for a processor, a JAVA™ byte code, an instruction, a command and a script.

The program pertaining to the present invention can be produced in the following manner: Firstly, software developers write, in a programming language, a source program for realizing each flowchart and functional components. In this regard, the software developers use class structures, variables, array variables and calls for external functions according to syntax of the program language.

The source program will be given to a compiler. The compiler translates the source program to generate an object program.

Upon generation of the object program, the programmer starts up a linker for this program. The linker allocates the object program and relevant library programs to a memory space, and combines them together to generate a load module. The load module generated in this manner premises reading by a computer, and enables the computer to execute processing procedures shown in the flowcharts and processing procedures of the functional components. The program pertaining to the present invention can be produced through these processes.

### Variations of Contents

The digital stream that constitutes the content in each embodiment may be obtained by real time encoding performed by an encoder.

The real time encoding includes outside encoding as well as self encoding by which the encoder encodes input digital/analog signals. The outside encoding is recording of digital data that has already been encoded. Specifically, a multi-program type transport stream is partialized and the partial transport stream is recorded on a recording medium. The present invention is applicable to such a case as well.

The digital stream of the content may also be obtained by encoding analog/digital video signals recorded on a video tape. Moreover, the digital stream may be obtained by encoding analog/digital video signals directly loaded from a video camera. Also, the digital stream may be distributed by a distribution server.

Furthermore, the content may include only an audio stream and not include a video stream.

Directory Structure within Local Storage

The HD drive 202 and the memory card drive 203 of the fourth and fifth embodiments may be replaced with local storages that can be accessed with use of methods from Java™ IO Package. The local storage includes a plurality of domain areas. Here, the domain area is a directory that corresponds to a disc root certificate that is unique to BD-ROMs. The domain area stores sub-directories for each organization.

The disk root certificate is a root certificate that the creator of the BD-ROM has been received from the root certificate authority and allocated to the BD-ROM. The disc root certificate is encoded according to the X.509 format. The detailed specifications of the X.509 are disclosed in “CCITT Recommendation X.509 (1988), “The Directory—Authentication Framework”, published by the CCITT.

The structure of the directories for each organization application is the same as that of the MHP. In other words, in the local storage, the directories of applications of each organization defined in the MHP are located under the directory corresponding to the root certificate. Therefore, the compatibility with the storage method of the MHP can be retained. Among file path to the directory structure of the local storage, a path corresponding to the root certificate is called a “local storage root”.

It is preferable that the class files are read from the directory corresponding to the disc root certificate of the BD-ROM according to the local storage root, and the object is generated based on these class files to be executed by the virtual machine.

Also, it is preferable that the contents of the BD-ROM and local storage are encrypted according to the Advanced Access Content System (AACS) and given signature information, and authorization for use is defined in the permission file.

For example, whether a desired file exist at a location indicated by a file path “/Persistent/1/1/streams/” or not is checked with used of exists( ) method of the Java™.io. The following is an example of use of the exists( ) method of the Java™.io

### Example

new Java™.io.File (“/Persistent/1/1/streams/O.m2ts”).exists( );

### Receiving Operation Requests

The remote control described in each of the embodiments is an apparatus that receives instructions unique to AV apparatuses, such as Play, Stop, Pause, and Skip, and instructions given by the user to a hierarchical GUI. The remote control includes, a play key, a stop key, a pause key, a skip key, a menu key for calling a menu that constitutes the GUI, direction keys that change the focus on parts of the GUI, an enter key for giving a confirmation instruction to the GUI, a cancel key for going up to a higher level of the hierarchical menu, and numeric keys. These keys structure a key matrix. The remote control specifies the column position and the row position of a pressed key by the key sense, and generates a key code by encoding the column position and the row position. The remote control transmits a remote control signal that includes the generated key code.

The remote control signal to be transmitted includes frames each for a few milliseconds. I/O bits of a bit sequence included in the frame are constituted of bits having a carrier signal of a few KHz and bits not having a carrier. The play back apparatus generates a clock pulse with a frequency and a duty ratio that are same as those of the carrier. It is preferable that the remote control receives the instruction by capturing the data part of the bit sequence.

In each of the embodiments above, it is the remote controller that receives operation requests. However, the front panel of the playback apparatus may receive the requests. Also, the requests may be received via an input apparatus, such as a keyboard, a touch panel, a mouse, a keypad, and a trackball. If this is the case, the instructions may be received through click and drag operations.

### Realizing GUI Screen

It is preferable that the GUI screen described in each embodiment is constituted from OSD (On Screen Display) image data, and Look Up table. The OSD image data represents an image with bit codes allocated to the pixels respectively. The bit length of each bit shows the number of colors to be used for rendering a pixel. For example, if the bit length is 1, the pixel of the OSD image data is colored with two colors. If the bit length is 2, the pixel is colored with four colors, and if the bit length is 4, the pixel is colored with 16 colors.

The LUT includes a plurality of entries that respectively correspond to pixel codes. Each entry includes a luminance value, a red color-difference value and a blue color-difference value to be allocated to a pixel of the OSD, and a mixture ratio α that represents ratio for mixing the values. Each entry included in the LUT represents unique colors such as red, blue, green and yellow based on the luminance value, the red color-difference value and the blue color-difference value, and the entries are different from each other.

Interactive control on the GUI screen structured as described above is realized based on markup information that includes pieces of item information.

Each piece of markup information including the pieces of item information corresponds to any of selectable items on the GUI screen. Specifically, the pieces of item information include “focus destination information”, “palette information”, and “command”. The “focus destination information” shows an item to which the focus moves when any key of the remote control is pressed under the condition that the focus is on the selected item that corresponds to the information. The “palette information” shows a luminance and a color to be used for displaying a selected item when the item is in a focused state and a normal state. The “command” shows operation to be performed by the playback apparatus when the selected item is confirmed.

This concludes the explanation of the data structure for realizing the GUI screen. On the other hand, the playback apparatus performs filtering according to a given zoom ratio and the mixture ratio α, using the pixel data for a plurality of lines, the OSD data, and the entries of the LUT, to convert the data to video signals and output the signals to the display of TV receiver or the like connected externally. Then, according to the user's operations and interactive control information, the playback apparatus changes the LUT for display, to realize the focus movement between the items.

What is claimed is:

1. A playback apparatus comprising:
a first detection unit operable to detect a physical type of a disc medium when the disc medium is loaded;
a second detection unit operable to detect a format type of data recorded on the disc medium;
a playback unit operable to play back the data recorded on the disc medium; and
a determination unit operable to determine whether to play back the data, based on a combination of the physical type and the format type.

2. The playback apparatus' of claim 1, further comprising:
a notification unit operable, if the physical type and the format type are inconsistent, to notify a user of irregularity of the combination or possibility of a playback failure.

3. A playback method comprising:
a first detection step of detecting a physical type of a disc medium when the disc medium is loaded;
a second detection step of detecting a format type of data recorded on the disc medium;
a playback step of playing back the data recorded on the disc medium; and
a determination step of determining whether to play back the data, based on a combination of the physical type and the format type.

4. A recording apparatus comprising:
a built-in medium;
a conversion unit operable to convert a content to be recorded, to obtain two or more format-dependent data sets, and write the data sets on the built-in medium, each of the data sets being dependent on a different application format;
a presentation unit operable to present to a user a capacity of the built-in medium obtained by adding a prescribed offset to an actual free space size of the built-in medium; and
a dubbing unit operable, when a portable medium is loaded, to read one of the data sets that has been written in an application format that is acceptable to the portable medium, and write the read data set on the portable medium, wherein
the prescribed offset is a size of a data set that is to be deleted to increase a free space of the built-in medium.

5. The recording apparatus of claim 4, wherein
the recording apparatus holds a plurality of portable medium types in one-to-one correspondence with frequencies of usage thereof by the dubbing unit, and
the data set to be deleted is a format-dependent data set that corresponds to a portable medium type whose frequency of usage is the lowest among the frequencies.

6. The recording apparatus of claim 4, wherein
the recording apparatus holds frequencies of usage of image quality modes that have been used for recording, and
the data set to be deleted is a format-dependent data set that corresponds to an image quality mode whose frequency of usage is the lowest among the frequencies.

7. The recording apparatus of claim 4, wherein
the recording apparatus holds a preference of the user and an image quality mode that suits the preference, and has a function to automatically acquire one of a plurality of contents that has an attribute that suits the preference,
the conversion unit converts the acquired one of the plurality of contents, and
the data set to be deleted is a format-dependent data set that corresponds to the acquired one of the plurality of contents, and to an image mode that does not suit the preference.

8. The recording apparatus of claim 4, wherein
the two or more format-dependent data sets correspond to different image quality modes respectively, and
the recording apparatus further comprises a playback unit for playing back one of the format-dependent data sets that corresponds to an image quality mode whose image quality is the highest among the image quality modes.

9. A recording method for use with a computer, the recording method comprising:
a conversion step of converting a content to be recorded, to obtain two or more format-dependent data sets, and writing the data sets on the built-in medium, each of the data sets being dependent on a different application format;
a presentation step of presenting to a user a capacity of the built-in medium obtained by adding a prescribed offset to an actual free space size of the built-in medium; and
a dubbing step of, when a portable medium is loaded, reading one of the data sets that has been written in an application format that is acceptable to the portable medium, and writing the read data set on the portable medium, wherein
the prescribed offset is a size of a data set that is to be deleted to increase a free space of the built-in medium.

10. A disc medium that has two or more recording layers each applying a different recording method, wherein
the recording layers have recorded thereon the same content in different application formats, and
a recording size of the content is determined for each of the recording layers based on a ratio among sizes of free spaces of the recording layers.

11. The disc medium of claim 10, wherein
if the recording layers include a layer that has enough space to record the content and a layer that does not have enough space to record the content, a substitute data is recorded on the layer that does not have enough space instead of the content, the substitute data being digest data generated from the content or still image data for identifying the content.

12. The disc medium of claim 10, wherein
a flag is recorded in a lead-in area of each of the recording layers, the flag showing that the disc medium is a hybrid medium that has two or more recording layers each applying a different recording method.

13. A recording apparatus that records a content on a disc medium that has two ore more recording layers, the recording apparatus comprising:
a designation unit operable to designate a recording layer as a recording destination according to an attribute of the content;
a first writing unit operable to write the content on the designated recording layer;
a re-encode unit operable to re-encode the content; and
a second writing unit operable to write the re-encoded content on an undesignated recording layer, wherein
a size of the re-encoded content is determined based on a size of the content recorded on the designated layer, a free space size of the designated layer, and a free space size of the undesignated layer.

14. The recording apparatus of claim 13, wherein
if the recording layers include a layer that has enough space to record the content and a layer that does not have enough space to record the content, a substitute data is recorded on the layer that does not have enough space instead of the content, the substitute data being digest data generated from the content or still image data for identifying the content.

15. The recording apparatus of claim 13, wherein
the recording apparatus writes a flag on each of the recording layers, the flag showing that the disc medium is a hybrid medium that has two or more recording layers each applying a different recording method.

16. The recording apparatus of claim 13, wherein
when deleting the content recorded on any of the recording layers, the recording apparatus deletes every corresponding content recorded on other one or more layers out of the recording layers.

17. A method for recording a content on a disc medium that has two or more recording layers, the method comprising:
a designation step of designating a recording layer as a recording destination according to an attribute of the content;
a first writing step of writing the content on the designated recording layer;
a re-encode step of re-encoding the content; and
a second writing step of writing the re-encoded content on an undesignated recording layer, wherein
a size of the re-encoded content is determined based on a size of the content recorded on the designated layer, a free space size of the designated layer, and a free space size of the undesignated layer.

18. A disc medium that has two or more recording layers each applying a different recording method, wherein
the recording layers include:
a first recording layer that is a read-only area; and
a second recording layer that is a writable area or a rewritable area, and
when loaded on a playback apparatus, the disc medium has the playback apparatus generate a virtual package by combining contents recorded on the first recording layer and the second recording layer according to playback control information recorded on the second recording layer, and play back the virtual package.

19. A playback apparatus that plays back a disc medium that has two or more recording layers each applying a different recording method,
the recording layers including:
a first recording layer that is a read-only area; and
a second recording layer that is a writable area or a rewritable area,
the playback apparatus comprising:
a generation unit operable, when the disc medium is loaded, to generate a virtual package by combining contents recorded on the first recording layer and the second recording layer according to playback control information recorded on the second recording layer; and
a playback unit operable to play back the virtual package generated by the generation unit.

20. A playback method for playing back a disc medium that has two or more recording layers each applying a different recording method,
the recording layers including:
a first recording layer that is a read-only area; and
a second recording layer that is a writable area or a rewritable area,
the playback method comprising:
a generation step of, when the disc medium is loaded, generating a virtual package by combining contents recorded on the first recording layer and the second recording layer according to playback control information recorded on the second recording layer; and
a playback step of playing back the virtual package generated by the generation step.
